(19) United States
(12) Patent Application Publication
(10) Pub. No.: US 2017/0323005 A1
(43) Pub. Date: Nov. 9, 2017

(54) Relevant Relationships Based Networking Environment

(71) Applicants: Schmidt J. Raymond, Troy, NY (US); Green J. Andrew, New York, NY (US)

(72) Inventors: Schmidt J. Raymond, Troy, NY (US); Green J. Andrew, New York, NY (US)

(21) Appl. No.: 15/595,162

(22) Filed: May 15, 2017

Related U.S. Application Data
(63) Continuation of application No. 15/089,772, filed on Apr. 4, 2016, now abandoned.
Application No. 15/089,772 is a continuation of application No. 13/532,762, filed on Jun. 25, 2012, now abandoned.
Application No. 13/532,762 is a continuation-in-part of application No. 12/179,678, filed on Jul. 25, 2008, now abandoned.
(60) Provisional application No. 60/951,829, filed on Jul. 25, 2007.

(51) Int. Cl. G06F 17/30; H04L 29/08; H04L 29/06; H04L 12/58; G06Q 10/00; H04W 4/20

(52) U.S. Cl. CPC G06F 17/30604; H04W 4/206; H04L 67/306; H04L 63/123; G06F 17/30867; H04L 51/32; G06Q 10/00; H04L 63/102

(57) ABSTRACT

The present invention provides a relevant relationships based networking environment for establishing member networks focusing on different aspects, of a members life based on generally vetted connections with other members. In accordance with the invention, a member initiates the formation of one or more aspect of life related networks, such as social, business or a particular interests aspect related networks, by inviting other members to connect through primary relationship connections and the other members accepting the invitations. Based on the primary relationship connections the networking environment automatically adds secondary relationship connection members to the aspect related network. Primary relationship connections require prior agreement by both members to the connection, such connections provide for both communication and information sharing. Secondary relationship connections are established automatically by the networking environment based on how one member may be logically connected in a defined manner to another member through existing primary relationship connections in a particular aspect related network. In the context of the invention, “logically connected” is used to describe how two members in a particular aspect related network may be connected to each other through a series of network permitted primary relationship connections. The predefined permitted intervening connections allow for increased quality and vetting in choosing new member connections in the network of the present invention.

### CROSS-REFERENCE TO RELATED APPLICATION

The present application is a continuation of U.S. patent application Ser. No. 15/089,772 filed Apr. 4, 2016 (pending) which is a continuation of U.S. patent application Ser. No. 13/532,762 filed Jun. 25, 2012 (pending), which is a continuation-in-part application of U.S. patent application No. 12/179,678, filed on Jul. 25, 2008, which are both is incorporated herein by reference in their entirety. The present application also explicitly references and claims the benefit of U.S. Provisional Application No. 60/951,829, which was filed on 25 Jul. 2007, and whose benefit was explicitly claimed by then co-pending U.S. patent application Ser. No. 12/179,678, and which are incorporated herein by reference in their entirety.

### COPYRIGHT NOTICE

A portion of the disclosure of this patent document contains material which is subject to copyright protection, for example, the FIGURES. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Before the internet “social networking” used to mean meeting people through the people you already knew and members of a person's social network were connected to common interests and or relationships. Then, the internet came along and brought a host of social “networking” sites, which said they provided ways to meet new people, and that was fine unless members wanted to meet new but relevant people, that is, people strongly vetted by others they already knew. Eventually, many of these social networking sites evolved into sites where people shared information with people they already knew and where members did not effectively use them to meet new people they may actually want to know.

The invention relates generally to aspect of life related electronic networks, such as social, business and/or particular interests related networking environments. Conventional online social, including business networking systems provide means for members to form connections with other members so as to communicate and share information with other members. These systems may provide and/or promote large increases in connections. Thereby resulting in close relationships potentially being drowned out by the “noise” of all the other member connections. These systems generally provide no graduated vetting system based on the “quality” of connection between members for ensuring that only more relevant connections under the circumstances are presented to a member in expanding his/her network. Nor do they provide for automatic limited connections with other members based on the “quality” of the intervening connections as determined in accordance with the present invention.

### SUMMARY OF THE INVENTION

The present invention provides a system, network and method to provide a networking environment where members introduce members to other members more along the lines of the way people originally networked socially in real life. In accordance with the invention, the network establishes and maintains the relevant relationship data connecting members and automatically, utilizing vetted primary relationships established by the members, provides for expanding a members network by sharing information about other potential network members who are essentially vetted by current members of the network. Members are generally introduced to other members in connection with their peers and close contacts.

The present invention provides a relevant relationships based networking environment for establishing member networks focusing on different aspects of a member's life based on generally vetted connections with other members. In accordance with the invention, a member initiates the formation of one or more aspect of life related networks, such as social, business or a particular interests related networks, by inviting other members to connect through primary relationship connections and the other members accepting the invitations. Based on the primary relationship connections the networking environment automatically adds secondary relationship connection members to the aspect related network.

In a preferred embodiment, the networking environment provides members with two or more primary relationship connections capabilities and two or more secondary relationship connections capabilities, each connection having certain member communication and information sharing capabilities. Primary relationship connections require prior agreement by both members to the connection, such connections provide for both communication and information sharing. Secondary relationship connections are established automatically by the networking environment based on how one member may be logically connected in a defined manner to another member through existing primary relationship connections in a particular aspect related network.

In the context of the invention, “logically connected” is used to describe how two members in a particular aspect related network may be connected to each other through a series of network permitted primary relationship connections. The predefined permitted intervening connections allow for increased quality and vetting in choosing new member connections in the network of the present invention. Secondary relationship connections generally provide for some information sharing and some minimal communication capabilities. Thus the networking environment of the present invention automatically provides select information and select communication capabilities between members and select other members whose relationship connections meet predefined criteria. Information about a member's relationship connections may be stored by the network of the present invention as relationship data.

In accordance with one preferred embodiment of the invention, the networking environment provides for two primary relationship connections and the predefined permitted logical connections are any combination of one, two and/or three of the first primary relationship connections and any combination of the second primary relationship connection and one and/or two primary relationship connections.

In accordance with one preferred embodiment of the invention, the alpha relationship connection is the first primary relationship connection and the beta relationship connection is the second primary connection, while the predefined permitted secondary relationship connections are the gamma, delta, epsilon(1), epsilon(2), epsilon(3), theta(1) and theta(2) secondary relationship connections. See FIGS. 1- 4.

In accordance with another preferred embodiment of the invention, the alpha relationship connection is the first primary relationship connection and the beta relationship connection is the second primary connection, while the predefined permitted secondary relationship connections are the gamma, delta, epsilon(1), epsilon(2), and epsilon(3). See FIGS. 5-80.

In accordance with the invention, the one or more aspect of life related networks comprise a social aspect network and a business aspect network.

In accordance with the invention, there are two primary member information status settings: private and public, the system default is preferably private. Importantly, the system provides that even where a member has set their information status as private, where the member has agreed to one or more member primary relationship connections, assuming there is a pre-defined permitted relationship connection between the members, private member information will be automatically shared with and/or available to all or some of the other primary relationship connection members.

In accordance with a preferred embodiment, the system and method provide two main types of graphical user interface (GUI), first, the member's main GUI (the console/dashboard) page for each member, which organizes and displays member information and provides links to communication, search and other system functionality to the member. See, for example, FIG. 5. Second, the member's individual GUIs for each of the member's relationship connections pages (peerpages), which GUI page displays the member's profile, the member's relationship connection's profiles and certain of their relationship connections for all members for which the member has a permitted relationship status in that embodiment. It also displays several of the tools of the present invention which aid the decision to request to connect, such as paths, poll the network and peeks into aspect networks. See FIG. 14.

In accordance with another preferred embodiment of the invention, the member's main GUI (console) is divided into several separate areas for groupings of relationship connections by type, for example a members': alphas (peers), betas (contacts), gammas (prospects), deltas (possibilities), and epsilons (peersonalities). Also included are phase-outs (phazeouts). See FIG. 5. Members introduced through use of a pass or pass code are also displayed as a separate group in other embodiments.

In accordance with another embodiment of the invention, the member's main GUI (the console's) beta's section is further divided into separate areas for displaying beta relationship connections history, namely: (1) betas from gammas (prospects and indirect peers), (2) betas from deltas (possibilities and indirect portraits), (3) betas from epsilons (peersonalities), and (4) betas from peerpasses.

### BRIEF DESCRIPTION OF THE DRAWINGS

In order that the present invention may be more fully understood, it is described in the accompanying figures, but only by way of example and without limiting the broad scope or various other embodiments of the present invention. In the drawings, like numbering represents like elements between the drawings.

FIG. 1 illustrates a preferred embodiment of the invention where member A has the following relationship connections: alpha, beta, gamma, delta, epsilon(1), epsilon(2), epsilon(3), theta(1) and theta(2).

FIG. 2 illustrates a preferred embodiment of the invention where member P has formed an alpha relationship connection with member A from FIG. 1 and shows member P's relationship connections created through the alpha relationship connection with A.

FIG. 3 illustrates a preferred embodiment of the invention where member P has formed a beta relationship connection with member A from FIG. 1 and shows member P's relationship connections created through the beta relationship connection with A. FIG. 4 illustrates some relationship connections in accordance with an embodiment of the invention that provides for alpha, beta, gamma, delta, epsilon(1), epsilon(2), epsilon(3), theta(1) and theta(2) relationship connections.

FIGS. 5-80 show illustrative partial screen shots provided by the networking environment to a member in accordance with a preferred embodiment of the invention showing alpha, beta, gamma, delta, epsilon(1), epsilon(2), and epsilon(3) relationship connections and by clicking on member images will have the networking environment provide that member's peerpage. Blank images represent where a member's actual image would go.

FIG. 5 is an illustrative partial screen shot provided by the networking environment to member Andy, showing his Professional Peersona (business related aspect network) console.

FIG. 6 is an illustrative partial screen shot provided by the networking environment to member Andy, showing the GUI page provided in connection with a member clicking on the Post tab, used for the member to send messages to their alphas (Peers) and betas (Pathways) in a particular aspect network, in this case Andy's Professional PeerSona network.

FIG. 7 is an illustrative partial screen shot provided by the networking environment to member Andy, in connection with a member clicking on the Peer Passes tab, showing means for managing a member's PeerPasses.

FIG. 8 is an illustrative partial screen shot provided by the networking environment to member Andy, in connection with a member clicking on the Search tab, showing means for a member to search for other members (by a name and word search in a preferred embodiment) who are in their aspect network and/or have designated their status as public as well as providing for additional search criteria.

FIG. 9 is an illustrative partial screen shot provided by the networking environment to member Andy, in connection with a member clicking on the Settings tab, showing a member's settings page.

FIG. 10 is an illustrative partial screen shot provided by the networking environment to member Andy, in connection with a member clicking on the Notifications tab, showing a member's notifications relating to all of the member's aspect networks.

FIG. 11 is an illustrative partial screen shot provided by the networking environment to member Andy, in connection with a member clicking on the Invite Peer (alpha) icon on the member's Console shown in FIG. 5, providing means for inviting other to become the members' alphas (peers).

FIG. 12 is an illustrative partial screen shot provided by the networking environment to member Andy, in connection with a member clicking on the Invite Contact (beta) icon on the member's Console shown in FIG. 5, providing means for inviting other to become the members betas (contacts).

FIG. 13 is an illustrative partial screen shot provided by the networking environment to member Andy showing the Console as shown in FIG. 5, but focusing in on the My Networking Opportunities and showing the My Prospects section.

FIG. 14 is an illustrative partial screen shot provided by the networking environment to member Andy, in connection with a member clicking on the Jim T icon in the My Prospects section on the member's Console shown in FIG. 5, showing Jim's peerpage with profile information.

FIG. 15 is an illustrative partial screen shot provided by the networking environment to member Andy, in connection with a member clicking on the Poll icon shown on FIG. 14, providing means for the member to see and obtain information about Jim, in the page illustrated showing Mutual Peers (mutual alphas). A member can poll directly or indirectly their peers, the contacts of their peers, the peer's of their contacts, the peers of their prospects, the peers of their possibilities as well as prior paths. In another embodiment, a member who is considering requesting to connect as a beta with another member, can poll all the members's alphas and betas who are connected the other member, and can also indirectly poll all the member's alphas and betas who are also alphas or betas of the other member.

FIG. 16 is an illustrative partial screen shot provided by the networking environment to member Andy, in connection with a member clicking on the My Peersonalities icon on the member's Console shown in FIG. 5, showing Peers of Contacts, the member's betas' (contacts) new alphas (peers). My Peersonalities contain all members connected through the epsilon(1,2,3) relationship connections, that is the alphas of a members betas, gammas and deltas. Epsilon(1,2,3) relationship connections are representation on the console only as an icon and not with members' portraits, this is done to minimize connection noise, as epsilons(1,2,3) are considered lesser vetted connections. Thus they are not displayed along with the alphas, betas, gammas and deltas on the console page, but nevertheless are available by clicking on the Peersonalities icon.

FIG. 17 is an illustrative partial screen shot provided by the networking environment to member Andy, in connection with a member clicking on the Lynn image on FIG. 16, showing Lynn's peerpage with profile information and providing means to petition Lynn to become a new Contact (beta) in the member's selected Peersona (aspect) network.

FIG. 18 is an illustrative partial screen shot provided by the networking environment to member Andy, in connection with a member clicking on the My Peersonalities icon on the member's Console shown in FIG. 5 and then clicking on the Peers of Prospects tab on FIG. 16, showing My Prospects New Peers, that is the member's gammas' (prospects) new alphas (peers).

FIG. 19 is an illustrative partial screen shot provided by the networking environment to member Andy, in connection with a member clicking on the My Peersonalities icon on the member's Console shown in FIG. 5 and then clicking on the Peers of Possibilities tab on FIG. 16, showing My Possibilities New Peers, that is the member's deltas' (possibilities) new alphas (peers).

FIG. 20 is an illustrative partial screen shot provided by the networking environment to member Andy, in connection with a member clicking on the View all Peers icon on the member's Console shown in FIG. 5, showing all a member's peers (alphas) and providing means for setting access, making favorite and managing access to peeks (linked networks).

FIG. 21 is an illustrative partial screen shot provided by the networking environment to member Andy, in connection with a member clicking on the My Prospects Jim icon on the member's Console shown in FIG. 5, resulting in FIG. 14 but this screen shot version focuses on portion of the page showing the image icon, the “Peer Paths” icon and the “Let's Connect” icon.

FIG. 22 is an illustrative partial screen shot provided by the networking environment to member Andy, in connection with a member clicking on the Peer Paths icon on FIG. 21, showing among other things the peer path display logically connecting Andy and Jim, alpha (Hanz, Andy) beta (Jim, Heinz) equals delta (Jim, Andy).

FIG. 23 is FIG. 22 focusing on the peer path with Hanz and more clearly showing the “View Hanz's Peer Interaction with Jim” icon. Peer paths offer a visual display of how your alphas are interacting your other alphas, and your betas, gammas and deltas, including disconnected primary relationship connections.

FIG. 24 is an illustrative partial screen shot provided by the networking environment to member Andy, in connection with a member clicking on the “View Hanz's Peer Interaction with Jim” on Figure, showing how Hanz's peers (alphas) are interacting with Jim

FIG. 25 is an illustrative partial screen shot provided by the networking environment to member Andy, showing the GUI page provided in connection with a member clicking on the Peer Passes tab, which provides means for creating a member's peer passes.

FIG. 26 is an illustrative partial screen shot provided by the networking environment to member Andy, in connection with a member clicking on the View all Peers icon on the member's Console shown in FIG. 5, and then clicking on the “Dave O Manage Access to Peeks” icon on FIG. 20, showing means for managing peek access (linked networks) for the particular individual.

FIG. 27 is an illustrative partial screen shot provided by the networking environment to member Andy, in connection with a member clicking on the “View All” icon associated with My Peersonify Contacts on the member's Console shown in FIG. 5, showing all a member's contacts (betas) and providing means for setting access, making favorite and managing access to peeks (linked networks).

FIG. 28 is an illustrative partial screen shot provided by the networking environment to member Andy, in connection with a member clicking on the “View All” icon associated with “New peers of my peers” on the member's Console shown in FIG. 5, showing all a member's new prospects (gammas).

FIG. 29 is an illustrative partial screen shot provided by the networking environment to member Andy, in connection with a member clicking on the “View All” icon associated with “Pre-existing peers of my New Peers” on the member's Console shown in FIG. 5, showing all a member's prior prospects (gammas).

FIG. 30 is an illustrative partial screen shot provided by the networking environment to member Andy, in connection with a member clicking on the “View All” icon associated with “New Contacts to my Peers” on the member's Console shown in FIG. 5, showing all a member's new possibilities (deltas).

FIG. 31 is an illustrative partial screen shot provided by the networking environment to member Andy, in connection with a member clicking on the “View All” icon associated with “Pre-existing Contacts to my New peers” on the member's Console shown in FIG. 5, showing all a member's prior possibilities (deltas).

FIG. 32 is an illustrative partial screen shot provided by the networking environment to member Andy, in connection with a member clicking on the Marisol icon in the Phazeout section on the member's Console shown in FIG. 5, showing information about Marisol who is being phased out.

FIG. 33 is an illustrative partial screen shot provided by the networking environment to member Andy, in connection with a member clicking on the Settings tab and focusing on the top section of the settings GUI page, which shows among other things the means for setting the privacy settings and icons to click for entering information, including profile information.

FIG. 34 is an illustrative partial screen shot provided by the networking environment to member Andy, in connection with a member clicking on the Settings tab and focusing on the bottom left section of the settings GUI page, which shows among other things the means for setting among other things Peersona Peeks (links across aspect networks).

FIG. 35 is an illustrative partial screen shot provided by the networking environment to member Andy of the section the Console shown in FIG. 5 showing the member's Peersonas (aspect networks).

FIG. 36 is an illustrative partial screen shot provided by the networking environment to member Andy after clicking on the “Peer of My Prospect” tab on the GUI page shown in FIG. 15.

FIG. 37 is an illustrative partial screen shot provided by the networking environment to member Andy after clicking on the “Manage Posting Groups” icon on the GUI page shown in FIG. 6.

FIG. 38 is an illustrative partial screen shot provided by the networking environment to member Andy after clicking on the “Reply” icon associated with the first message in the “Peer” section which said “Hi . . . This is a test message” and showing the options that the recipient may reply to All, only to Andy, the sender, only to the recipient's peers (alphas) and pathways (betas) who are also Andy's peers and pathways.

FIG. 39 is an illustrative partial screen shot provided by the networking environment to member Andy after clicking on Kelly B in the “My Peers” section of member Andy's Professional Peersona console page, showing Kelly B's peerpage with a “Petition” section providing means for Andy to petition Kelly to become a new contact (beta) in a selected other Peersona, such as Andy's Social Peersona.

FIG. 40 is an illustrative partial screen shot provided by the networking environment to member Andy after clicking on Lynn O in the “My Peersonify Contacts” section of member Andy's Professional Peersona console page, showing Lynne O's peerpage with a “Petition” section providing means for Andy to petition Kelly to become a new contact (beta) in a selected other Peersona, such as Andy's Social Peersona.

FIG. 41 is an illustrative partial screen shot provided by the networking environment to member Andy after clicking on member Andy's “A Social Peersona” in the “My Peersonas” section of Andy's console as shown in FIG. 5 and shows Andy's Social Peersona console.

FIG. 42 an illustrative screen shot provided by the networking environment to member Andy, in connection with a member clicking on the Sue icon in the My Possibilities section on the member's Social Peersona console shown in FIG. 41, showing Sue's peerpage with profile information and the Peer Paths icon. Peer Paths show the way in which the member is connected to another member through logical connections of an alpha and an alpha and an alpha and a beta to get gamma and delta relationship connections.

FIG. 43 is an illustrative partial screen shot provided by the networking environment to member Andy, in connection with a member clicking on the Peer Paths icon on FIG. 42, showing among other things the peer path display logically connecting Andy and Sue as prospects, alpha (Hanz, Andy) alpha (Sue, Heinz) equals gamma (Sue, Andy). It also shows the “Prior Paths, Possibility Paths and Prospect Paths”.

FIG. 44 is an illustrative partial screen shot provided by the networking environment to member Andy, in connection with a member clicking on the “Prior Paths” icon on FIG. 43, showing how Sue was once Andy's prospect through Lynn, but that the peer (alpha) relationship connection between Sue and Lynn was disconnected, thus breaking the prospect relationship connection between Sue and Andy. Disconnects are shown for all cases where an intervening member becomes disconnection from on or the other members they connect.

FIG. 45 is an illustrative partial screen shot provided by the networking environment to member Andy, in connection with a member clicking on the “Presentation Path” icon shown on FIG. 42, showing how Andy and Sue originally were gammas (prospects) both having connections with certain other peers, and that Andy invited Sue to connect as a beta. Presentation Paths are only shown where one member has invited another member to connect as a beta, and also after a member has accepted. Presentation paths are provided in this embodiment only for combinations of two alphas (gamma) (prospect) of an alpha and a beta (delta)) (possibility) relationship connections, other embodiments provide for combinations of two alphas and a beta, while other embodiments for other combinations of the same or different primary relationship connections.

FIG. 46 is an illustrative partial screen shot provided by the networking environment to member Andy, in connection with a member clicking on the “My Peers” or “Sue's Peers” icons shown on FIG. 45, showing Andy's and Sue's “Mutual Peers” and providing means to Poll mutual peers.

FIG. 47 is an illustrative partial screen shot provided by the networking environment to member Andy, in connection with a member clicking on the “Prior Paths” icon shown on FIG. 46, showing Andy's peers that have disconnected (de-peered) with Sue and providing means for polling her about Sue.

FIG. 48 is an illustrative partial screen shot provided by the networking environment to member Andy, in connection with a member clicking on the circle to the left of words Public Search and then clicking on the Save Changes icon in the Privacy section of the Settings GUI page shown on FIG. 33, upon changing the privacy setting to public the system will add a PUBLIC PROFILE icon for clicking on and entering information that will be available to all members.

FIG. 49 is an illustrative partial screen shot provided by the networking environment to member Mike showing the Personal Peersona (personal network) console GUI page for Mike, a relatively new member.

FIG. 50 is an illustrative partial screen shot provided by the networking environment to member Mike, after clicking on the Invite Peer icon shown in FIG. 49 and entering “Andy” and the email address in the “By email” section.

FIG. 51 is an illustrative partial screen shot provided by the networking environment to member Mike, after clicking on the “Send Peer Invitation” icon shown in FIG. 49.

FIG. 52 is an illustrative partial screen shot provided by the networking environment to member Andy, showing Andy's Notifications Page after Mike clicked on “Send Peer Invitation” shown in FIG. 50.

FIG. 53 is an illustrative partial screen shot provided by the networking environment to member Andy, after Andy clicked on the “Process Peers” icon shown in FIG. 52, showing in the “Peer Invite Requests” section Mike's invitation to connect as peers (alphas), and providing for Andy to select the peersona network (aspect network) Andy chooses to peer with Mike if he accepts.

FIG. 54 is an illustrative partial screen shot provided by the networking environment to member Andy, after Andy clicked on the Mike icon in the “Peer Invite Requests” section shown in FIG. 53, thereby showing Mike's peerpage and associated information or icons to access same.

FIG. 55 is an illustrative partial screen shot provided by the networking environment to member Andy, after Andy went back to his Notifications GUI page, in this case by clicking on “View Presentations” icon shown on FIG. 54 and after Andy selected to join as peers with Mike in Andy's “Pink Drink” peersona network (aspect network), even though Mike had sent his invitation from his Personal Peersona.

FIG. 56 is an illustrative partial screen shot provided by the networking environment to member Mike, of Mike's Notification's GUI page after Andy had clicked on the Accept invitation icon shown in FIG. 55 and after Mike had clicked on the “Process Peers icon”, Mike clicks on the “Decline” icon as he does not want to become part a of a network called “Pink Drink”.

FIG. 57 is an illustrative partial screen shot provided by the networking environment to member Andy, showing on his Social Peersona console page Sue in the “My Prospects” section.

FIG. 58 is an illustrative partial screen shot provided by the networking environment to member Andy, showing Sue's peerpage as it appears to Andy after Andy clicked on Sue icon shown in FIG. 57.

FIG. 59 is an illustrative partial screen shot provided by the networking environment to member Andy, showing Sue's peerpage as it appears to Andy after Andy clicked on “Let's Connect” icon shown in FIG. 58, clicking on the “Let's Connect” icon send an invitation to connect as a beta (Contact) to Sue.

FIG. 60 is an illustrative partial screen shot provided by the networking environment to member Sue, showing Sue's Notification page after Andy clicked on “Let's Connect” icon shown in FIG. 58 and shows that there is 1 presentation (invitation to be a contact) to be processed.

FIG. 61 is an illustrative partial screen shot provided by the networking environment to member Sue, showing Sue's Notification page after Sue clicked on the “Process Presentation” icon in FIG. 60.

FIG. 62 is an illustrative partial screen shot provided by the networking environment to member Sue, showing Andy's peerpage.

FIG. 63 is an illustrative partial screen shot provided by the networking environment to member Sue, after Sue clicked on the “Poll” icon shown in FIG. 62, showing Sue's mutual peers with Andy and providing Sue with the means to poll all or some of those peers to gather information about Andy.

FIG. 64 is an illustrative partial screen shot provided by the networking environment to member Sue, after Sue clicked on the “Prior Paths” tab shown in FIG. 63, showing Sue's peers (alphas) who have de-peered (disconnected) from Andy in the past and providing Sue with the means to poll all or some of those peers to gather information about Andy.

FIG. 65 is an illustrative partial screen shot provided by the networking environment to member Matt, showing Matt's “Post” (message) GUI page after Sue had clicked on the “Send Poll Message” regarding Matt shown on FIG. 64.

FIG. 66 is an illustrative partial screen shot provided by the networking environment to member Matt, showing Matt's “Post” GUI page after Matt had clicked on the “Reply” icon next to Sue and after Matt had typed his response in the message box.

FIG. 67 is an illustrative partial screen shot provided by the networking environment to member Matt, showing Matt's “Post” GUI page after Matt had clicked on the “Post It” icon shown in FIG. 66.

FIG. 68 is an illustrative partial screen shot provided by the networking environment to member Sue, showing Sue's “Post” GUI page after Matt had clicked on “Post It” icon shown in FIG. 66.

FIG. 69 is an illustrative partial screen shot provided by the networking environment to member Sue, showing Sue's “Post” GUI page after Sue clicked on the “1 Reply” icon next to Matt's reply reference in FIG. 68 and shows Matt's response to Sue's poll of Andy.

FIG. 70 is an illustrative partial screen shot provided by the networking environment to member Sue, showing Sue's Notification GUI page after clicking on “Process Presentations.”

FIG. 71 is an illustrative partial screen shot provided by the networking environment to member Sue, showing Andy as a beta in the “My Peersonify Contacts” section of Sue's console after Sue clicked on the “Confirm” icon confirming Andy as a contact (beta) on the screen shown on FIG. 70.

FIG. 72 is an illustrative partial screen shot provided by the networking environment to member Andy, showing Sue as a beta in the “My Peersonify Contacts” section of Andy's console after Sue clicked on the “Confirm” icon confirming Andy as a contact (beta) on the screen shown on FIG. 70.

FIG. 73 is an illustrative partial screen shot provided by the networking environment to member Andy, showing Sue's peerpage after Andy clicked on Sue's icon in FIG. 72 which shows Andy that Sue has a Bicycling Peersona.

FIG. 74 is an illustrative partial screen shot provided by the networking environment to member Andy, after Andy clicks on the circle selecting the Bicycling Peersona shown on FIG. 73, and shows information about Sue in her Bicycling Peersona network, including her Public and Private Peers in Sue's Bicycling Peersona, in one embodiment, in another embodiment only the Public Peers would be shown..

FIG. 75 is an illustrative partial screen shot provided by the networking environment to member Andy, shows Andy as having selected as a parallel Peersona to Sue's Bicycling Peersona his Cycling Peersona.

FIG. 76 is an illustrative partial screen shot provided by the networking environment to member Andy, showing Andy's view of Sue's Bicycling Peersona after Andy has clicked on the “Let's Connect” icon shown in FIG. 75.

FIG. 77 is an illustrative partial screen shot provided by the networking environment to member Sue, showing Sue's Notification GUI page, after Andy has clicked on the “Let's Connect” icon shown in FIG. 75, and showing that there is 1 “Process Peeks”.

FIG. 78 is an illustrative partial screen shot provided by the networking environment to member Sue, showing Andy's request to connect from his Cycling Peersona to Sue's Bicycling Peersona as a contact (beta).

FIG. 79 is an illustrative partial screen shot provided by the networking environment to member Sue, showing Andy's peerpage on Sue's Bicycling Peersona after Sue clicked on the “Confirm” icon shown on FIG. 78 accepting Andy's offer to connect as a contact (beta).

FIG. 80 is an illustrative partial screen shot provided by the networking environment to member Andy, showing Sue's peerpage on Andy's Cycling Peersona after Sue clicked on the “Confirm” icon shown on FIG. 78 accepting Andy's offer to connect as a contact (beta). In another embodiment, Ndy would need to confirm the Petition.

FIG. 81 shows an illustrative environment for providing a networking environment according to an embodiment.

FIGS. 82A-D show an illustrative series of interactions between members of the networking environment according to an embodiment.

FIGS. 83A-D show an illustrative series of communication abilities between the members shown in FIGS. 82A-D according to an embodiment.

FIG. 84 shows an illustrative table for storing events according to an embodiment.

FIG. 85 shows an illustrative profile page according to an embodiment.

FIG. 86 shows an illustrative peer page according to an embodiment.

FIG. 87 shows an illustrative member page according to an embodiment.

FIG. 88 shows an illustrative relationships page according to an embodiment.

### DETAILED DESCRIPTION OF THE INVENTION

In accordance with one preferred embodiment of the invention, member relationship connections are generally divided into three categories with attendant communication and information system functionality, namely: (i) primary, the alphas and betas; (ii) secondary, the gammas, deltas, epsilons and thetas; and (iii) no relationship connection. The alpha and beta categories of primary relationship connections provide for keeping alphas (peers) close to you and not diluting alpha relationship connections through the need to add new relations connections as alphas. Alpha relationship connections are also referred to as peer relationship connections. An alpha is a peer and vice versa. Typically, a member is shown in the presence of that member's peers. The alpha can function as collaborators as they serve to reinforce and expand upon a member's autobiographical profile. Alphas may also function as collaborators as their actions in growing connections serve as the basis for the automatic formation of new connections for their alphas. The actions of the alphas activate the proliferation of a memebr's gammas, deltas, epsilons and thetas.

Instead a member can use beta relationship connections to add relevant additional relationship connections; and then using the alpha and beta relationships as they change, the network, system and method of the present invention using relationship data automatically establishes the second relationship connections, the gammas, deltas, epsilons and thetas relationship connections. Again, the use of the beta primary relationship connection in accordance with the present invention, allows alphas not to dilute their alpha membership by adding new members, instead the invention provides that new contacts can be added as betas and still have communication flow and information sharing without the need to unnecessarily dilute the peer-age.

In this embodiment, a member's relationship connections are based on all permutations of a total of three primary relationship connections, consisting of one, two and three alpha connections and one beta primary relationship connections along with one or two alpha connections, thereby providing for gamma, delta, epsilons and thetas secondary relationship connections.

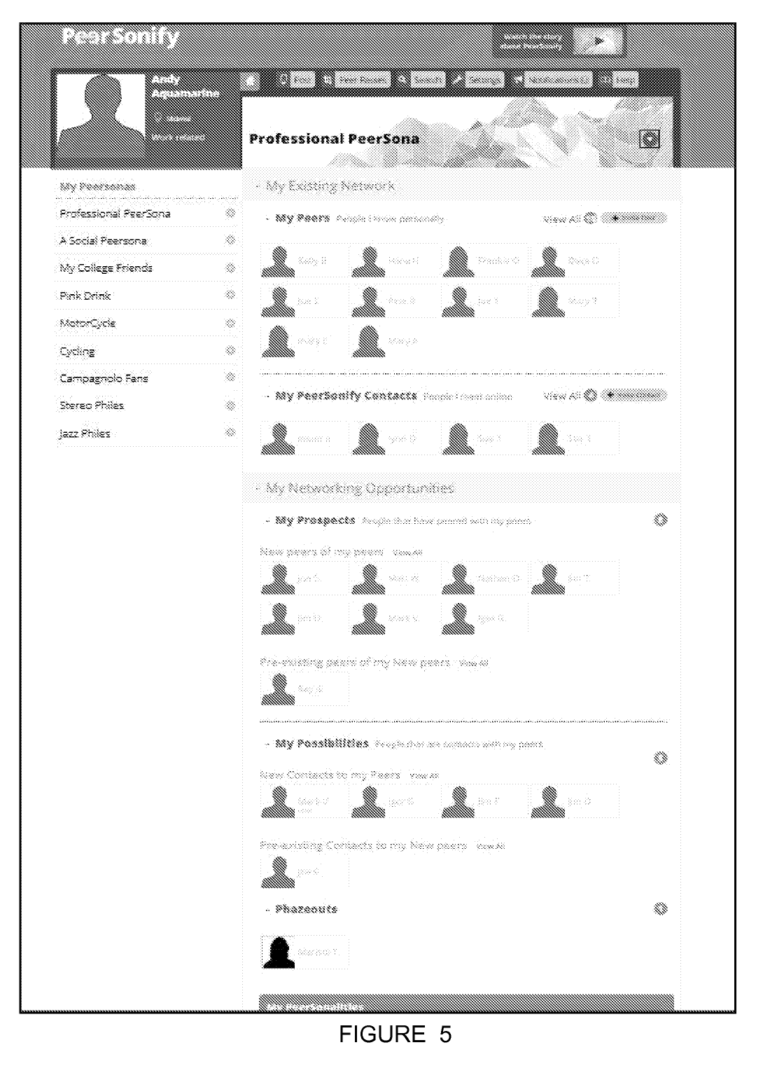

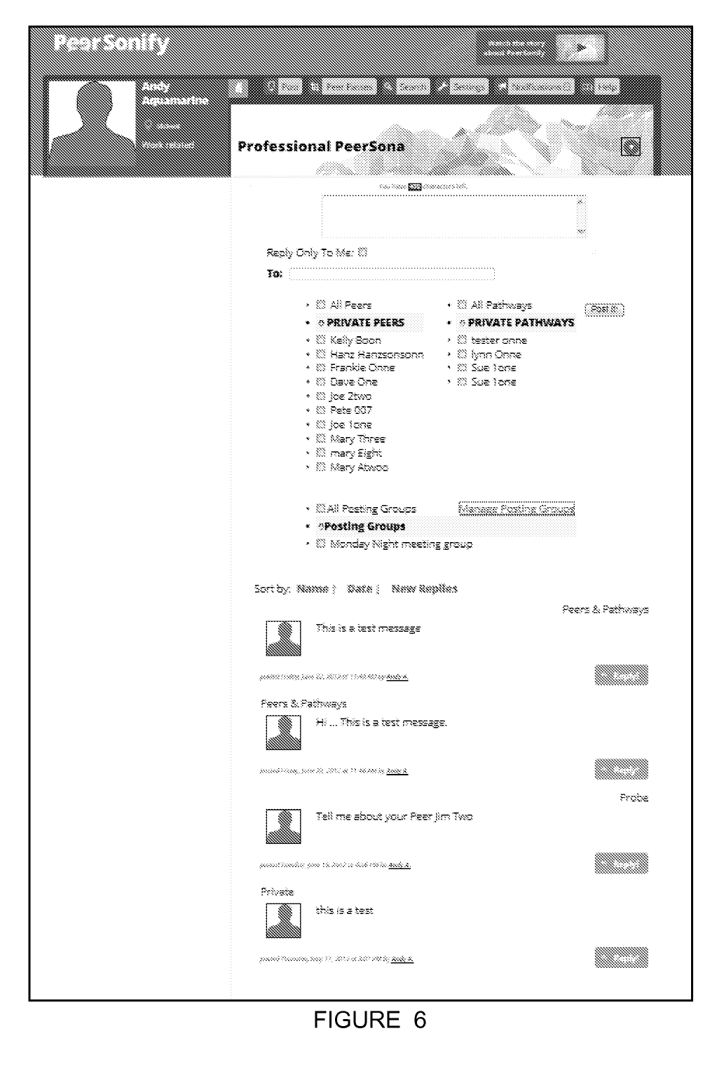

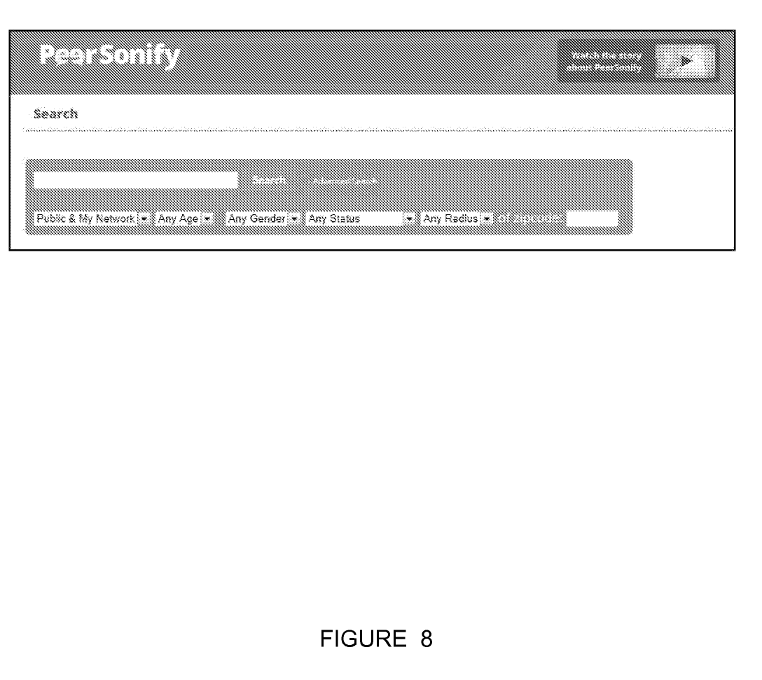

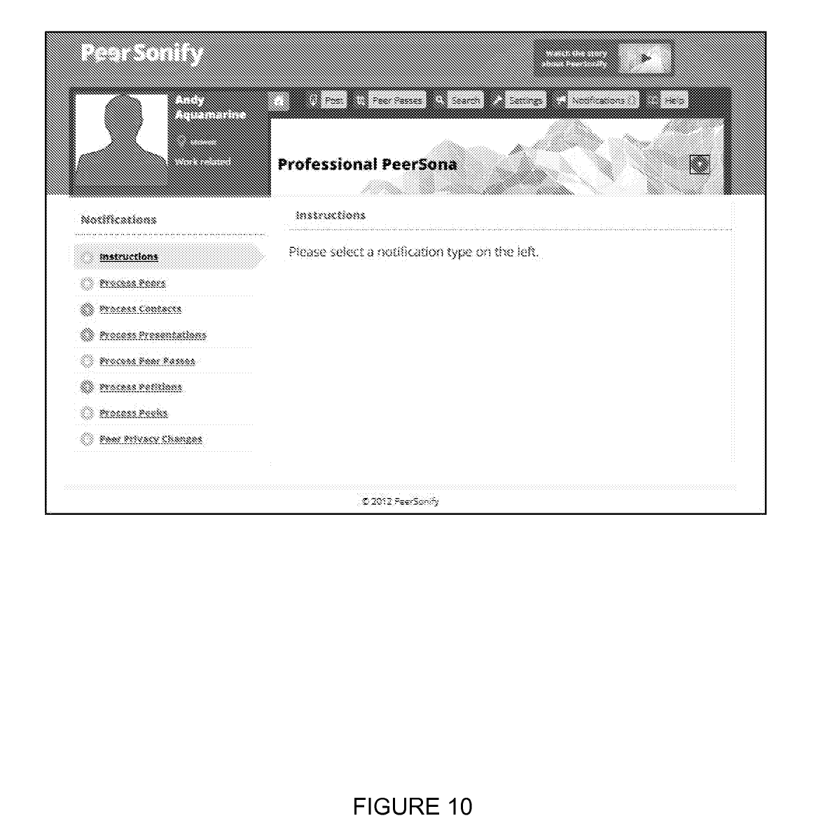

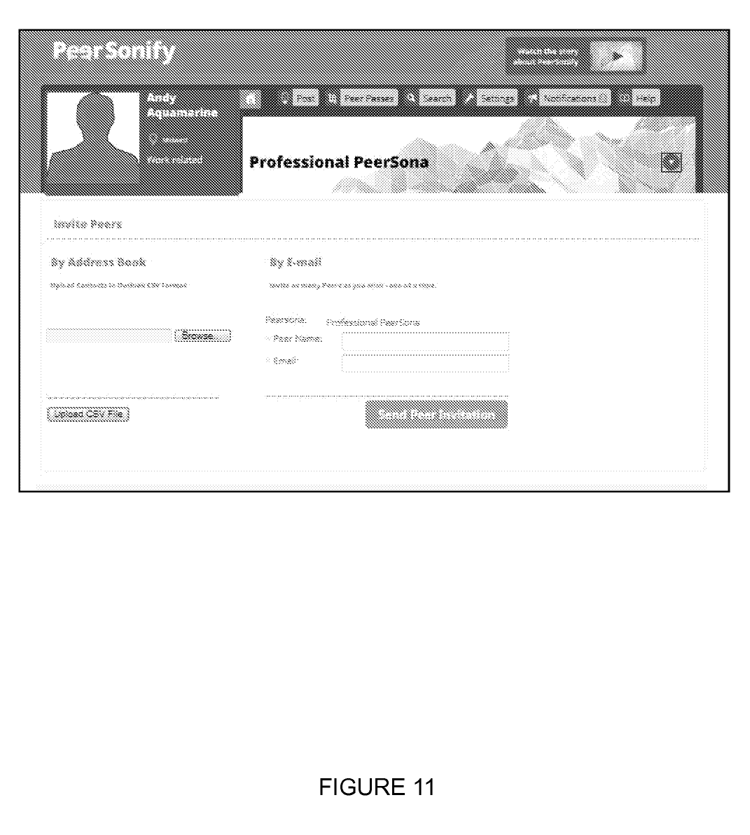

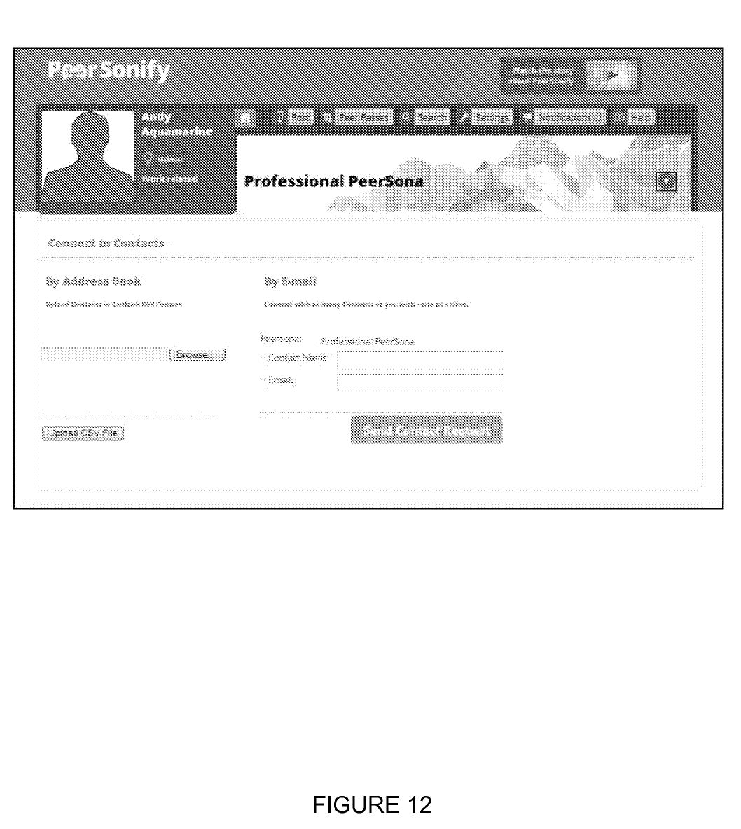

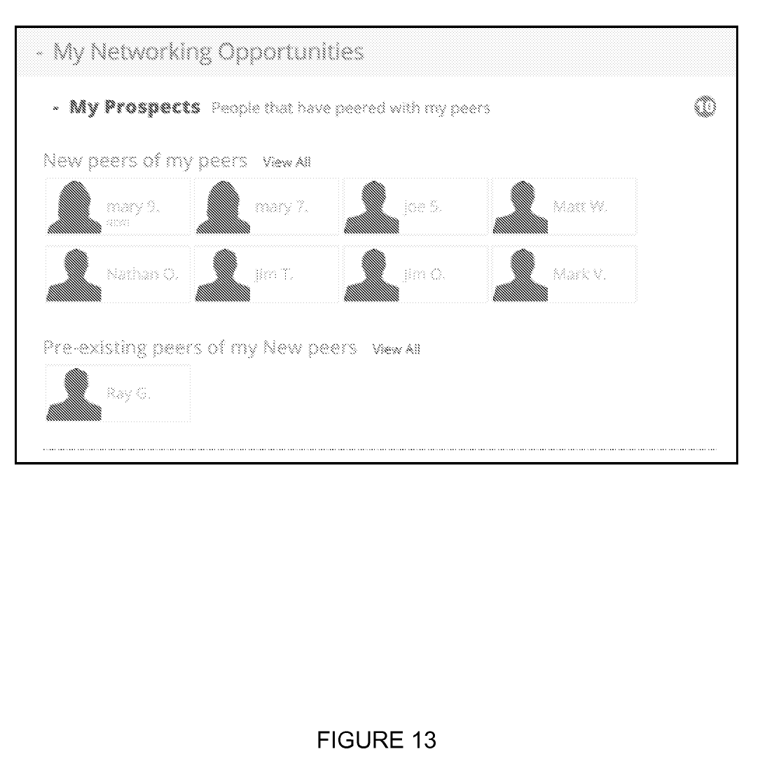

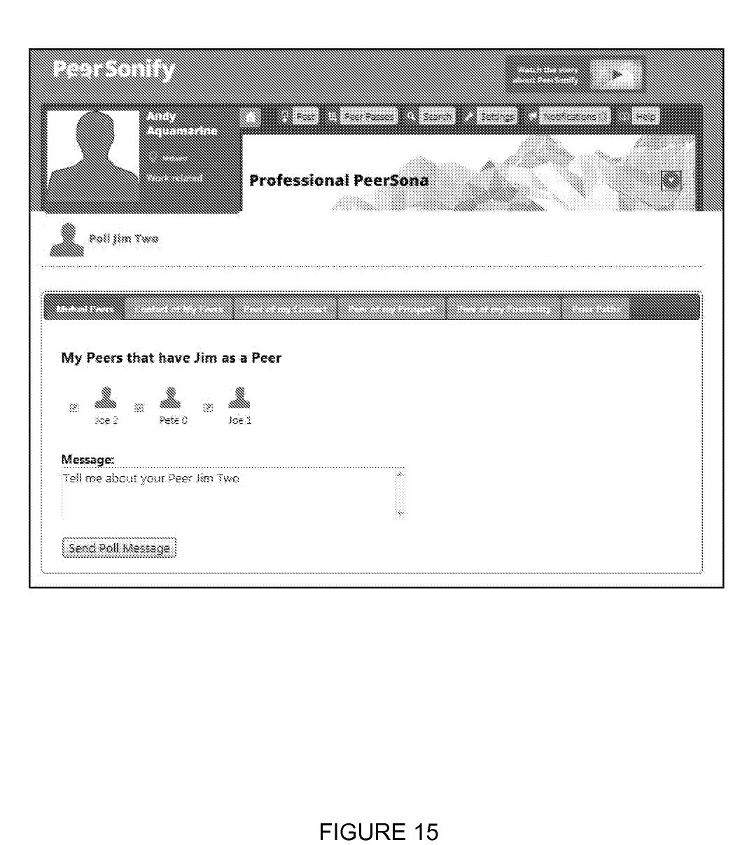

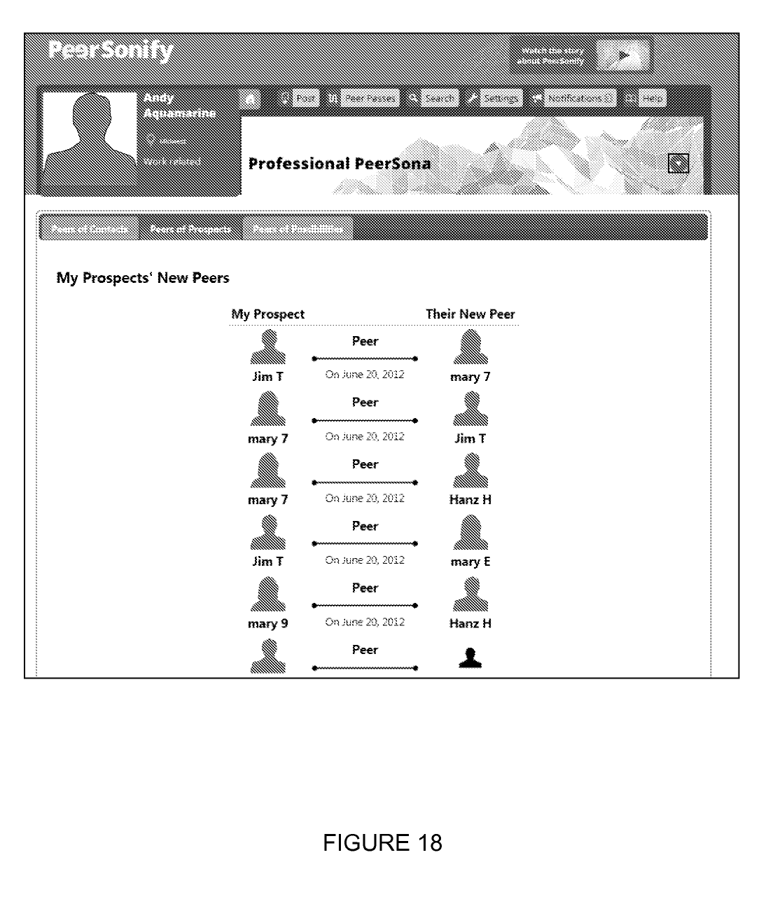

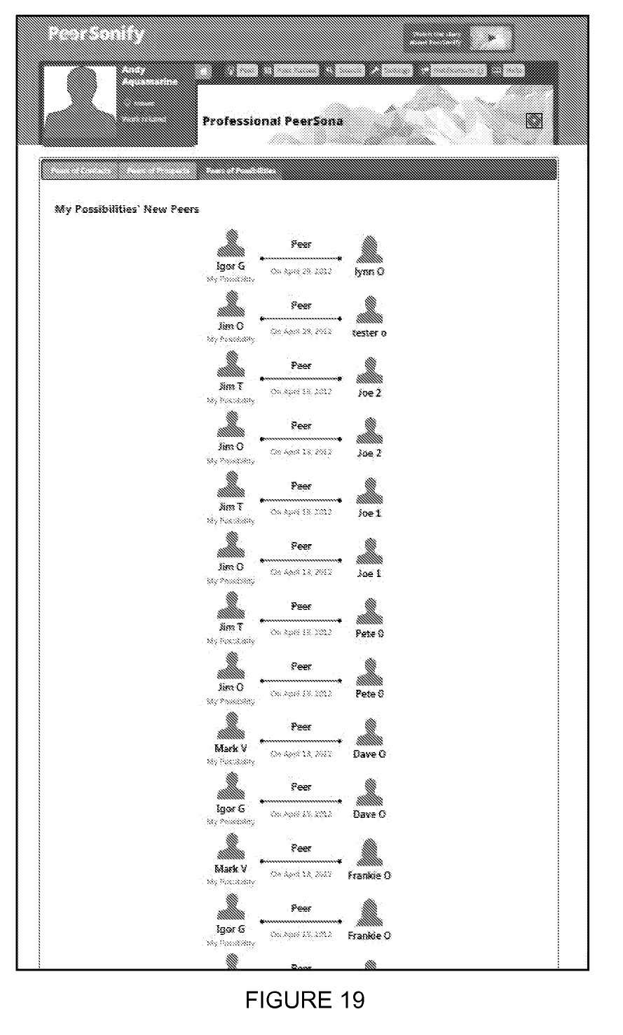

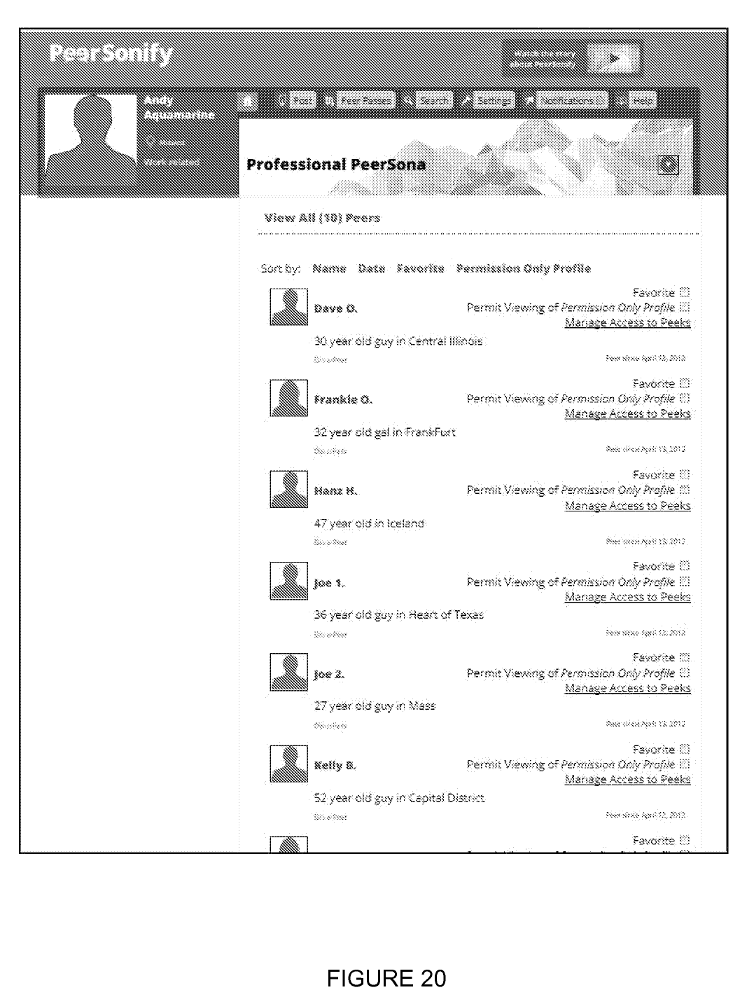

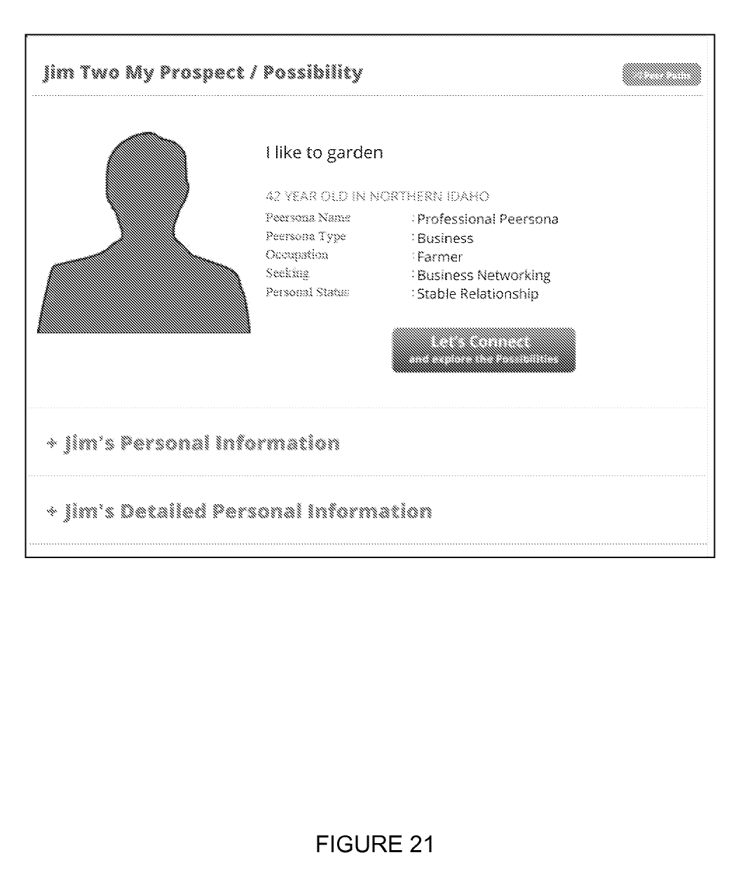

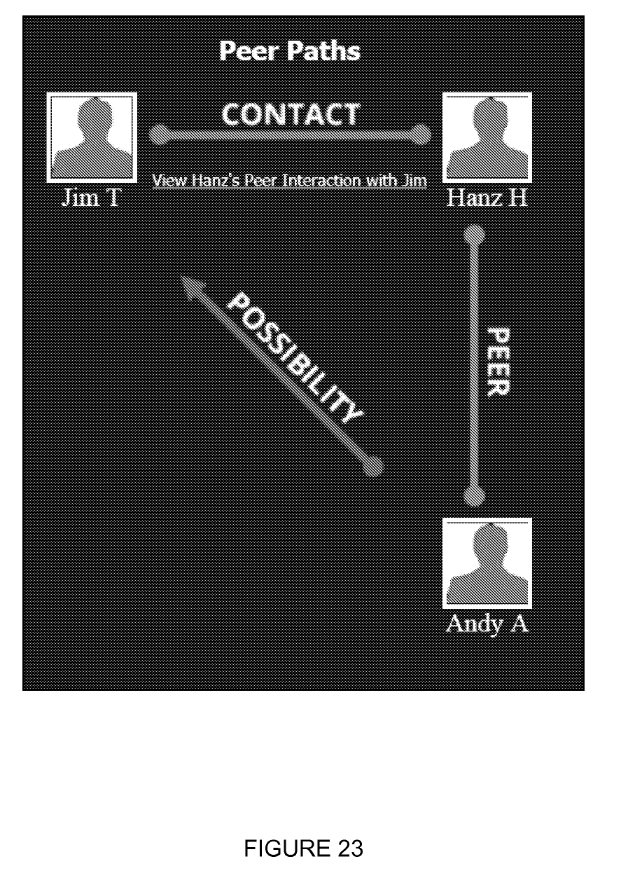

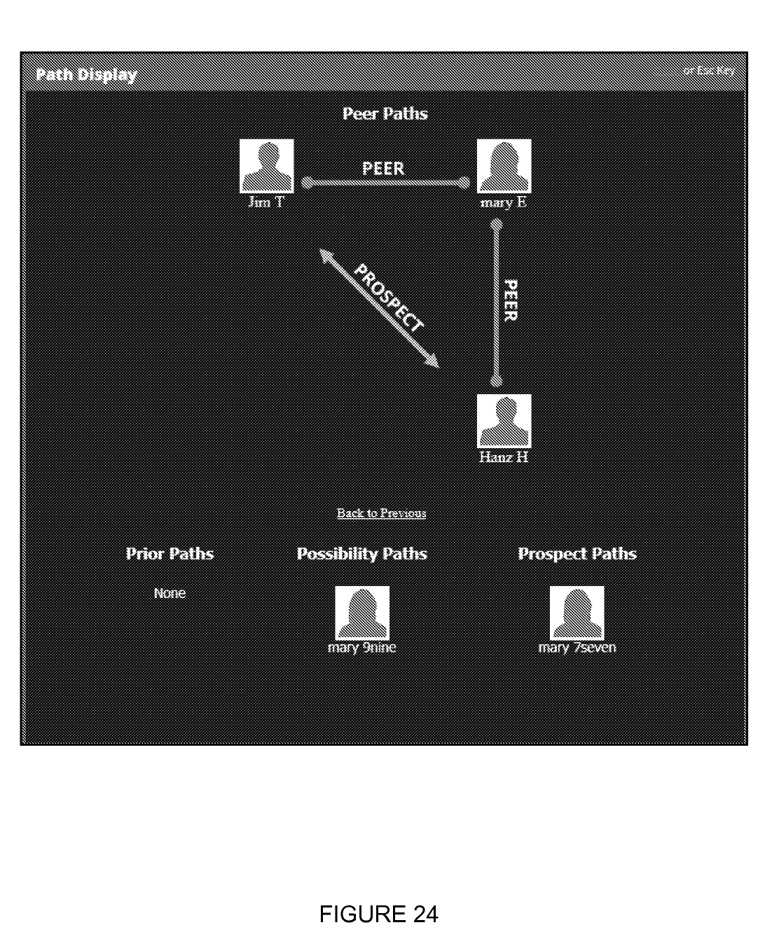

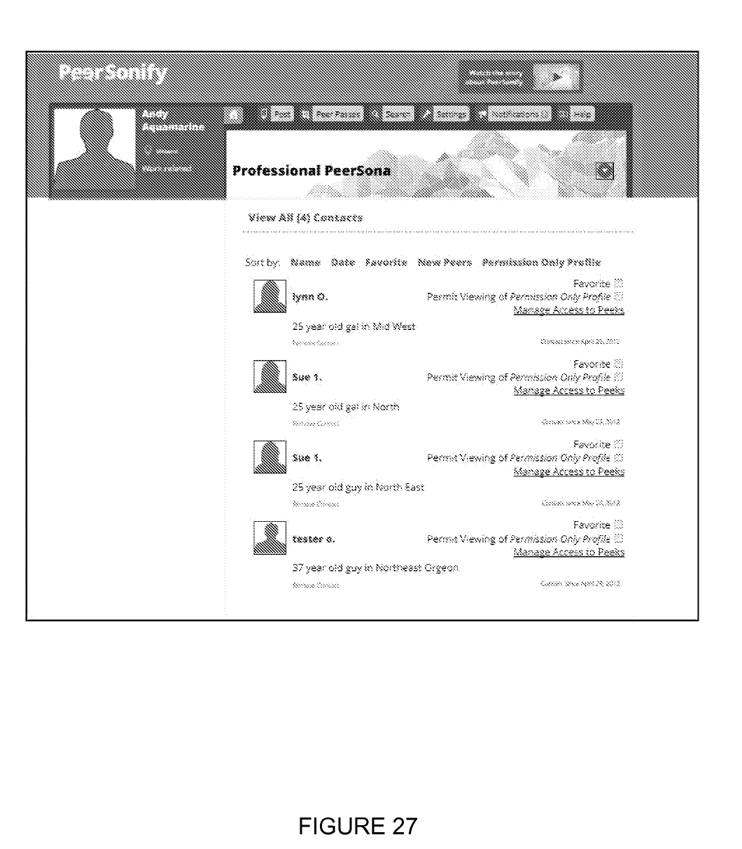

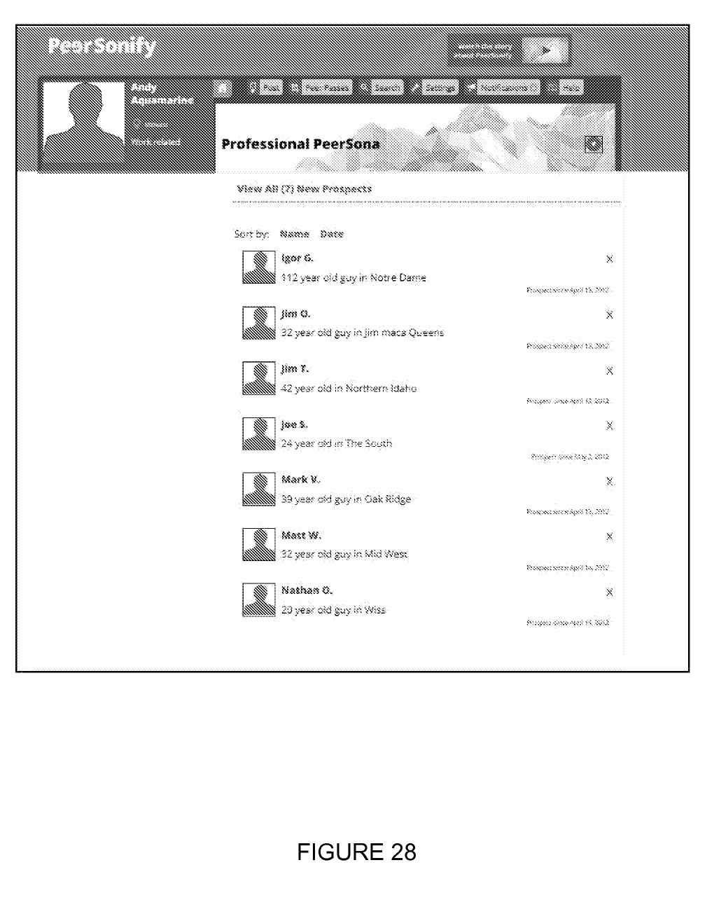

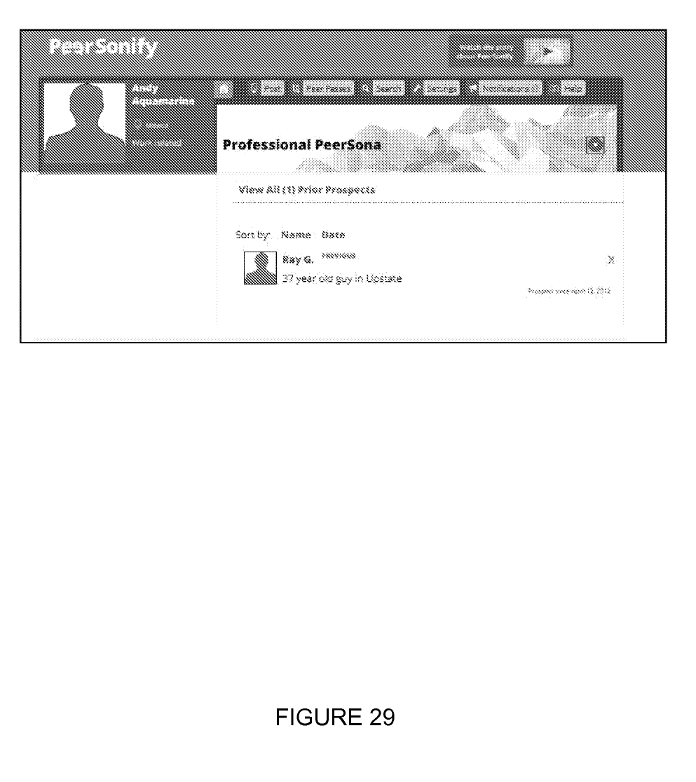

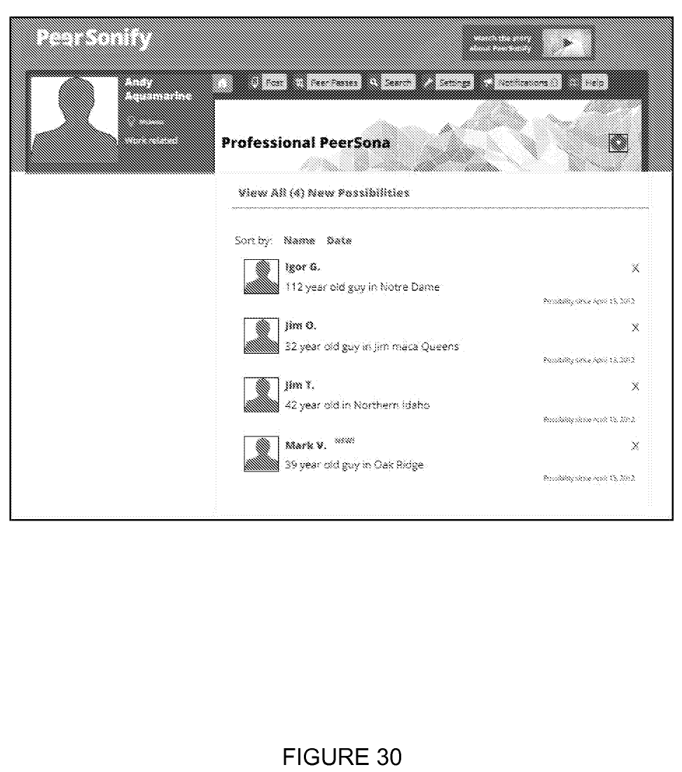

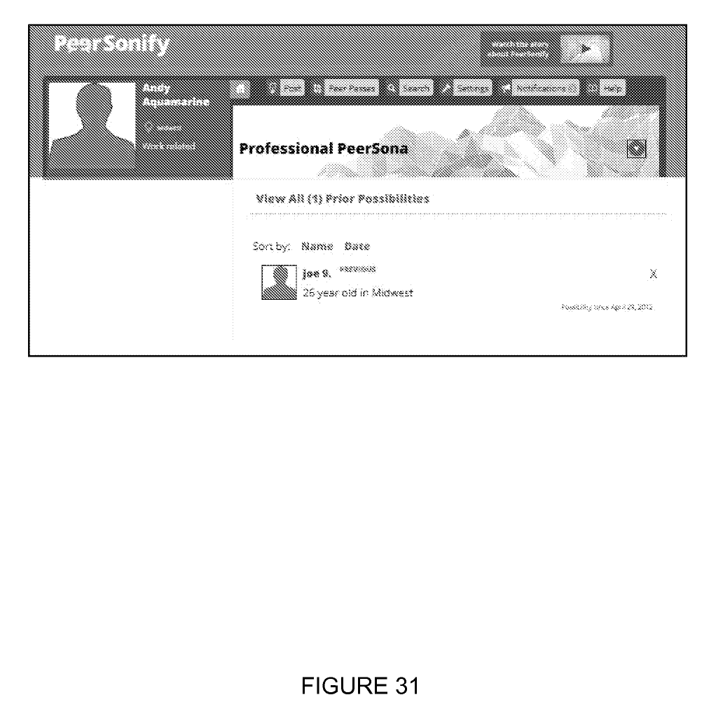

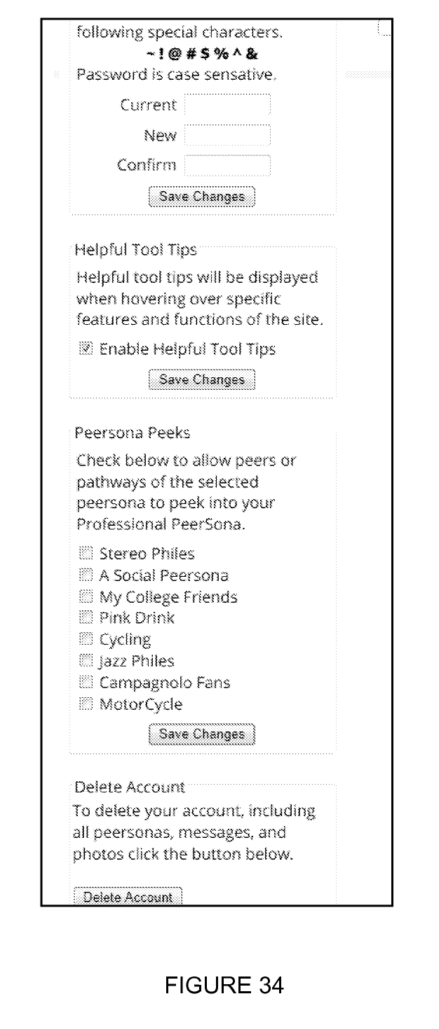

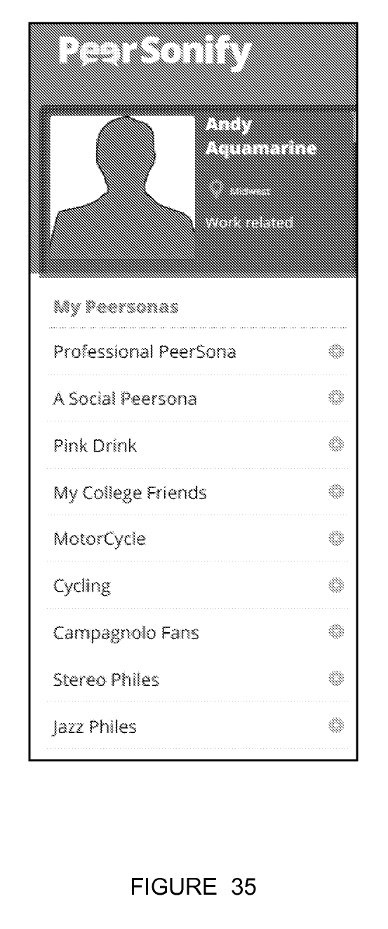

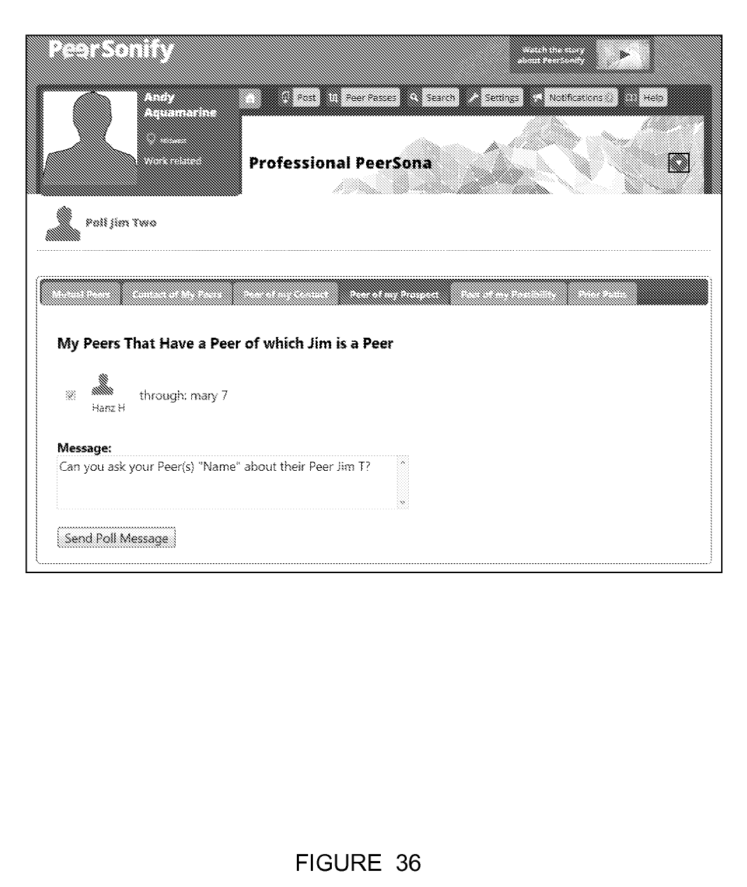

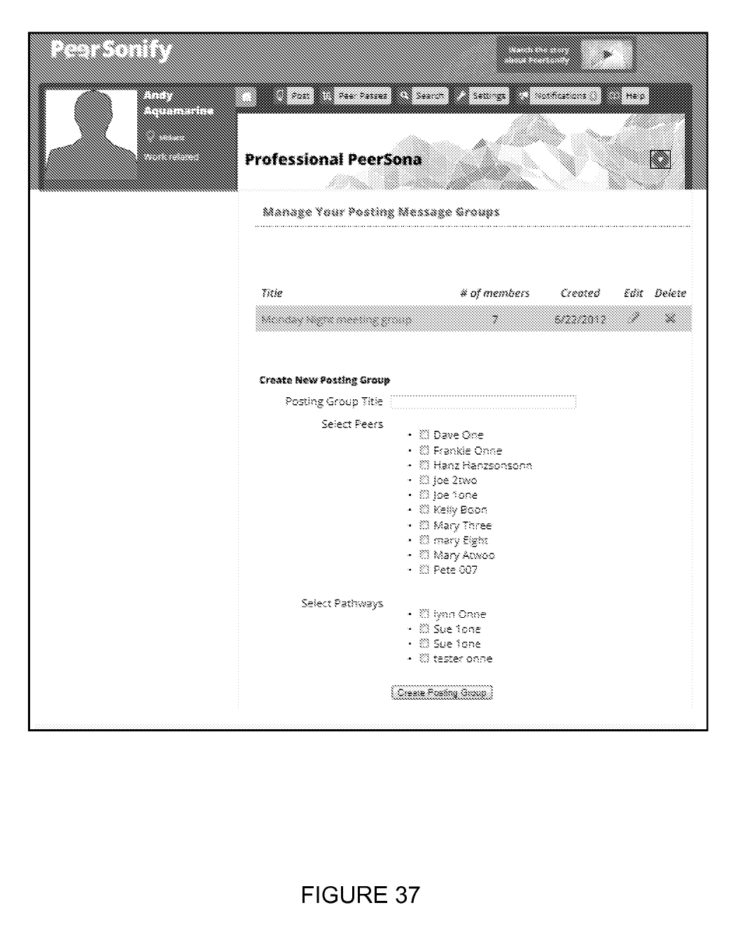

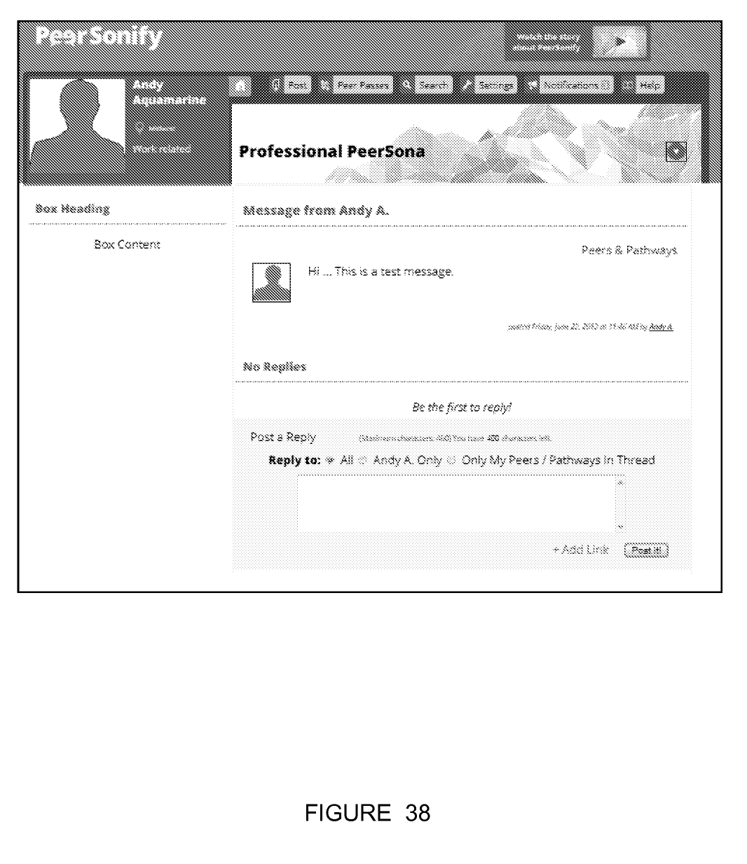

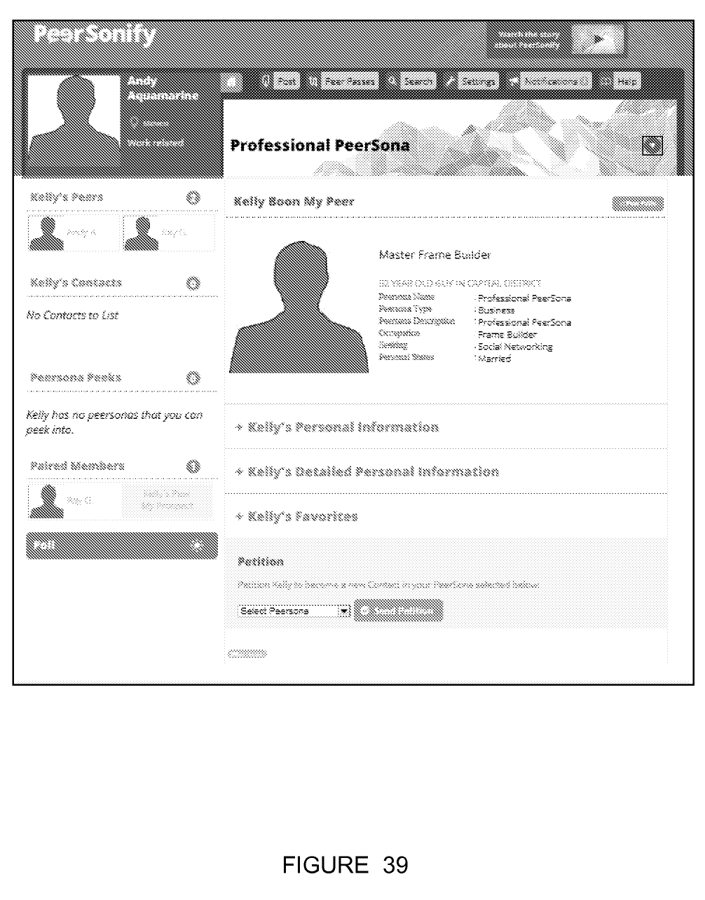

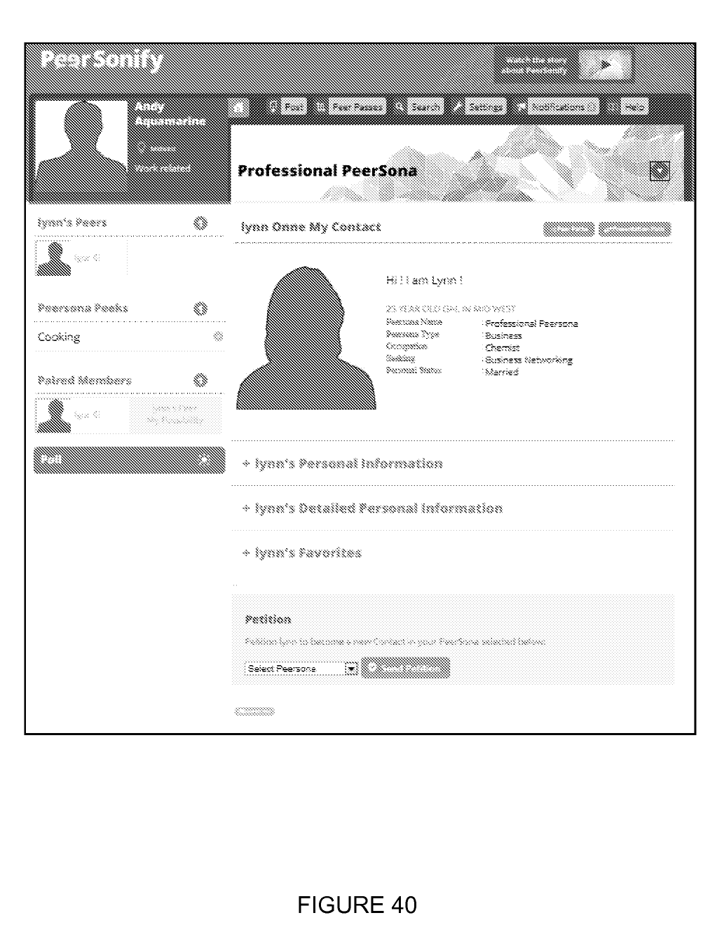

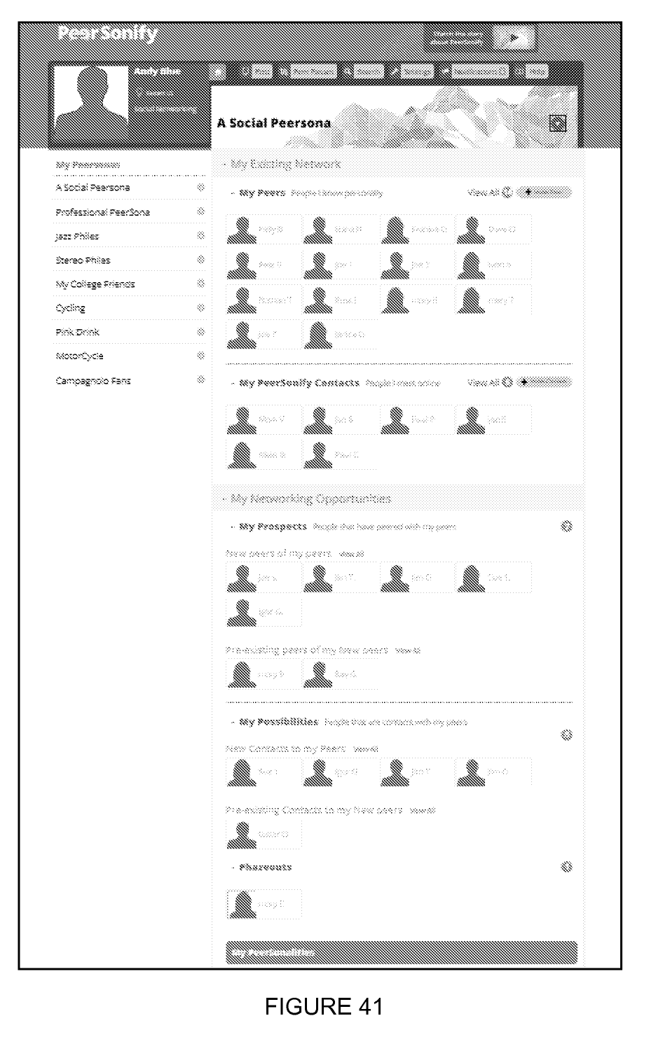

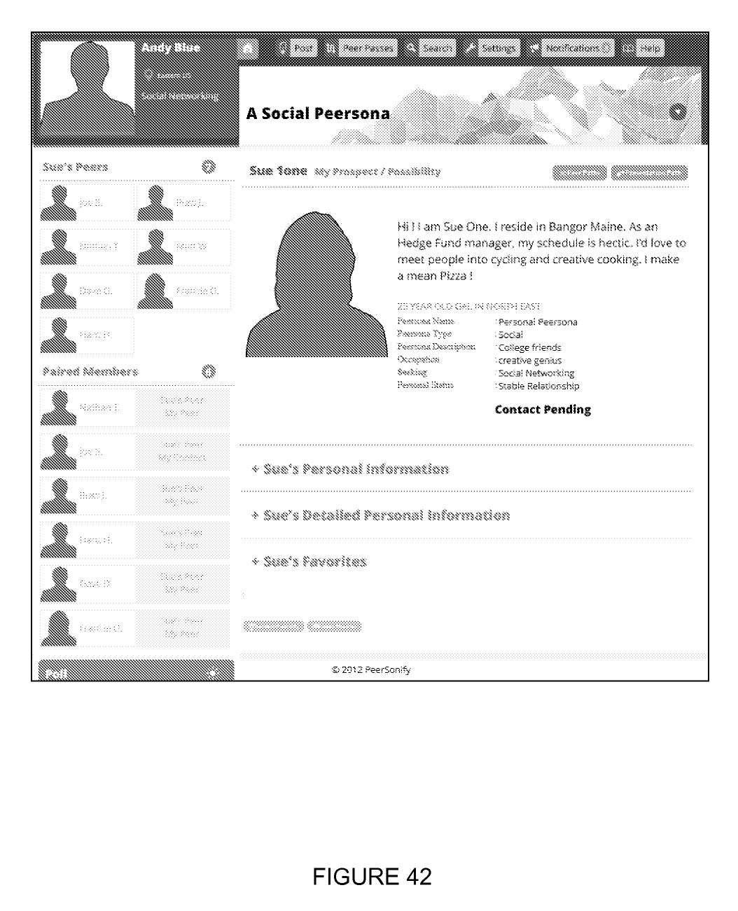

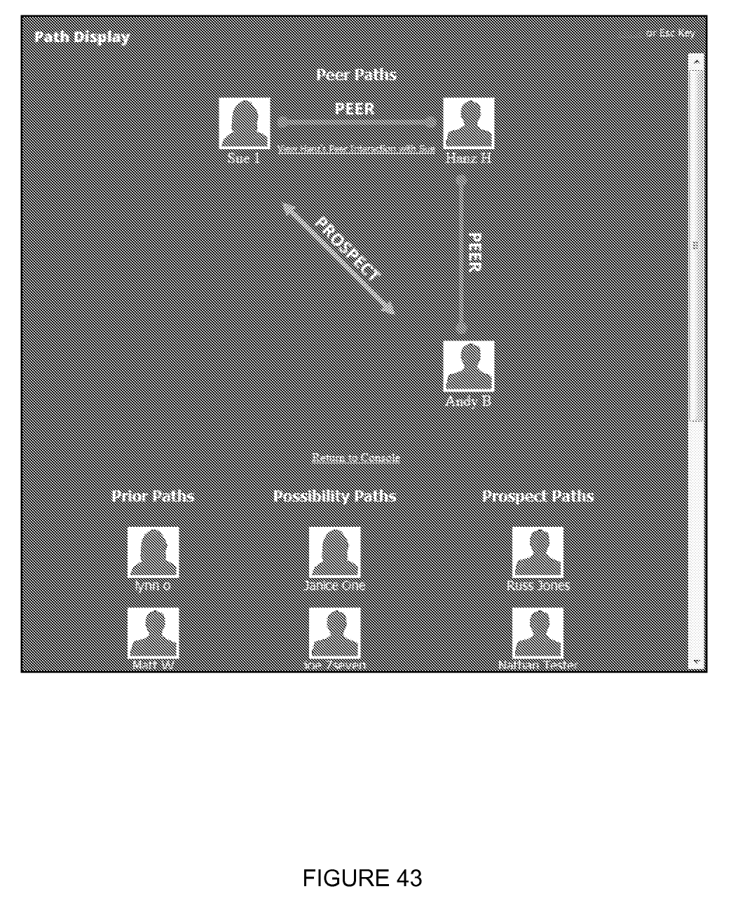

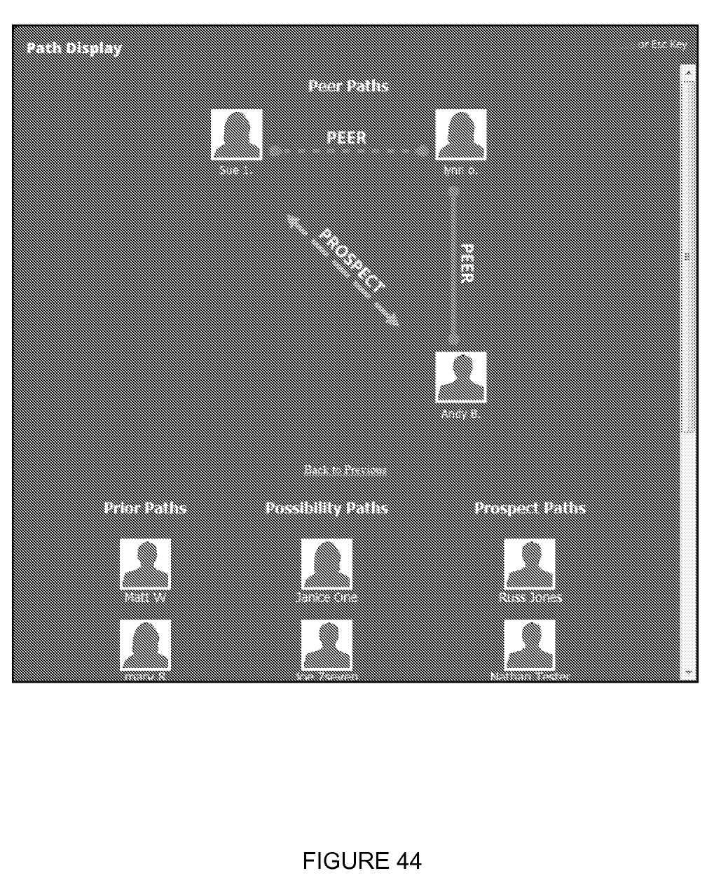

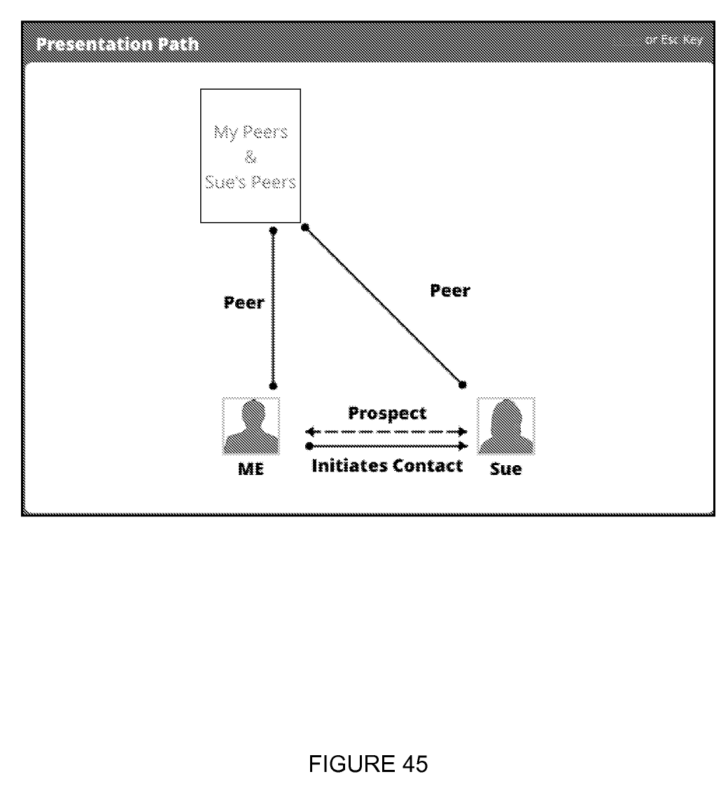

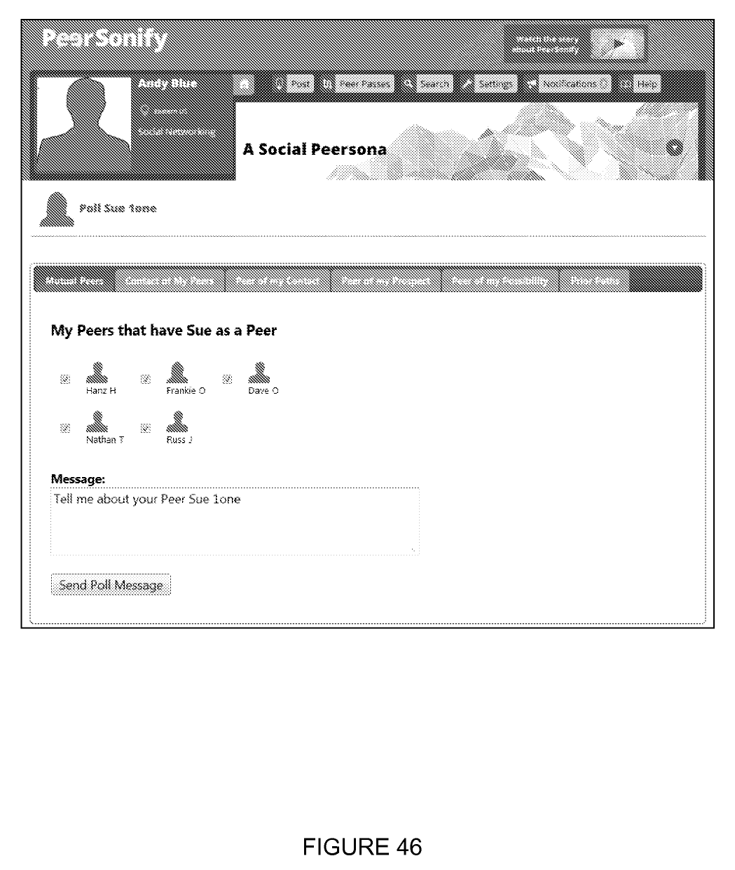

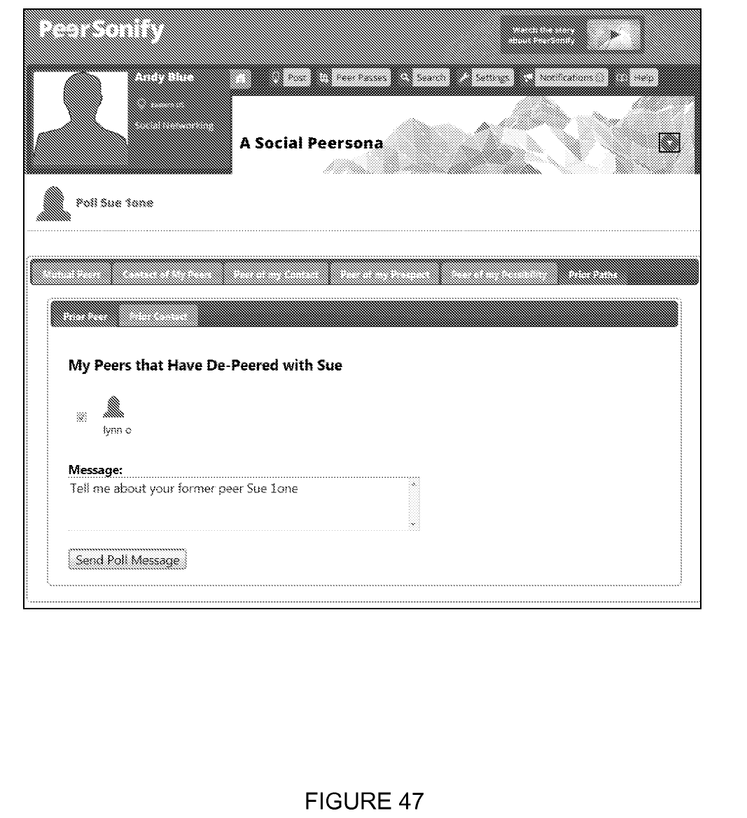

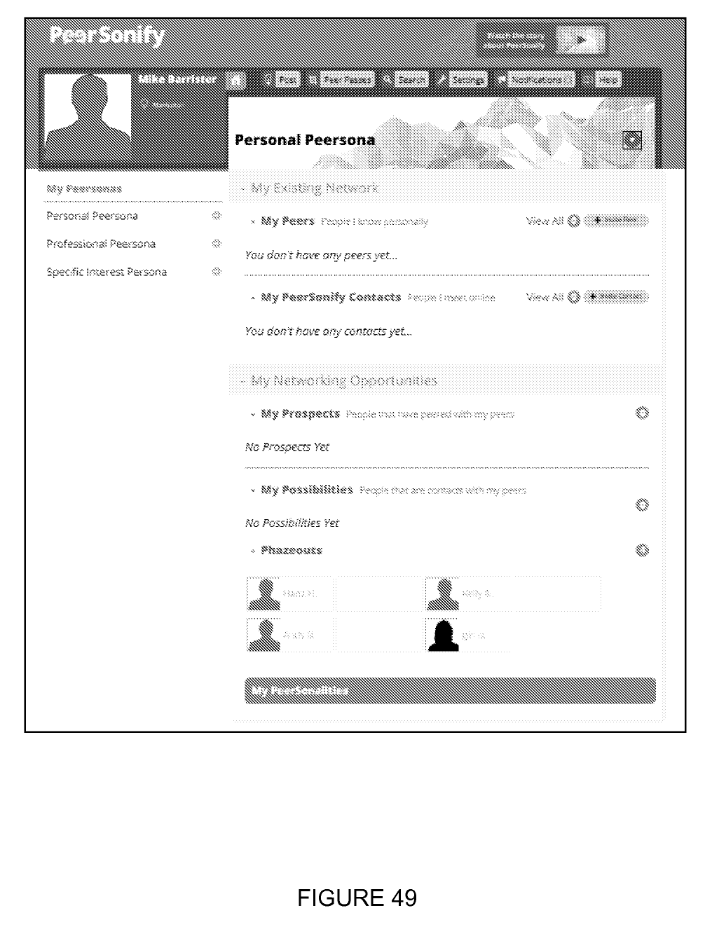

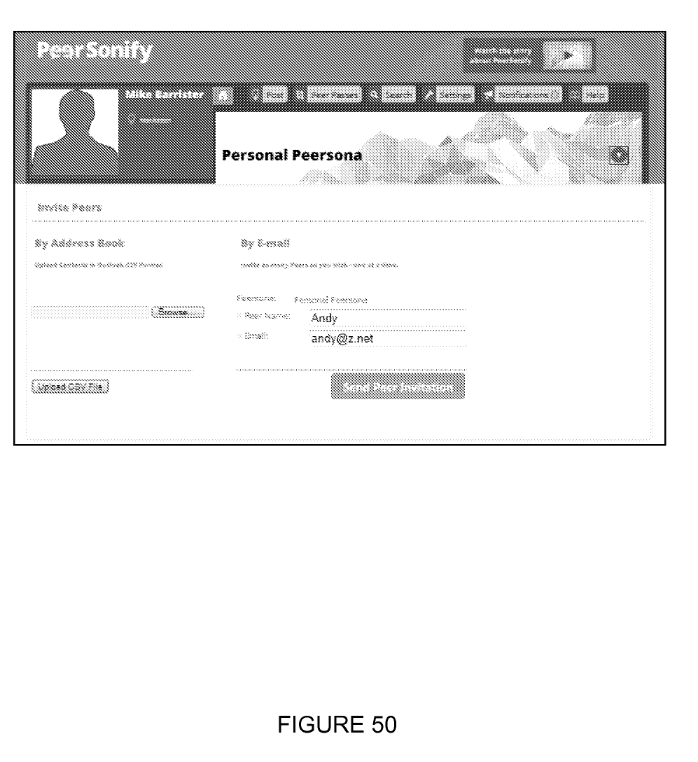

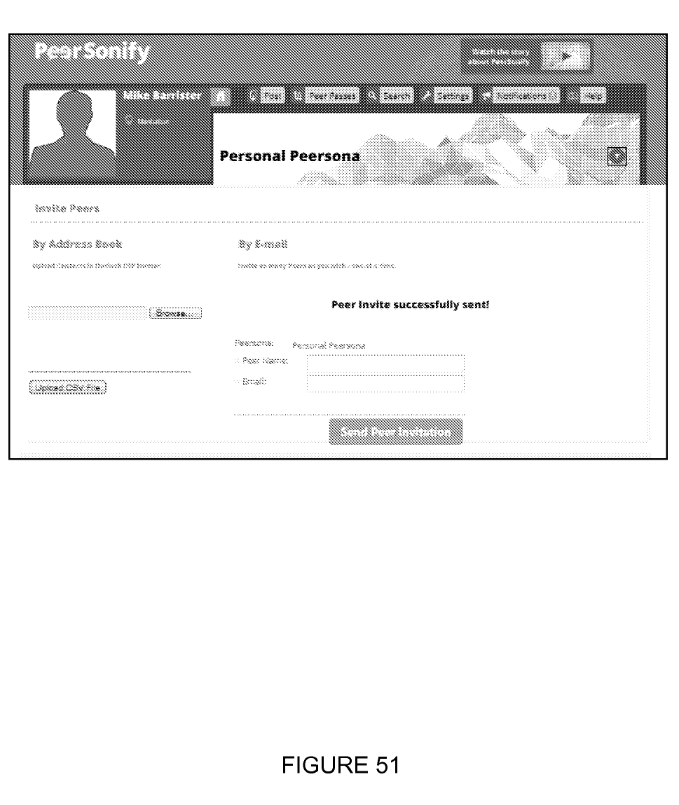

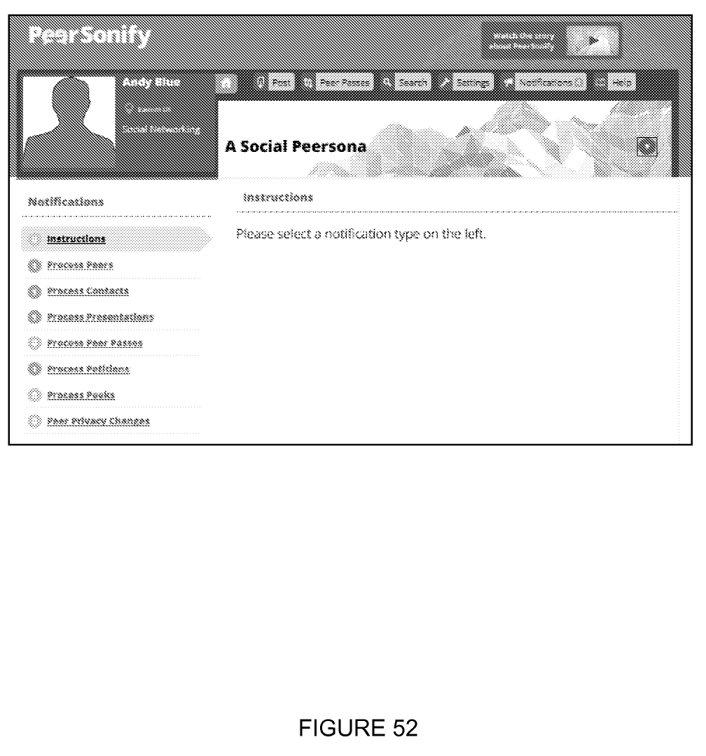

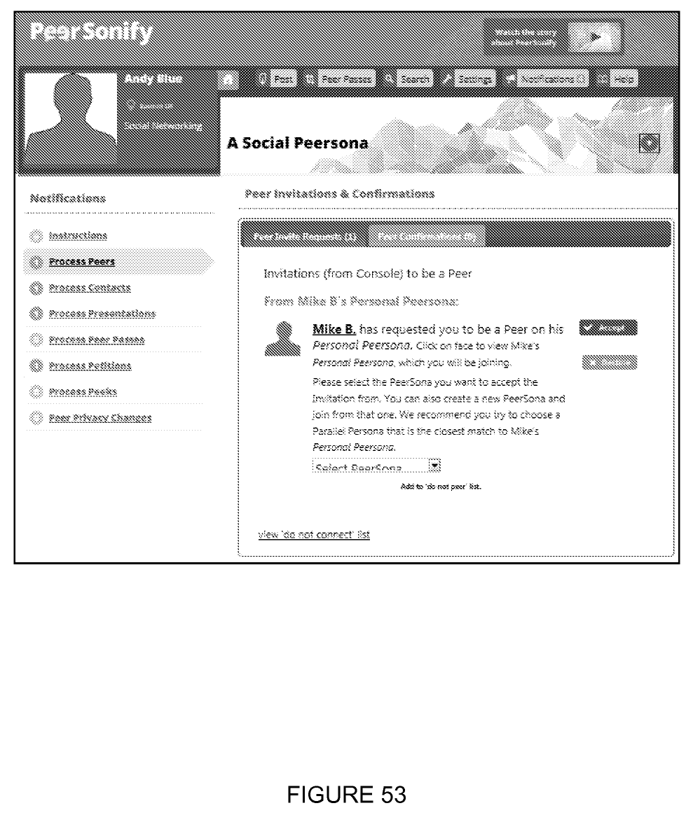

In other embodiments, only specified permutations of two alphas and a beta may be utilized thus resulting for example in provision only for gamma, delta and epsilons relationship connections. See FIGS. 5-50, for example. In accordance with the invention, other embodiments may provide member's relationship connections based on all permutations of one alpha and one beta primary type relationship connections. In accordance with the invention, other embodiments may provide member's relationship connections based on same or different permutations of the same or different primary relationship connections.

Built into the presentation of the display of members in the preferred embodiments shown in FIGS. 5-50, is the assumption that the following order of relationship connections relevancy in vetting potential connections from highest to lowest is alpha, beta, gamma, delta and epsilons. This can be seen, for example, by the way a members alphas (peers), betas (contacts), gammas (prospects) and deltas (possibilities) portraits are displayed on their consoles. Indeed, only reference is made to the epsilons (peersonalities) and no epsilon portraits appear on the console page. See FIG. 5. Moreover, the presentation of the display of members in the preferred embodiments shown in FIGS. 5-50, is generally consistent with showing members in the presence of their alphas (peers) in a primary way. In certain preferred embodiments with thetas, see FIG. 4, thetas would be less relevant than epsilons and would be displayed in accordance with their lesser relevance.

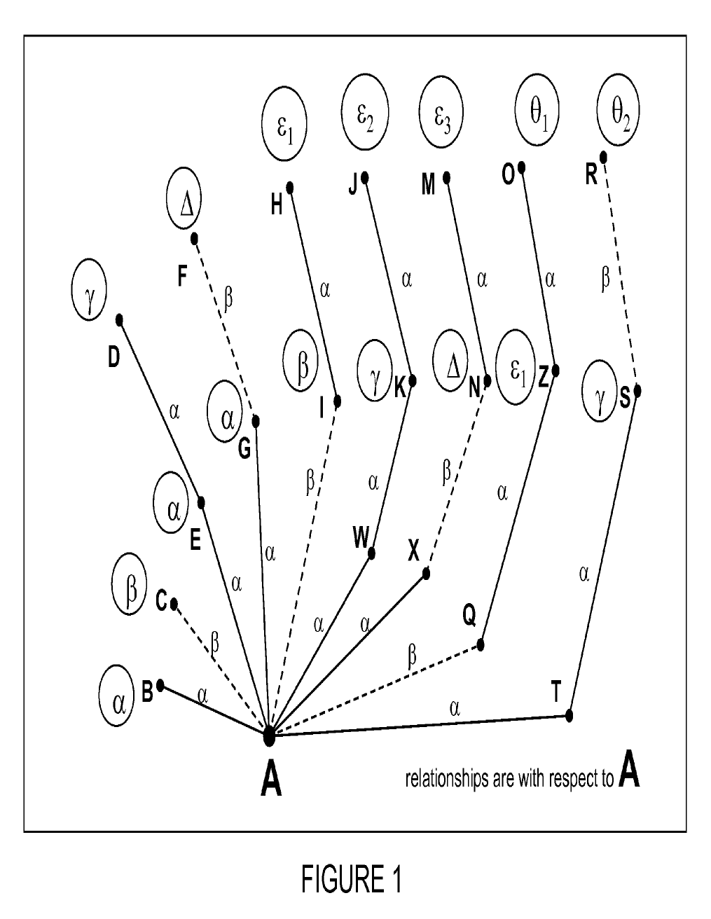

For clarity, as used below, the present notation provides that the direction of the path, that is the alpha and beta links necessary to connect two members the path's direction, is maintained. For example, if the path leads from member A to member B, and the relationship connection is that B is an alpha of A, this alpha relationship is denoted as alpha (BA) or α(BA) and because that is a defined permitted relationship connection for the system member A can see member B. In the parenthetical B is in the first position and A is in the second position. If in other relationship connections there are any intervening relationships connections the common members are deleted and the position of the member in the parenthetical that is first or second position, is always maintained. This will be shown in greater detail below with respect to FIGURE FIG. 1. The following description of primary and secondary relationships refers to one preferred embodiment of the invention.

### The Primary Relationship Connections—the Alphas and Betas

The primary relationship connections require that both members to the relationship connection agree in advance to the relationship. In one embodiment preferred embodiment, the agreement takes the form of member A inviting member B, member B accepting the invitation, and member A confirming member B's acceptance. Other embodiments encompass other variations of agreement, some with and some without confirmation of acceptance, but all require some form of affirmative agreement to enter into the primary relationship connection. alphas (α) (peers) are members who have agreed to be in an alpha relationship.

If P is an alpha of A, the relationship is designated as α(P of A) or aα(PA). Once the alpha relationship is established by mutual agreement of both members, in the form of one member (invitor) inviting the other member (invitee) to enter into an alpha relationship and the invitation is accepted by the invitee, and in one preferred embodiment, acceptance is confirmed by the invitor, the system associates alpha relationship data with the alpha members and enables those members in an alpha relationship connections, that is both α(PA) and α(AP), to automatically (a) view information about each other; (b) communicate with each other; and (c) view information about other system members who are in one or more permitted predefined relationships with a member's alpha relationship. Absent a permitted predefined relationship, members may not see information or otherwise communicate with other members through the system. In one preferred embodiment α(AP)=α(PA), insofar as to the types of members' connections each can see of the other.

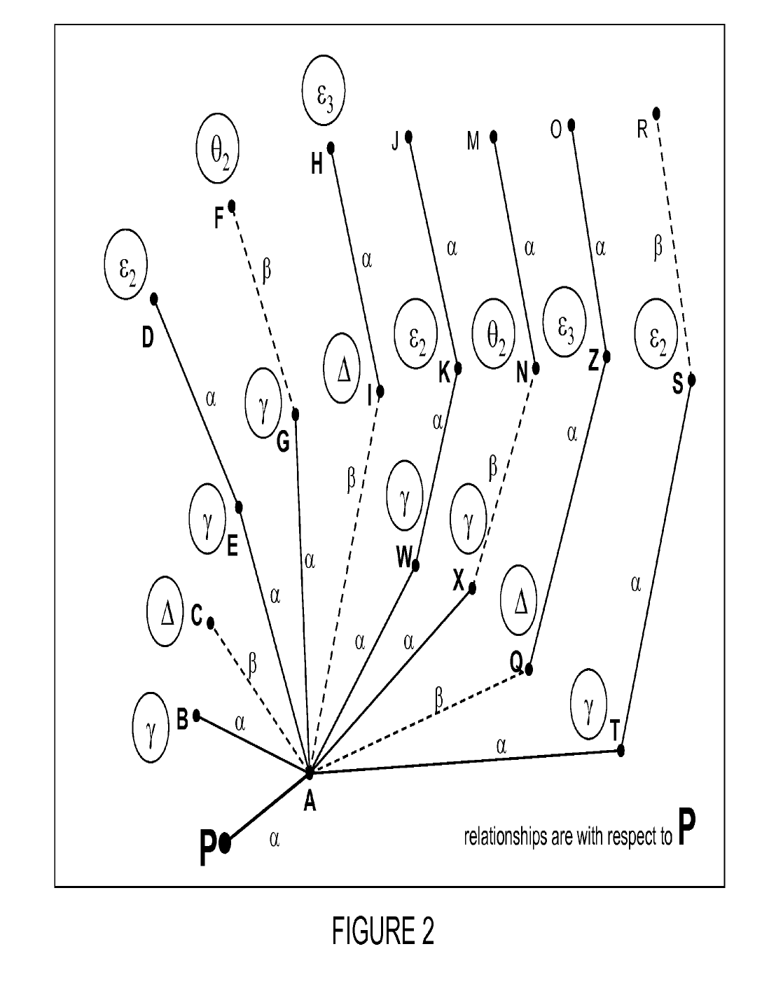

In one preferred embodiment, member A acquires some information from member P to be invited, such information as may be required by the system, for example member P's email address, phone number, bar code or other machine readable code . Member A will provide the system with the required information and the system will send an invitation to member P, upon receipt of the invitation member P can decline or accept. If member P accepts, and in one preferred embodiment, member A also confirm's P's acceptance, the peerage relationships α(AP) and α(PA) are formed by the system and information is stored as relationship data; with immediate consequences. In one preferred embodiment, upon entering into an alpha relationship, member P can automatically see all other pre-defined permitted relationship connections. Thus, member P now sees not only member A, but P also sees all of member A's alphas, betas, gammas, deltas and epsilon(1)s, as well. See FIG. 1 and FIG. 2.

In a preferred embodiment, upon member A inviting member P to enter into an alpha relationship, member P and all of member P's alphas can see member A, and depending on the embodiment A's alphas as well, so that member P may consult with member P's alphas and member P's alphas may offer solicited and/or unsolicited advice. In an embodiment, member A's alphas are informed and may consult with member A. In some embodiments, a member's ability to agree to relationship connection or not may be controlled by the other member's of the member's aspect network. For example, a member's peers, perhaps by majority vote, say that the member must accept or decline the invitation.

### betas (β) (pathways) (direct portraits) (contacts) are members who have agreed to be in a beta relationship

If A is a beta of B, the relationship is designated as β(AB). Once the beta relationship is established by one member inviting another member to connect, the invitation being accepted, and in one preferred embodiment, the acceptance confirmed, the system associates beta relationship data with the beta members and enables those beta relationship members (that is both β(AB) and β(BA) to automatically (a) view information about each other; (b) communicate with other; and (c) view information about other members who are in one or more relationships with a member's beta relationship. In this preferred embodiment β(AB)=β(BA), insofar as to the types of members' connections each can see of the other.

### The Secondary Relationship Connections—the Gamma, Deltas, Epsilons and Thetas

The secondary relationship connections are based on the various ways in which the primary relationship connections form a path from one member to another in accordance with the allowed permutations. In the case where all permutations of two alphas and one beta are permitted to connect two members, the allowed secondary relationship connections are in one preferred embodiment given as the gammas, deltas, epsilons and thetas. In this embodiment: gammas are alphas of alphas; deltas are betas of alphas; epsilons are alphas of betas, alphas of gammas and alphas of deltas; while thetas are gammas of betas and betas of gammas.

### gammas (γ) (prospects) (indirect peers) (alphas of alphas)

A gamma is an alpha of an alpha. In logically connecting D with A, E is an alpha of A, α(EA), and D is an alpha of E, α(DE), then A to D is α(EA) α(DE)=γ(DA). See FIG. 1. In one preferred embodiment γ(AD)=γ(DA), insofar as to the types of members' connections each can see of the other.

The system of the invention automatically establishes gamma relationships, based on the underlying alpha of alpha relationship data, which enables those members in a gamma relationship to automatically (a) view certain information about each other; and (b) send invitations to each other to become betas, but not otherwise communicate through the system. In one embodiment, upon one member sending an invitation through the system to connect to another a gamma member as a beta, the sender's information displayed to the receiving member is automatically enhanced by the system.

### deltas (Δ) (possibilities) (indirect portraits) (betas of alphas).

A delta is a beta of an alpha. In logically connecting F with A, We start with G is an alpha of A, α(GA) and F is a beta of G, β(FG), then F is also a delta of A, and the relationship is given as Δ(FA)=α(GA) β(FG). See FIG. 1.

The system of the invention automatically establishes delta relationships, based on the underlying primary relationship connections stored as relationship data, which enables those members in a delta relationship to automatically (a) view certain information about each other; and (b) send invitations to each other to become betas, but not otherwise communicate through the system. In one embodiment, upon one member sending an invitation through the system to connect to a delta member as a beta, the sender's information displayed to the receiving member is automatically enhanced by the system.

In this embodiment, members logically connected in one direction are not logically connected in the same way in the reverse direction, that is, the delta relationship connection is not reciprocal. To logically connect from A to F, a beta of an alpha logical connection is utilized, in going from F to A, an alpha of a beta logical connection is utilized. In this embodiment these are two differently pre-defined logical connections. From F to A, it is a delta relationship connection, and from A to F it is an epsilon(1) relationship connection as described below. See FIG. 1. Non-reciprocity is also true of certain other pre-defined logical connections of embodiments of the present invention.

### epsilons (ε) (peersonalities) (alphas of betas, gammas and deltas) alphas of betas (ε₁)

An epsilon(1) is an alpha of a beta. In logically connecting H with A, we start with I a beta of A, β(IA), and H an alpha of I, α(HI), then H is also an epsilon(1) of A and the relationship is β(IA) α(HI)=ε₁(HA). See FIG. 1.

### alphas of gammas (ε₂)

An epsilon(2) is an alpha of a gamma. In logically connecting J with A, W is an alpha of A, α(WA), K is an alpha of W, α(KW) and J is an alpha of K, α(JK) and the relationship is α(WA) α(KW) α(JK), which is equivalent to γ(KA) α(JK) and which is the same as ε₂(JA) and thus J is an epsilon(2) of A. See FIG. 1.

### alphas of deltas (ε₃)

An epsilon(3) is an alpha of a delta. In logically connecting M with A, X is an alpha of A, α(XA), N is a beta of X, β(NX) and M is an alpha of N, α(MN), which relationship can be represented as α(XA) β(NX) α(MN), which is the same as Δ(NA) α(MN), thus M is an epsilon(3) of A or ε₃(MA). See FIG. 1.

The system of the invention automatically establishes epsilon relationships, based on the primary relationship connections stored as relationship data, which enables those members in a epsilon relationship to automatically (a) view certain information about each other; and (b) send invitations to each other to become or betas, but not otherwise communicate through the system. In one embodiment, upon one member sending an invitation through the system to connect to an epsilon (1,2,3) member as a beta, the sender's information displayed to the receiving member is automatically enhanced by the system.

### thetas (θ) (betas of gammas and gammas of betas) gammas of betas (θ₁)

A theta(1) is the gamma of a beta, which is the same as an alpha of an alpha of a beta (which is the same as a alpha of an epsilon(1)). α(OZ) α(ZQ) β(QA)=γ(OQ) β(QA)=θ₁(OA). See FIG. 1. In this way O is logically connected to A.

### betas of gammas (θ₂)

A theta(2) is the beta of a gamma, which is the same as a beta of an alpha or an alpha (which is also the same as a delta of an alpha). β(RS) α(ST) α(TA)=β(RS) γ(SA)=θ₂(RA). See FIG. 1. In this way R is logically connected to A.

If member O is a Theta(1) to member A, then member A is a Theta(2) to O.

The system of the invention automatically establishes theta relationships, based on the underlying primary relationship connections stored as relationship data, which enables those members in a theta relationship to automatically (a) view certain information about each other; and (b) send invitations to each other to become betas, but not otherwise communicate through the system. In one embodiment, upon one member sending an invitation through the system to connect to a theta (1,2) member as a beta, the sender's information displayed to the receiving member is automatically enhanced by the system.

### Permitted Connections

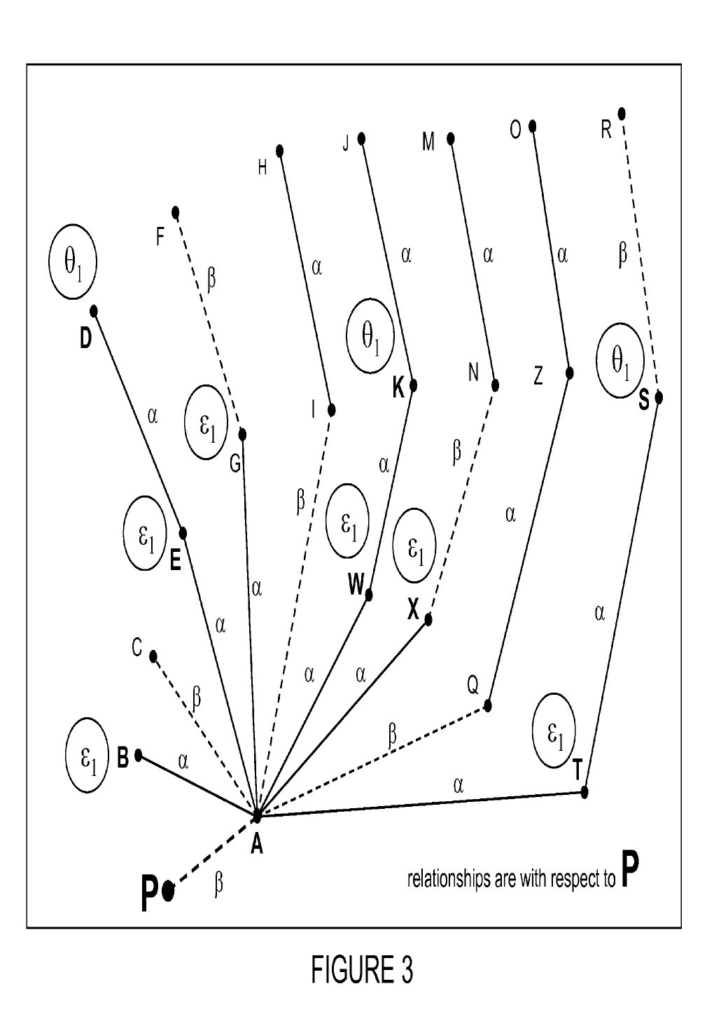

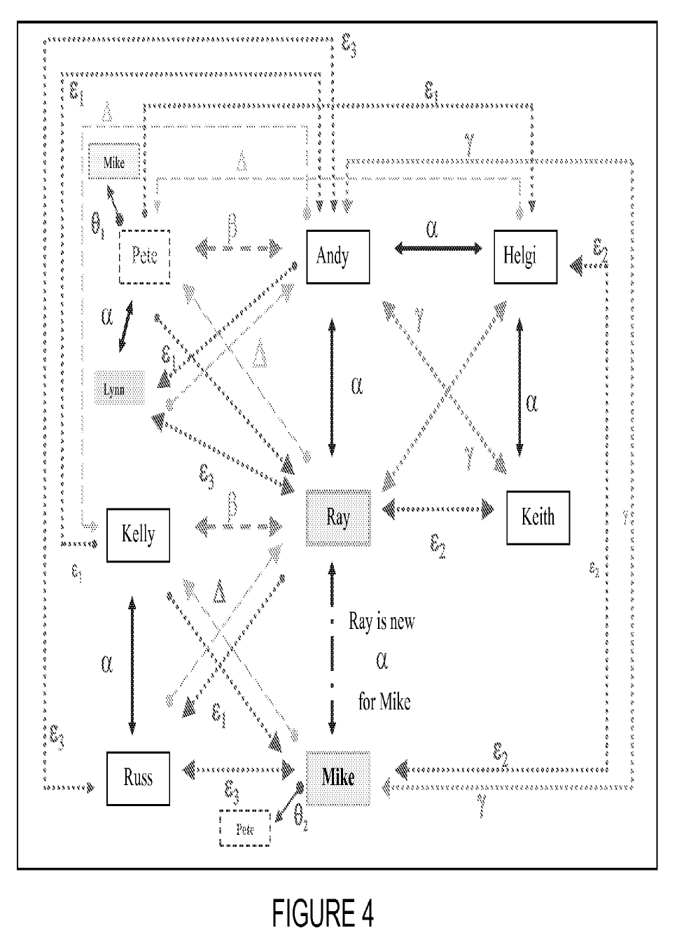

With reference to FIGS. 1, 2 and 3, there is shown the preferred embodiment wherein member A's permitted relationship connections are the alpha, beta, gamma, delta, epsilons(1,2,3) and the thetas(1,2). That is, the permitted pre-defined relationship connections are: alphas (α) and betas (β) and the permitted connections based on alphas and betas, namely, gammas (γ) (alphas of alphas), deltas (Δ) (betas of alphas), epsilons (ε) (alphas of betas (ε₁), alphas of gammas (ε₂), alphas of deltas (ε₃)) and thetas (θ) (gammas of betas (θ₁) and betas of gammas (θ₂)). We start with members B, C, D. E. F. G. H. I, J, K, W, M, N, X, O, Z, Q, R, S and T all connected to A through relationship connections as given in FIG. 1 and below and that provide for A to see all of them.

First, with respect to members A's FIG. 1 relationship connections, bolded members are those that member A can “see” because of the permitted relationship connections of this preferred embodiment, in this case A can see all of them. To summarize, for this preferred embodiment the following are the pre-defined permitted logical connections.

### Primary Relationship Connections

alphas (α)

betas (β)

### Secondary Relationship Connections

| | |
|---|---|
| gamma | alpha of an alpha (γ) |
| delta | betas of an alpha (Δ) |
| epsilon(1) | alpha of a beta (ε₁) |
| epsilon(2) | alpha of a gamma (ε₂) |
| epsilon(3) | alpha of a delta (ε₃) |
| theta(1) | gamma of a beta (θ₁) |
| theta(2) | beta of a gamma (θ₂) |

Thus the following are member A's connections as shown on FIG. 1.

$$\begin{matrix}α ( BA ) & & & \\ β ( CA ) & & & \\ γ ( DA ) & = α ( EA ) α ( DE ) & & \\ Δ ( FA ) & = α ( GA ) β ( FG ) & & \\ {ɛ}_{1} ( HA ) & = β ( IA ) α ( HI ) & & \\ {ɛ}_{2} ( JA ) & = γ ( KA ) α ( JK ) & = α ( WA ) α ( KW ) α ( JK ) & \\ {ɛ}_{3} ( MA ) & = Δ ( NA ) α ( MN ) & = α ( XA ) β ( NX ) α ( MN ) & \\ {θ}_{1} ( OA ) & = β ( QA ) γ ( OQ ) & = β ( QA ) α ( ZQ ) α ( OZ ) & = {ɛ}_{1} ( ZA ) α ( ZO ) \\ {θ}_{2} ( RA ) & = γ ( SA ) β ( RS ) & = α ( TA ) α ( ST ) β ( RS ) & \end{matrix}$$

Thus member A can see all the other members shown on FIG. 1 through the logical relationship connections also shown.

### Entering into an Alpha (Peer) Relationship Connection.

Members A and P enter into an alpha (peer) relationship, that is, α(AP)=α(PA), then: (1) automatically A and P can communicate through the system; and (2) automatically, P can see those other members that A has a current relationship connections with who when the relationship connections are analyzed in accordance with the above embodiment of the invention with respect to P also provide for one of the permitted discovery relationships, namely: α; βγ; Δ; ε₁; ε₂; ε₃; θ₁, θ₂. Though this may appear to allow for a lot of discovery, in practice because of the relationship constraints only a few new members are discovered.

In accordance with a preferred embodiment of the invention, upon the formation of α(AP), the following relationship connections are made with the addition of α(AP) to the connections of Member A. Bolded members are those that member P can “see” after becoming A's alpha. See FIG. 2.

$$\begin{matrix}α ( AP ) & = α ( AP ) & \\ α ( AP ) α ( BA ) & = γ ( BP ) & \\ α ( AP ) β ( CA ) & = Δ ( CP ) & \\ α ( AP ) γ ( DA ) & = α ( AP ) α ( EA ) α ( DE ) & = γ ( EP ) α ( DE ) = {ɛ}_{2} ( DP ) \\ α ( AP ) Δ ( FA ) & = α ( AP ) α ( GA ) β ( FG ) & = γ ( GP ) β ( FG ) = {θ}_{2} ( FP ) \\ α ( AP ) {ɛ}_{1} ( HA ) & = α ( AP ) β ( IA ) α ( HI ) & = Δ ( IP ) α ( HI ) = {ɛ}_{3} ( HP ) \\ α ( AP ) {ɛ}_{2} ( JA ) & = α ( AP ) γ ( KA ) α ( JK ) & = α ( AP ) α ( WA ) α ( KW ) α ( JK ) \\ & & = γ ( WP ) α ( KW ) α ( JK ) \\ & & = {ɛ}_{2} ( KP ) α ( JK )\end{matrix}$$

In this preferred embodiment, P, using an alpha relationship connection with A, cannot see A's epsilon(2)s (J).

$$\begin{matrix}α ( AP ) {ɛ}_{3} ( MA ) = α ( AP ) Δ ( NA ) α ( MN ) = α ( AP ) α ( XA ) β ( NX ) α ( MN ) \\ = γ ( XP ) β ( NX ) α ( MN ) \\ = {θ}_{2} ( NP ) α ( MN )\end{matrix}$$

In this preferred embodiment, P, using an alpha relationship connection with A, cannot see A's epsilon(3)s (M).

$$\begin{matrix}α ( AP ) {θ}_{1} ( OA ) = α ( AP ) β ( QA ) γ ( OQ ) = α ( AP ) β ( QA ) α ( ZQ ) α ( OZ ) \\ = Δ ( QP ) α ( ZQ ) α ( ZO ) \\ = {ɛ}_{3} ( ZP ) α ( ZO )\end{matrix}$$

In this preferred embodiment, P, using an alpha relationship connection with A, cannot see A's theta(1)s (O).

$$\begin{matrix}α ( AP ) {θ}_{2} ( RA ) = α ( AP ) γ ( SA ) β ( RS ) = α ( AP ) α ( TA ) α ( ST ) β ( RS ) \\ = γ ( TP ) α ( ST ) β ( RS ) \\ = {ɛ}_{2} ( SP ) β ( RS )\end{matrix}$$

In this preferred embodiment, P, using an alpha relationship connection with A, cannot see A's theta(2)s (R).

### Entering into a Beta (Contact) (Relationship Connection.

P enters into a beta relationship connection with A. See FIG. 2. Once again Member A has the following relationships (see FIG. 1 and discussion above):

$$\begin{matrix}α ( BA ) = α ( BA ) & & \\ β ( CA ) = β ( CA ) & & \\ γ ( DA ) = α ( EA ) α ( DE ) & & \\ Δ ( FA ) = α ( GA ) β ( FG ) & & \\ {ɛ}_{1} ( HA ) = β ( IA ) α ( HI ) & & \\ {ɛ}_{2} ( JA ) = γ ( KA ) α ( JK ) & = α ( WA ) α ( KW ) α ( JK ) & \\ {ɛ}_{3} ( MA ) = Δ ( NA ) α ( MN ) & = α ( XA ) β ( NX ) α ( MN ) & \\ {θ}_{1} ( OA ) = β ( QA ) γ ( OQ ) & = β ( QA ) α ( ZQ ) α ( OZ ) & = {ɛ}_{1} ( ZA ) α ( ZO ) \\ {θ}_{2} ( RA ) = γ ( SA ) β ( RS ) & = α ( TA ) α ( ST ) β ( RS ) & \end{matrix}$$

In accordance with the invention, upon the formation of β(AP), the following relationship connections are made with the addition of β(AP) to the connections of Member A. Bolded members are those that member P can “see” after becoming A's beta. See FIG. 2.

β(AP) α(BA)=ε₁(BP)

β(AP) β(CA)=β(AP) β(CA)

In this preferred embodiment, P, using a beta relationship connection with A, cannot see A's betas (B).

$$\begin{matrix}β ( AP ) γ ( DA ) = {θ}_{1} ( DP ) & = β ( AP ) α ( EA ) α ( DE ) \\ & = {ɛ}_{1} ( EP ) α ( DE ) \\ β ( AP ) Δ ( FA ) = β ( AP ) α ( GA ) β ( FG ) & = {ɛ}_{1} ( GP ) β ( FG )\end{matrix}$$

In this preferred embodiment, P, using a beta relationship connection with A, cannot see A's deltas (F).

β(AP) ε₁(HA)=β(AP) β(IA) α(HI)

In this preferred embodiment, P, using a beta relationship connection with A, cannot see A's epsilon(1)s (H) or included betas (I).

$$\begin{matrix}β ( AP ) {ɛ}_{2} ( JA ) = β ( AP ) γ ( KA ) α ( JK ) = β ( AP ) α ( WA ) α ( KW ) α ( JK ) \\ = {ɛ}_{1} ( WP ) α ( KW ) α ( JK ) \\ = {θ}_{1} ( KP ) α ( JK )\end{matrix}$$

In this preferred embodiment, P, using a beta relationship connection with A, cannot see A's epsilon(2)s (J).

$$\begin{matrix}β ( AP ) {ɛ}_{3} ( MA ) = β ( AP ) Δ ( NA ) α ( MN ) = β ( AP ) α ( XA ) β ( NX ) α ( MN ) \\ = {ɛ}_{1} ( XP ) β ( NX ) α ( MN )\end{matrix}$$

In this preferred embodiment, P, using a beta relationship connection with A, cannot see A's epsilon(3)s (M) or included deltas (N).

β(AP) θ₁(OA)=β(AP) β(QA) γ(OQ)=β(AP) β(QA) α(ZQ) α(OZ)

In this preferred embodiment, P, using a beta relationship connection with A, cannot see A's theta(1)s (O) or included deltas (Z) and betas (Q).

$$\begin{matrix}β ( AP ) {θ}_{2} ( RA ) = β ( AP ) γ ( SA ) β ( RS ) = β ( AP ) α ( TA ) α ( ST ) β ( RS ) \\ = {ɛ}_{1} ( TP ) α ( ST ) β ( RS ) \\ = {θ}_{1} ( SP ) β ( RS )\end{matrix}$$

In this preferred embodiment, P, using a beta relationship connection with A, cannot see A's theta(2)s (R).

### Benefits of Membership

In accordance with one preferred embodiment of the invention, the benefits of two members connecting through an alpha or peer relationship is discussed. In this embodiment the permitted pre-defined relationship connections are the alpha, beta, gamma, delta, epsilons(1,2,3) and the thetas(1,2). See FIG. 4.

Basically, upon Mike becoming Ray's alpha the system and method of the invention automatically establishes relationship connections for Mike with all of Ray's alphas, betas, gammas, deltas, and epsilon(1)s. Thus, the system and method of the invention automatically show Mike the above individuals listed by relationship connection, but only the above listed individuals based on the new alpha relationship with Ray.

### Other Features of Embodiments of the Invention

In accordance with the present invention, a member can set up a network for any purpose, for example, business, hobbies, socializing. First a member declares who their alphas (peers) and the other members agree to be the member's alpha. These alphas act essentially as the initial seeds for the member's network. So that these seeds are not diluted in relevance by always adding new seed members as alphas, in accordance with one embodiment additional seed members may be added as betas (also referred to in various embodiments as: direct portraits, contacts, pathways, priorities, again upon two members agreeing to become betas. Of course, two members can always agree later to become alphas, if they wish. The network environment of the present invention continues “suggesting” new contact opportunities, based on how strongly a member is connected to other members through their respective alphas and betas in accordance with predefined combinations of same.

Starting with gammas, or indirect peers, who are alphas of alphas, then deltas, or indirect portraits, who are the betas of a member's alphas, and then showing other permitted combinations, the present invention provides the mechanism for expanding a members network with relevant alpha or beta level vetted contacts.

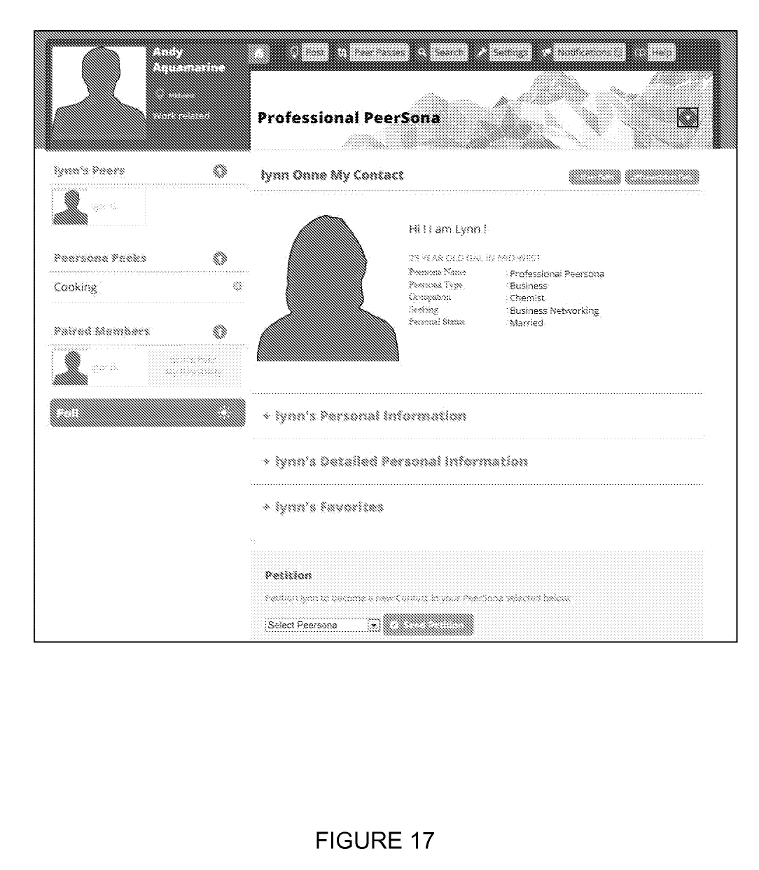

In other ways as well the networking environment of the invention can be a powerful tool. The networking environment can provide for multiple aspects, paths, passes, public/private view-ability, messaging options, phase-outs, poll-your-network, linking networks, viewing linked networks, requesting to connect on linked and non-linked networks, as well as the initial network viewed. On non-linked networks this is called a petition. See FIG. 17.

### Independent Aspect Networks

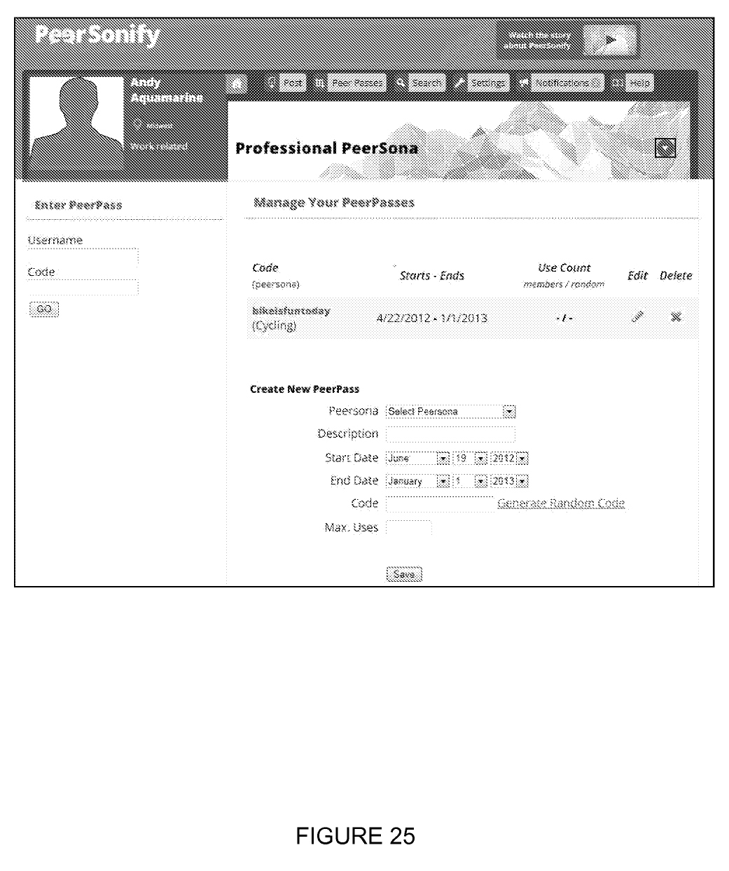

The independent networks a member can create for different aspects of their life also called Peersonas. A member can create as many or as few as they wish. They will each be named by the member and designated for social, business or a particular interest (for example, if related to political interests, charities, medical conditions, hobbies or anything else the member may want to network about) purpose. In certain preferred embodiments, they function as independent networks, except they can be linked for viewing and petition purposes. See FIG. 25.

### Poll your Network

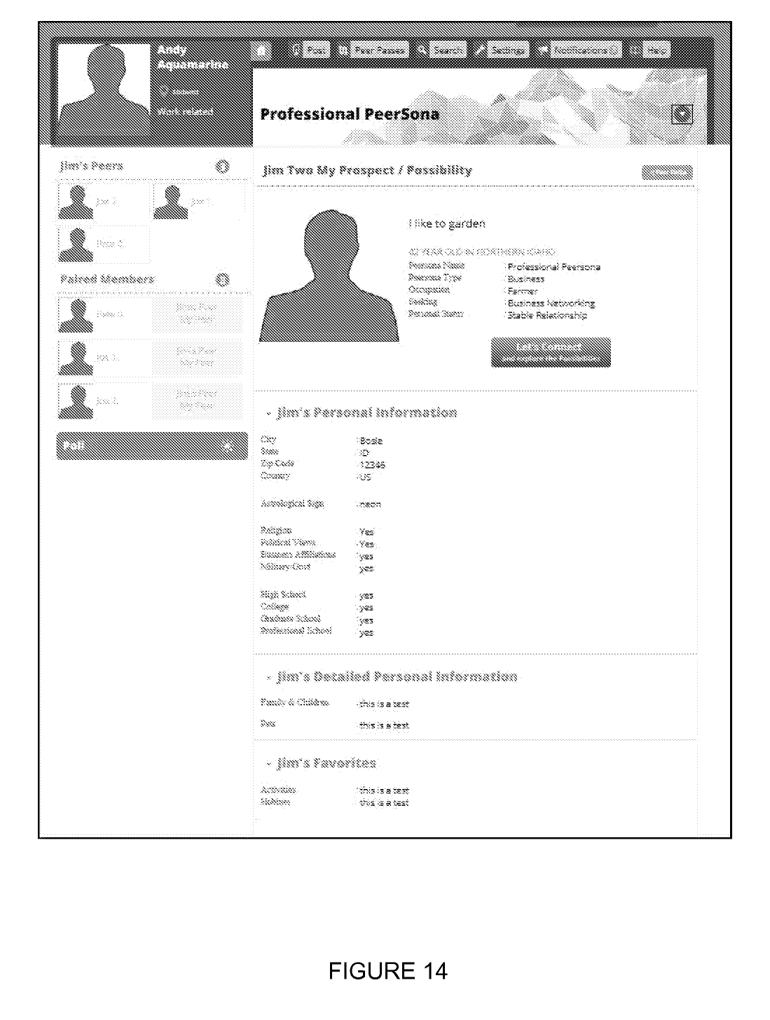

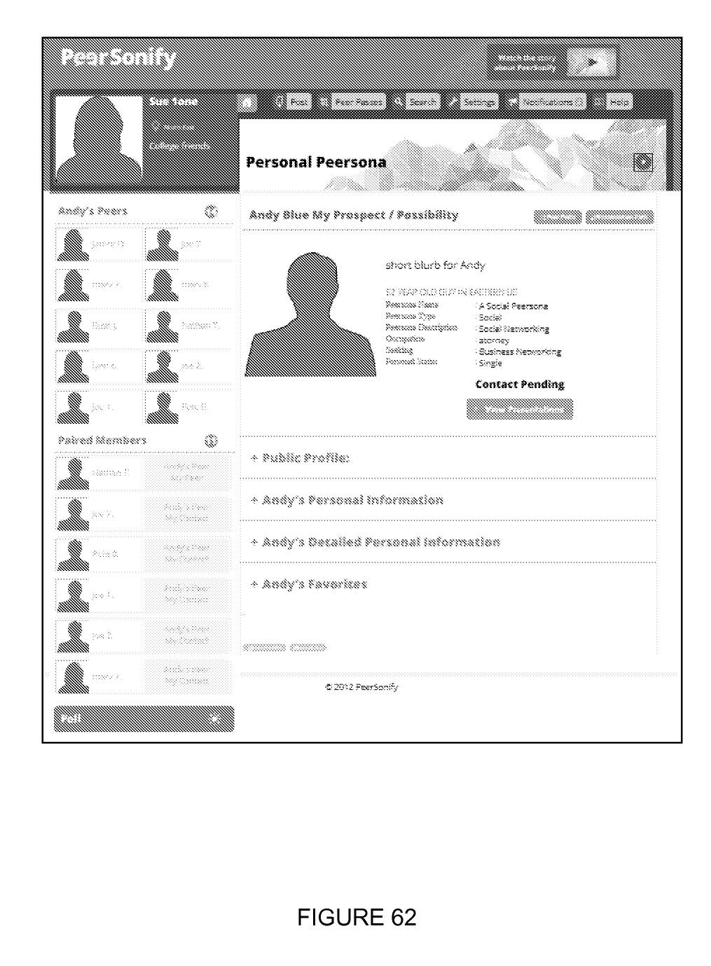

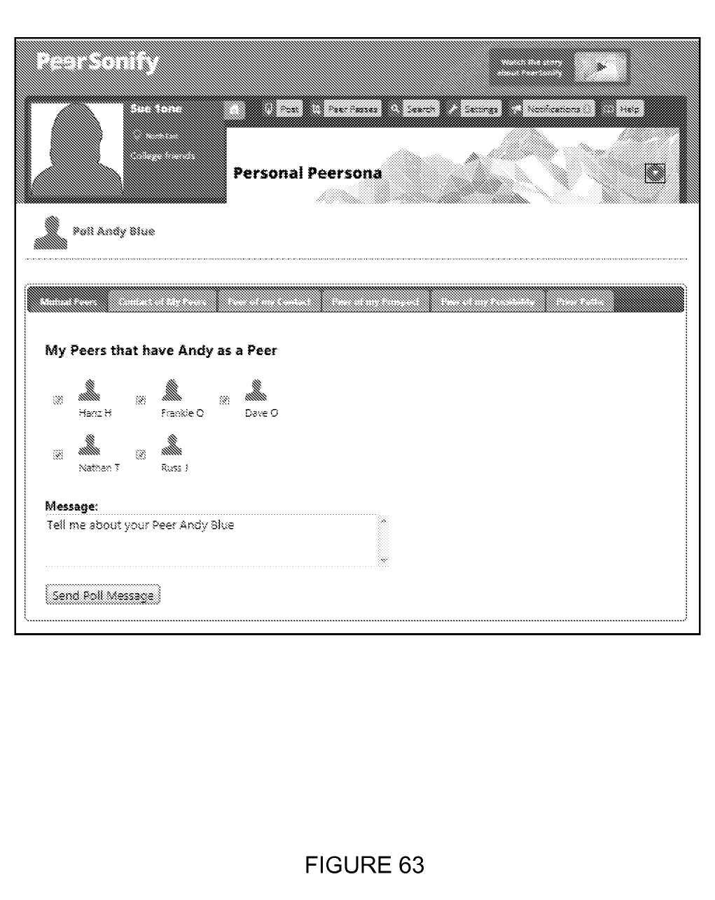

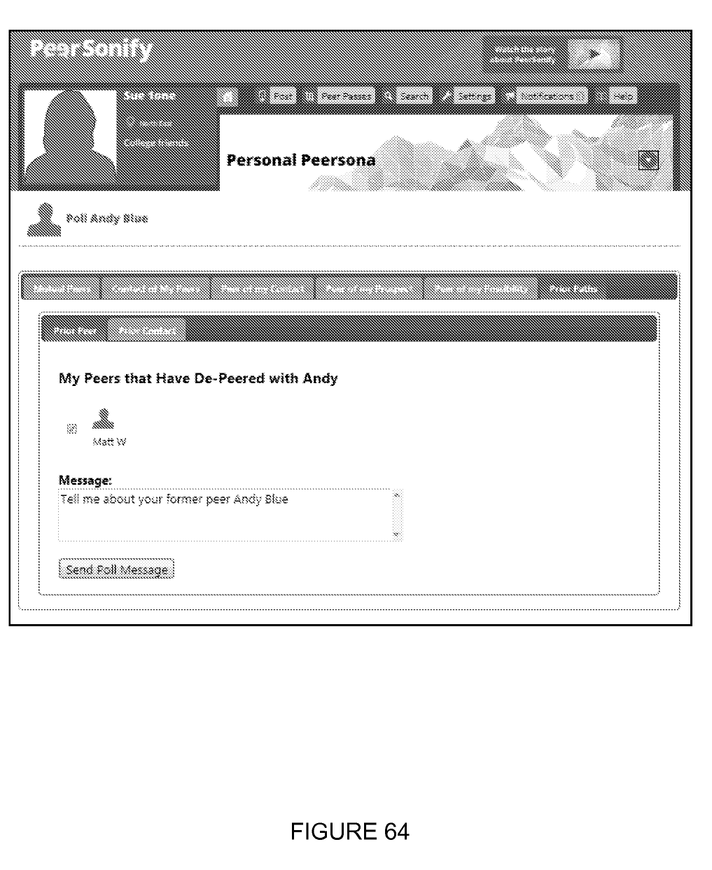

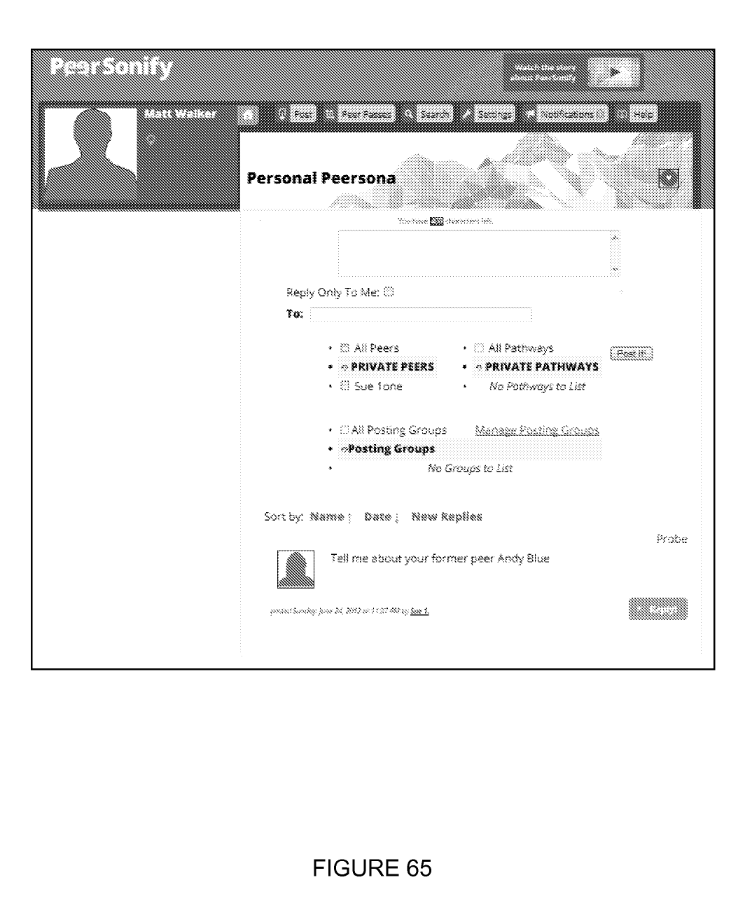

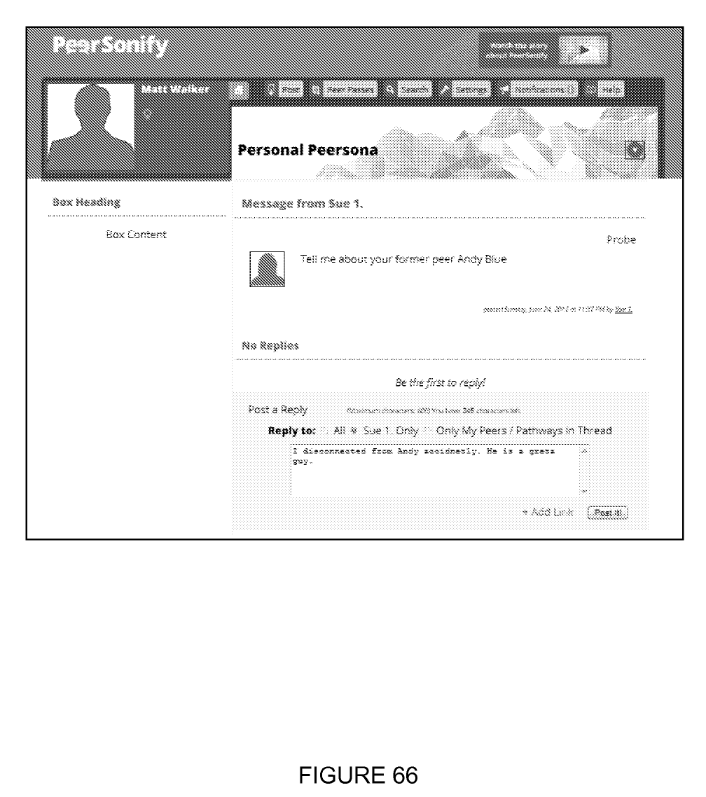

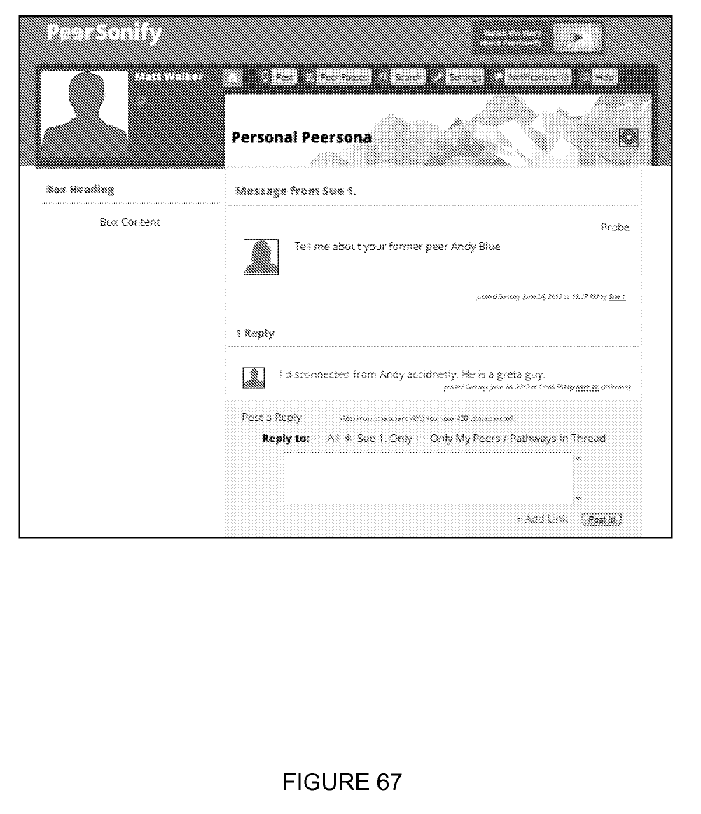

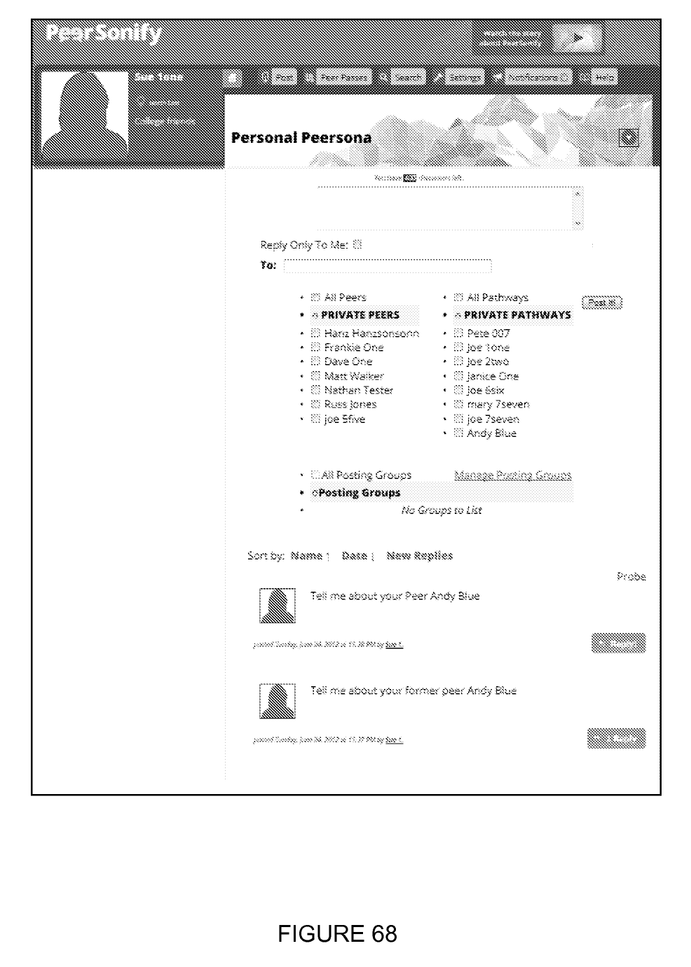

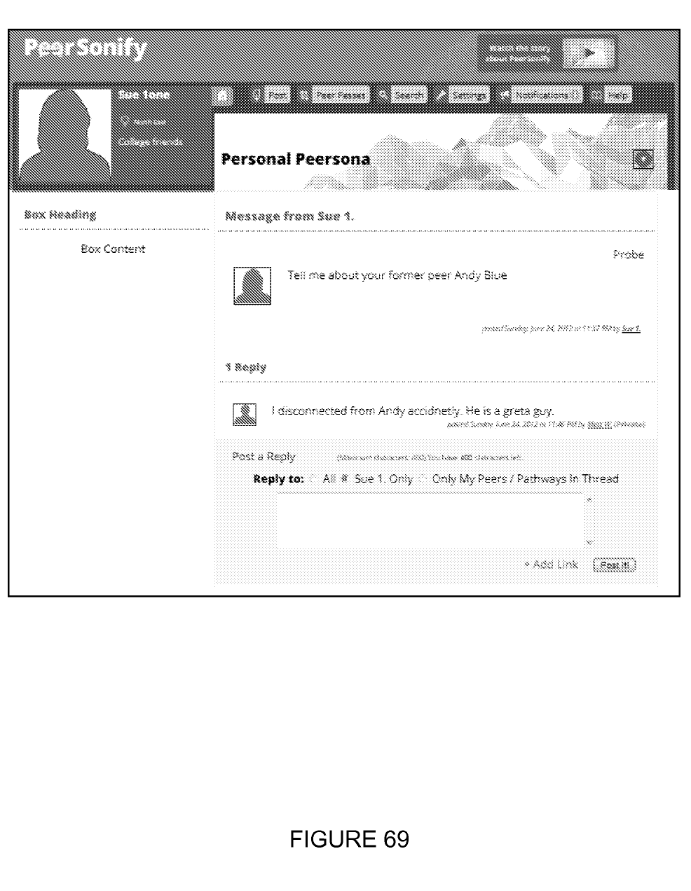

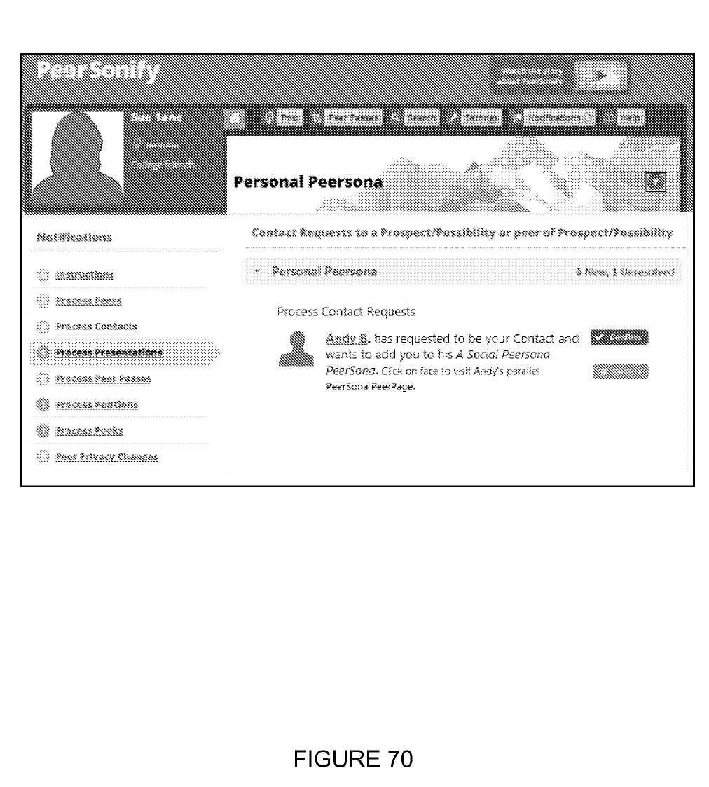

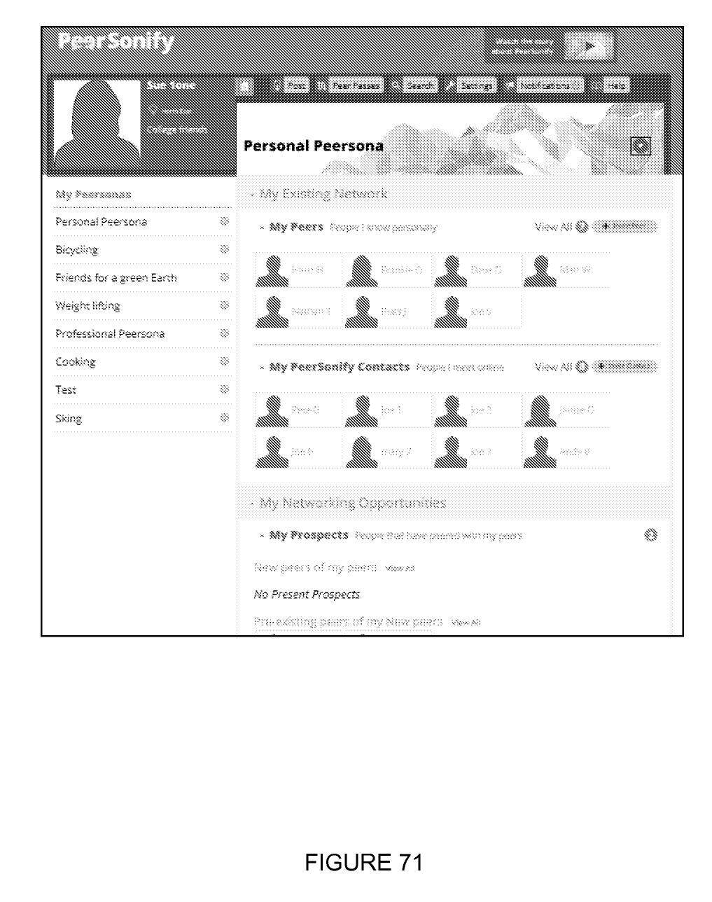

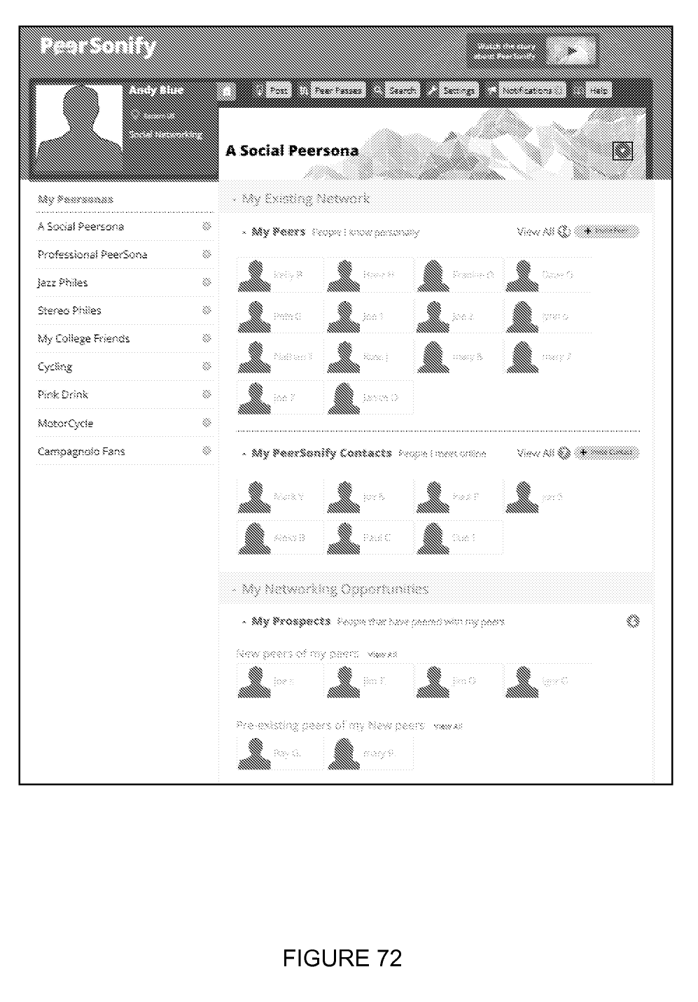

If a member is unsure about a potential new contact, they can poll their network and find out what other members really think of the potential new contact. The member can ask the networking environment to poll other members. The networking environment will then identify which alphas and betas and others the member can communicate with who are also an alpha or beta of the other member you want to ask to connect with as a beta. In an embodiment, it even identifies who in the member's network disconnected with them. The member can then select which or all of them they want to send a message asking them if they recommend the member to connect with that other member and/or to provide information about that other member. See FIGS. 14, 15, 46, 62, 63, 64, 65, and 69.

### Disconnect

Allows member A who are in a pre-defined permitted relationship with member B, to learn whether any of member A's alphas, betas, gammas, deltas and epsilon(1)s who are also a pre-defined permitted relationship with member B have disconnected from member B in the past. In one preferred embodiment, relationship data regarding disconnects is kept indefinitely.

### Blacklist

Allows members to prevent certain members (and perhaps their alphas) or future members (and perhaps their alphas) from being able to view their profile.

### Passes

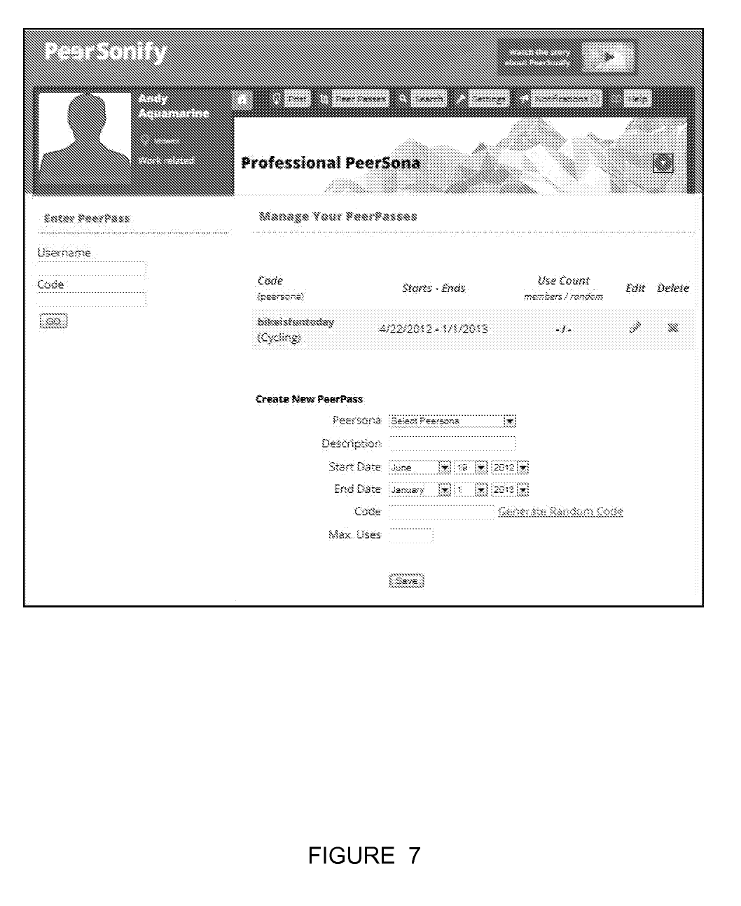

A member can create a pass code, for example, which can be given to people they meet in real life. When the person enters it on the home page (if not a member) or their GUI pass page (if they are a member), and member's peerpage will be displayed. In one embodiment, when a member enters a pass received from another member and the member does not want to request to connect as a beta right away then the member has a limited period of time, for example, ten days, to request to connect as a beta or their face (image) will disappear from the member's console. Passes can be created, edited, maintained and deleted. See FIG. 7. Pass codes are not limited in form and can even be machine readable.

### Phase-outs

Phaseout is a function that permits, for example, member A who is logically connected through permitted relationship connections to member C solely through an alpha or beta relationship with member B, to maintain for a limited period of time the ability after member B breaks their connection with C for A to continue to see member C and those other permitted connections based on the logical connection through C and B. Upon B breaking its connection with C, those members are placed in a phase-out situation. If there are other logical connections from A to C, even after B breaks with C, then there is no need to be placed in a phase-out situation and the other relationship connection may be displayed.

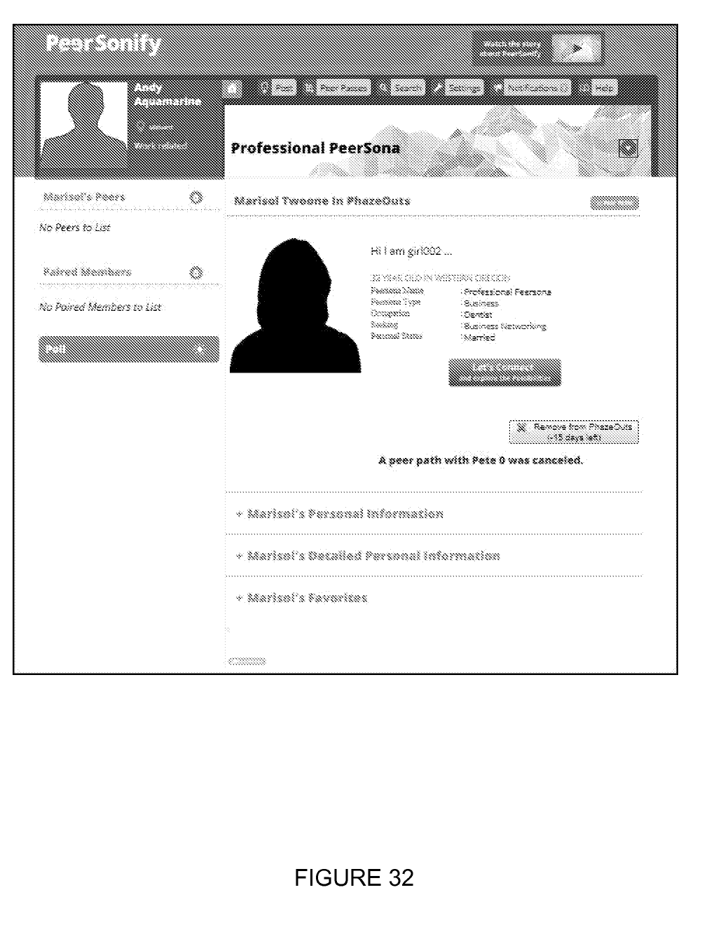

In another example, member A is an alpha of member B. So A can request to connect to all of B's alphas and betas. But if A disconnects its alpha connection with B, A can no longer request to connect with the alphas and betas of B. Except, in certain embodiments of the invention, the networking environment allows A to continue to request to connect with B's alphas and betas for 10 days after A breaks the connection with B, during which time those alphas and betas of B are called phase-outs. During that time the alphas of B move from A's prospects section on his console to his phase-outs (Phazeouts) section and the betas of B likewise move from A's possibilities section of his console to his phase-outs Section. The purpose of this embodiment is to allow a member to disconnect immediately, without forfeiting the ability to connect with people they might have been planning on connecting with in the future. See FIG. 5 and FIG. 32.

### Linked Networks and Viewing Linked Networks

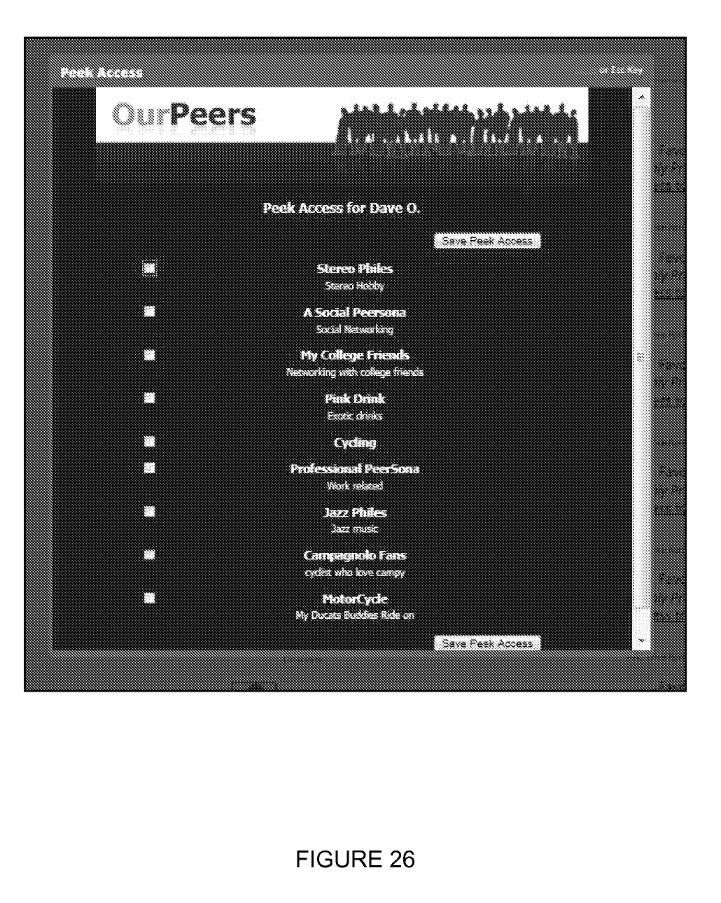

A member's other aspect networks. A member can show the other facets of their personality on their peerpage, which can display, in accordance with the member's settings, a member's peerpage on such other aspect networks which the member selects. Displaying other aspect networks is not required. A member can elect to show only some or none of their other aspect networks and the ones chosen can be different for each of the member's aspect networks. See FIG. 26.

### Petitioning (An Invitation to Join Another Aspect Network)

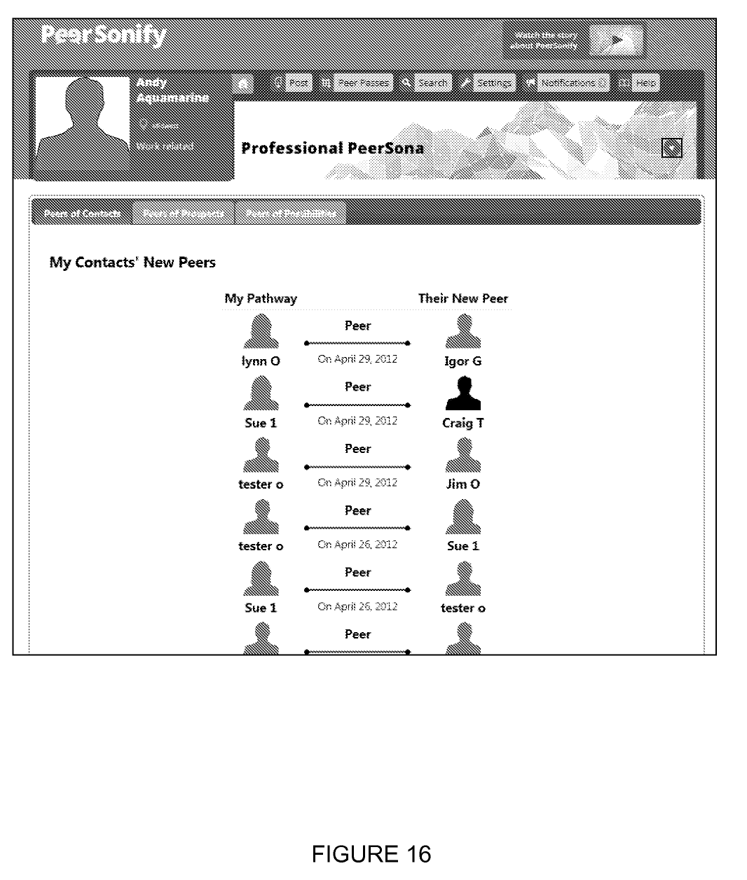

The ability to request to connect as a beta with someone on one aspect network from a different aspect network. In a preferred embodiment, a member can only petition alphas and betas. See FIGS. 16, 17, 39 and 40.

### Public/Private View-Ability

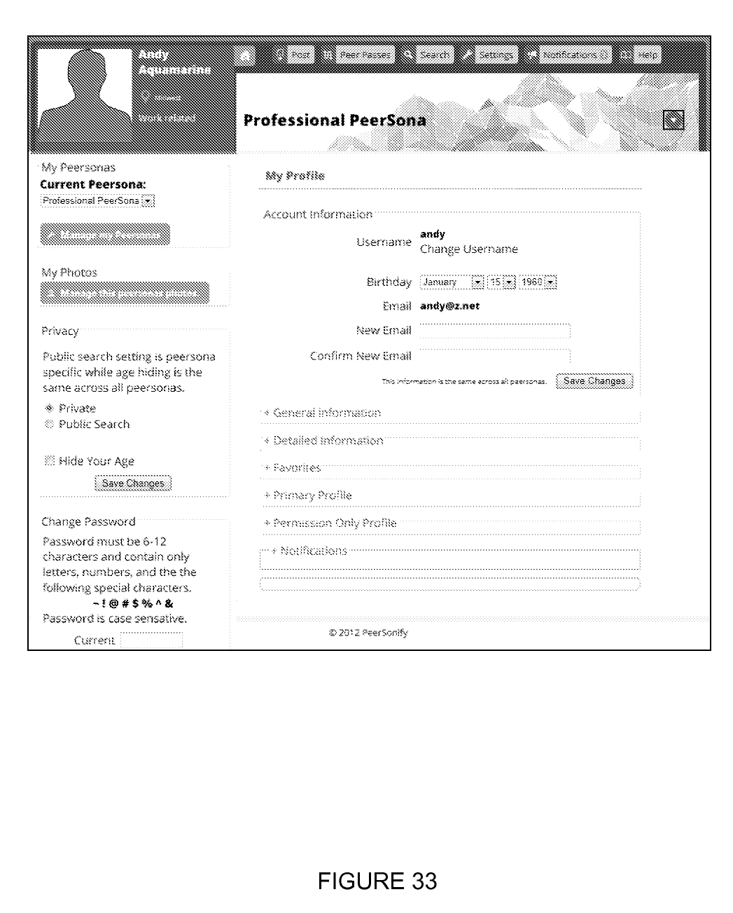

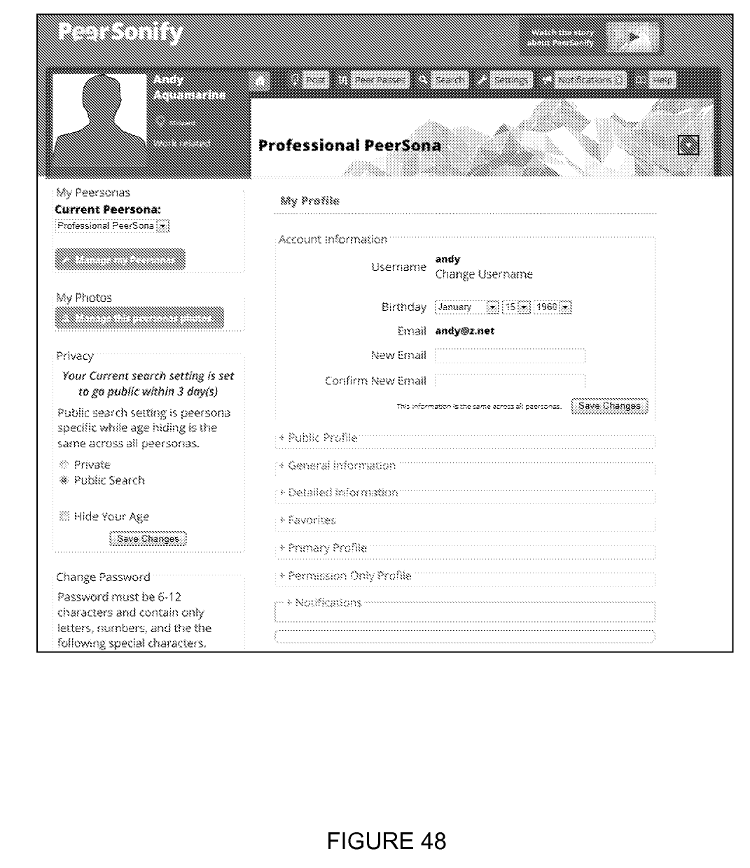

A member can elect to be publicly searchable (public) with a profile for public viewing, or not to be publicly searchable (private). See FIGS. 33 and 48. If a member elects to a private status and the member is an alpha of another member who elected to be public, the member's photos, profile and other information will not be visible when the other member's peerpage is displayed from a public search. However, the member and their profile and other accessible information will become visible when the member's public alpha or private alpha requests to become someone's beta or accepts a request to be someone's beta, but only to the betas and the alphas of the alpha who accepted or requested to become a beta.

### Types of Profiles

In a preferred embodiment there are at least four types of profiles. (1) “Public Profile”, if a member selects a public setting for an aspect network, for example, “Public Search” in the Privacy section of the Settings page. See FIG. 48. A Public Profile can contain photos and other information and is accessible through a public search. (2) “Private Profile”, if a member selects a private setting for an aspect network, for example, “Private” in the Privacy section of the Settings page. See FIG. 33. A Private Profile can contain photos and other information and is accessible when another member accesses a member's peerpage from the other members console of view all pages. (3) A “Permission Only Profile,” which can contain photos and other information and which is accessible only by specific permission given to a specific member. (4) “Short Profile,” a limited statements profile accessible to those other members who can see a member's portrait and who bring the text to view by hovering the computer GUI cursor over the member's portrait or associated text on the portrait.

A member can create a profile, with photos, which is seen only by those the member specifically gives permission to view it. Since the member can put as much or as little into the other portions of their profile and their public profile (if the member elects to have one), the member is in control of the privacy of the information they elect to display. Every preference and setting in the networking environment has it default setting set to the option which has more privacy.

If a member is publically viewable, they can create a different profile for when they are found through a public search or if they are found by networking.

If a member's alpha status is private and changes such status to public, the member's alphas will receive a notification and the change will not occur for a defined time period (which in one preferred embodiment is 10 days). This provides the member's alphas with time to change their privacy settings from public to private if they wish to do so.

### Messaging Options

A member can send a message to all their alphas and betas or just selected alphas and betas as well as to one or more pre-set posting groups. When a member sends a message, they can elect to have the replies come only to the sender or to everyone who originally received the message. Recipients can reply to all, to only those recipients who are also in the recipients network on that aspect network, or just to the sender. Moreover, the sender can direct that the message go only to those who received it who are also on the sender's aspect network.

### Paths

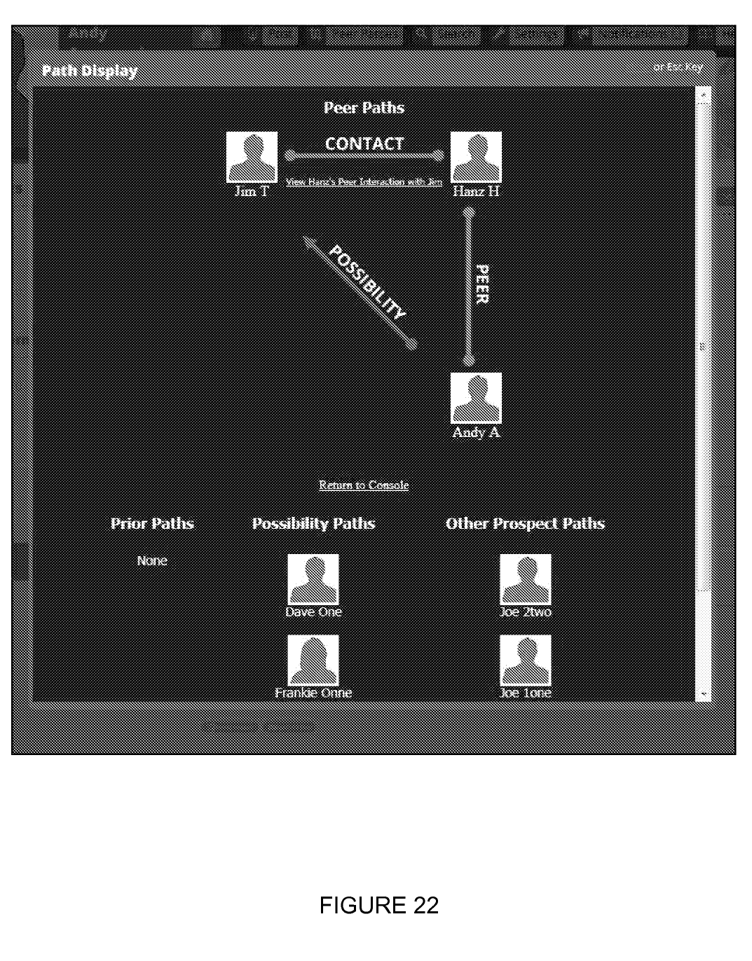

Paths are user friendly diagrams showing members how they are connected to other members they are connected with. See FIGS. 22, 23, 24, 43, 44, and 45. Paths show which one of the member's alphas introduced the member to a gamma or a delta, important information when deciding whether or not to connect as a beta. Paths also show if more than one alpha sent you a gamma or a delta and if someone is your alpha's gamma or delta. The more alphas who are sending a member a gamma or a delta, the more likely it is that a member should want to meet that person. Paths will also show if one of your alphas disconnected with a gamma or a delta (prior paths), an indication you may not want to connect as a beta. Since the Paths show which alpha disconnected, the member can send a message to that alpha asking the reason for the disconnection. See FIGS. 22-24. Moreover, in certain embodiments, a member can see how their gammas are interacting.

### Peerpage

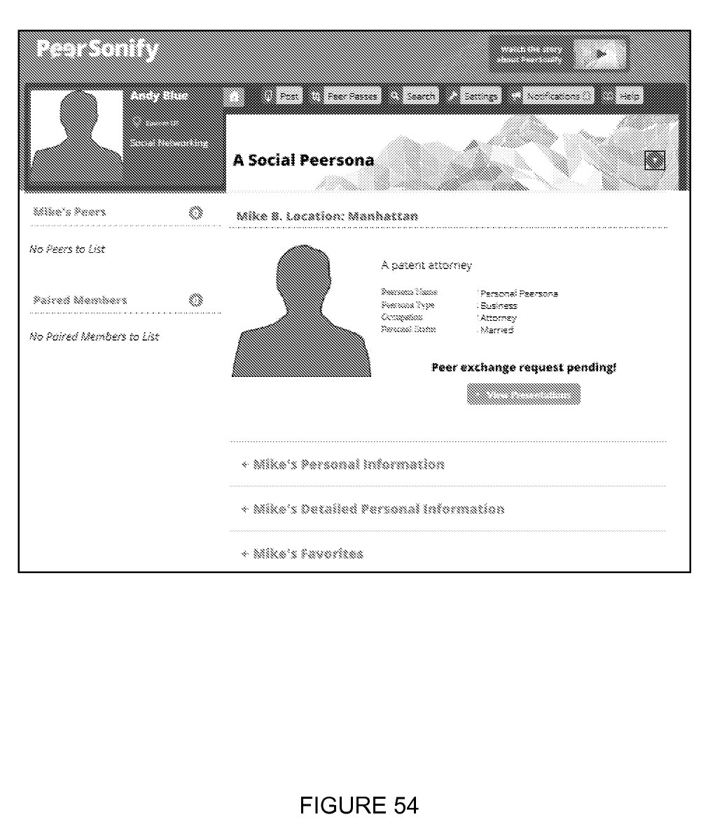

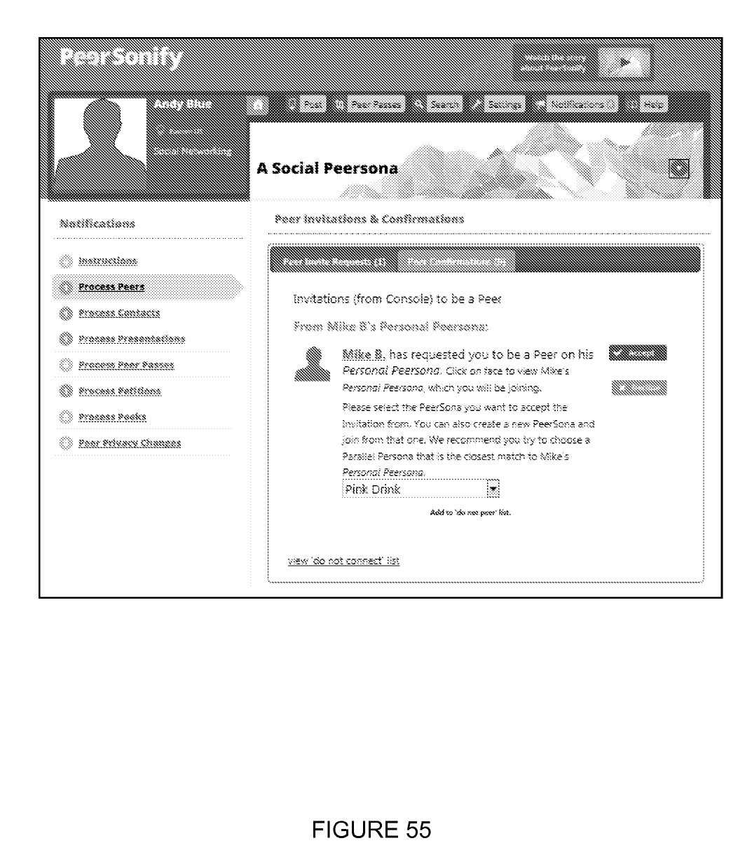

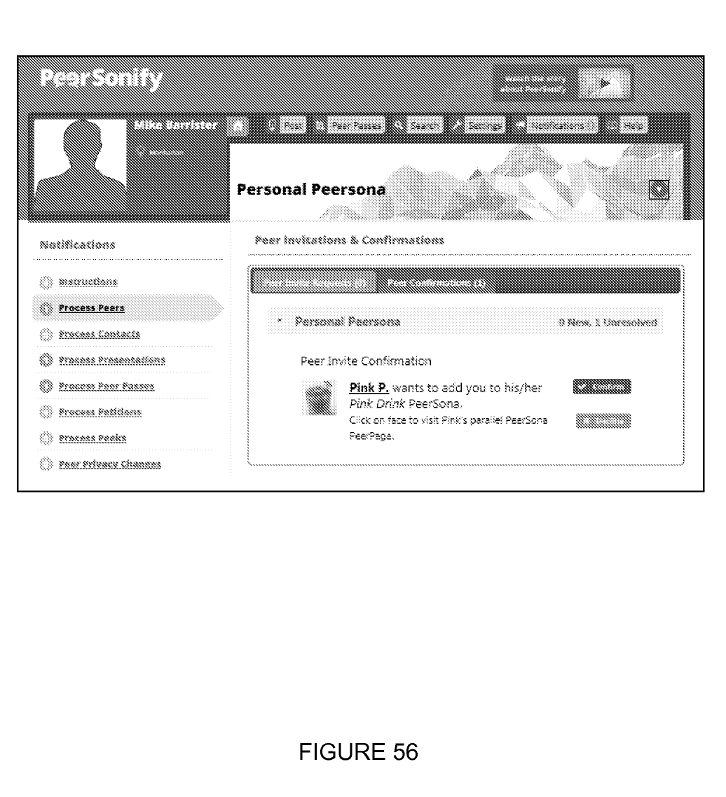

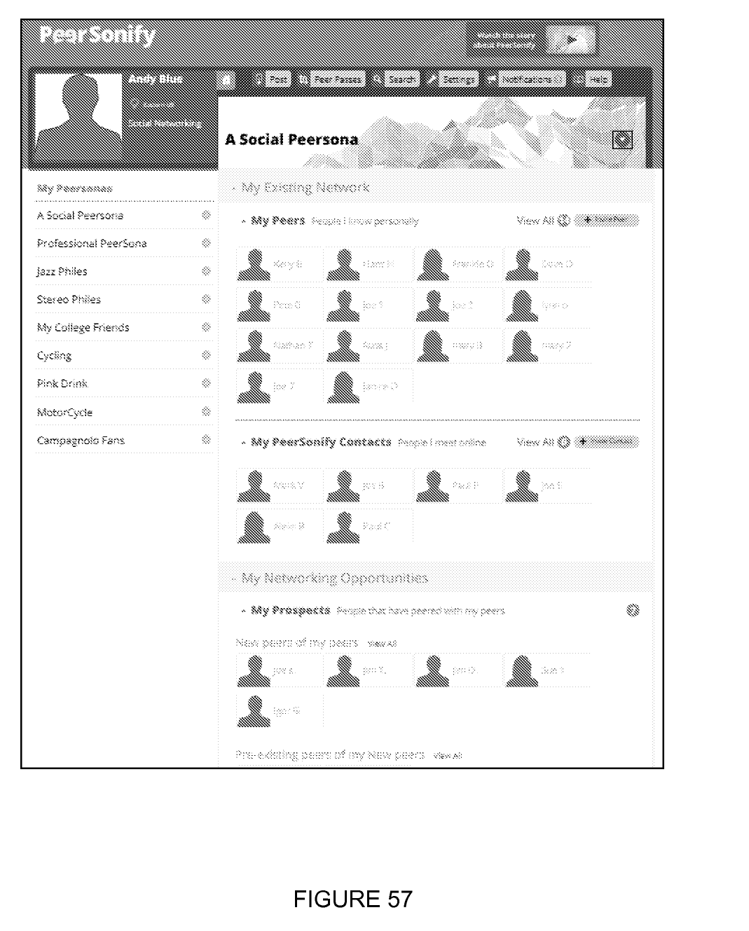

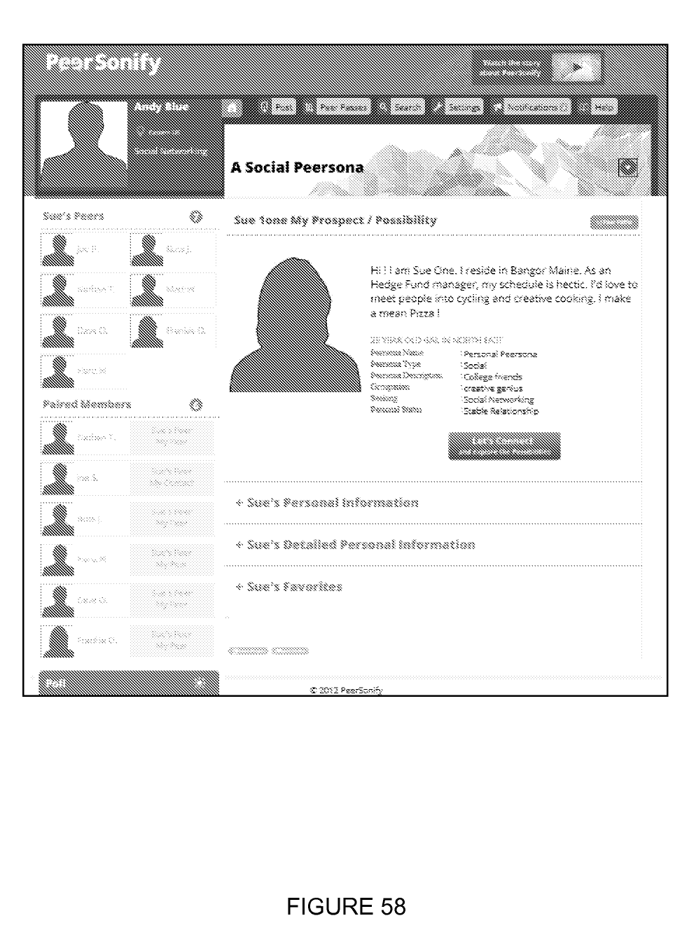

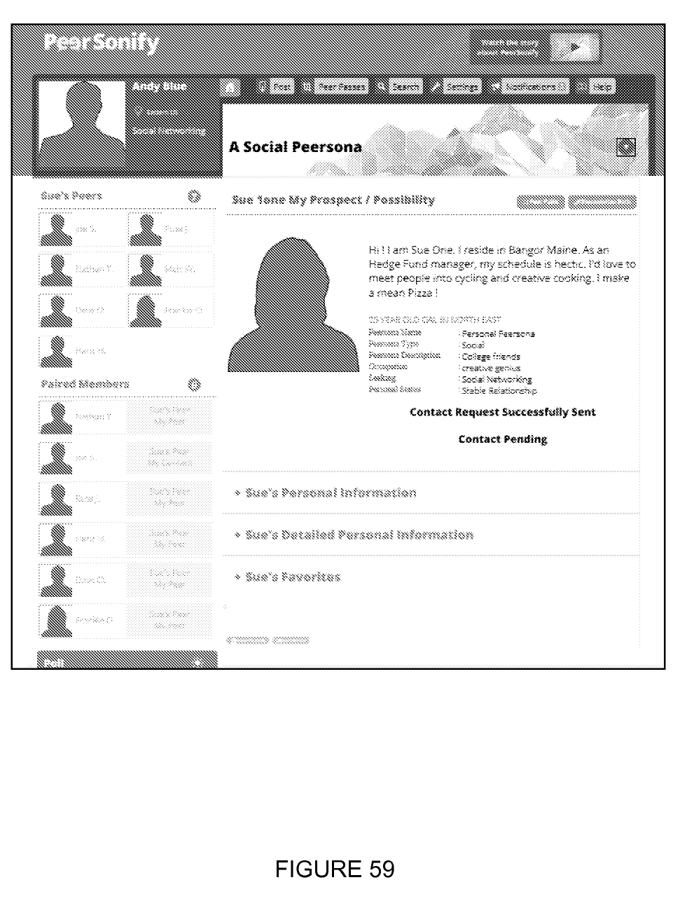

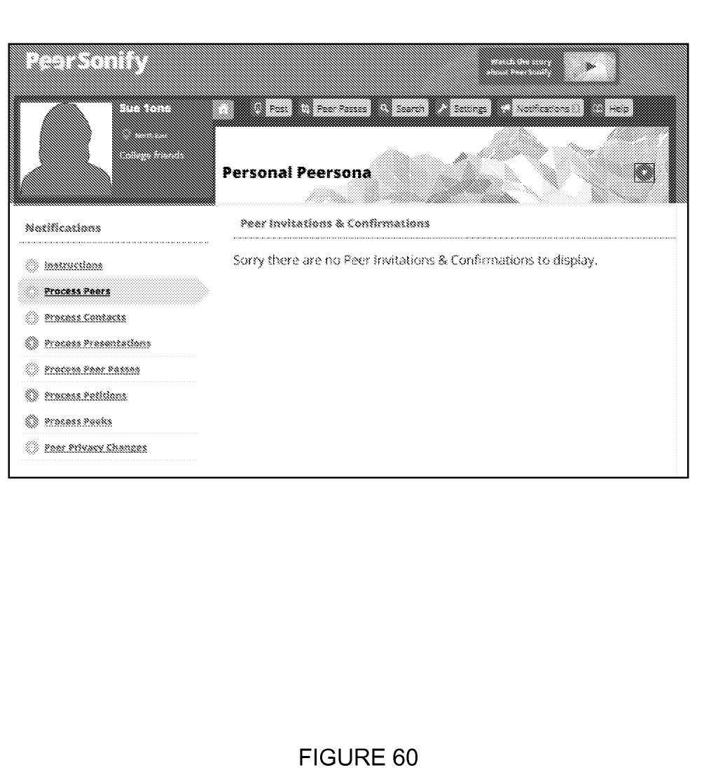

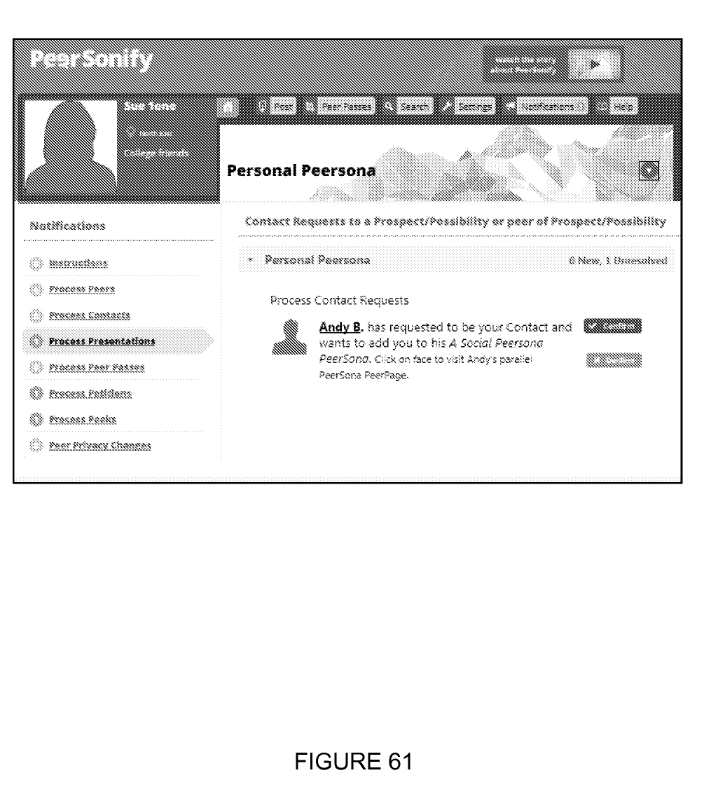

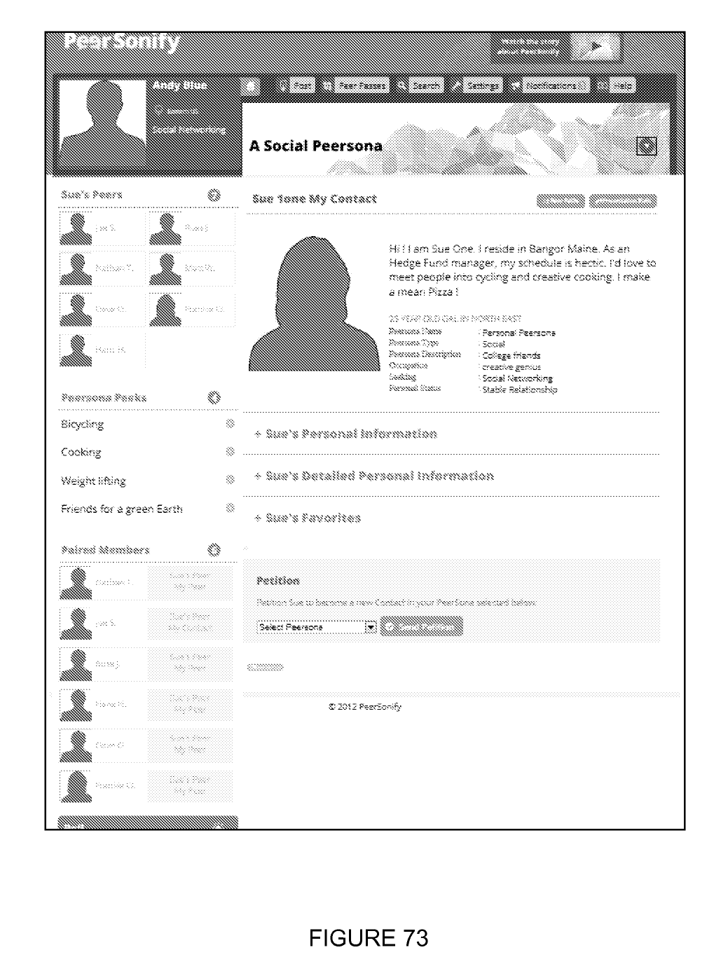

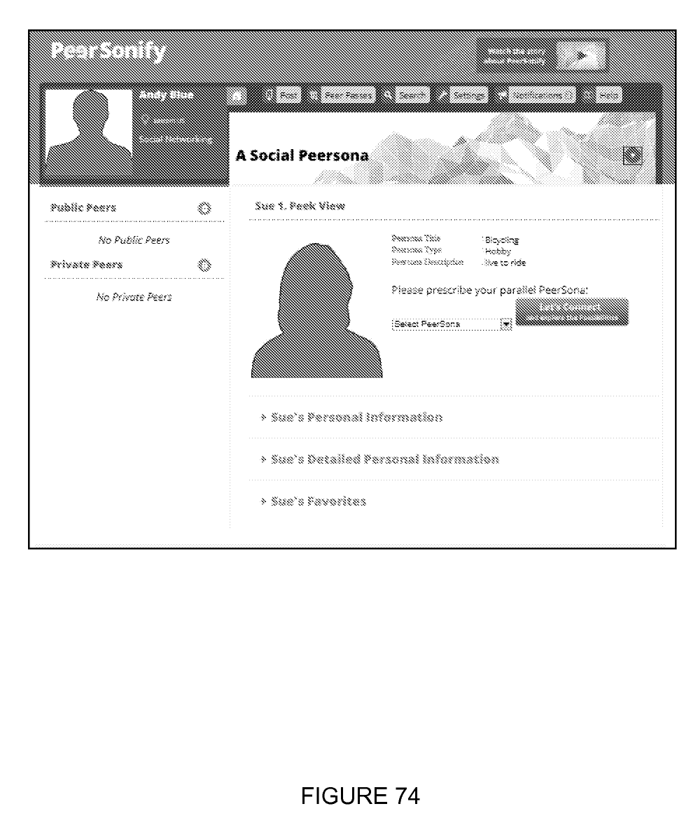

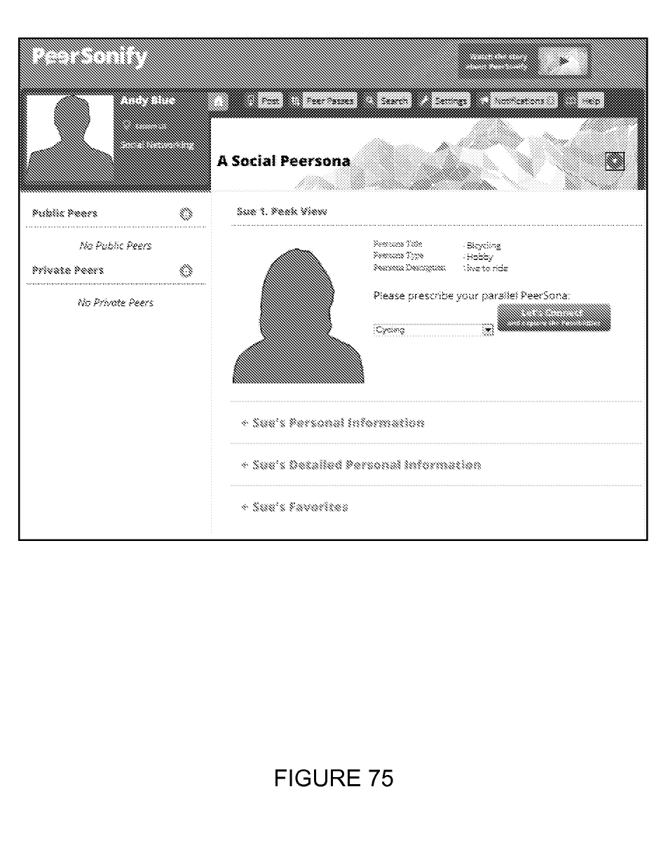

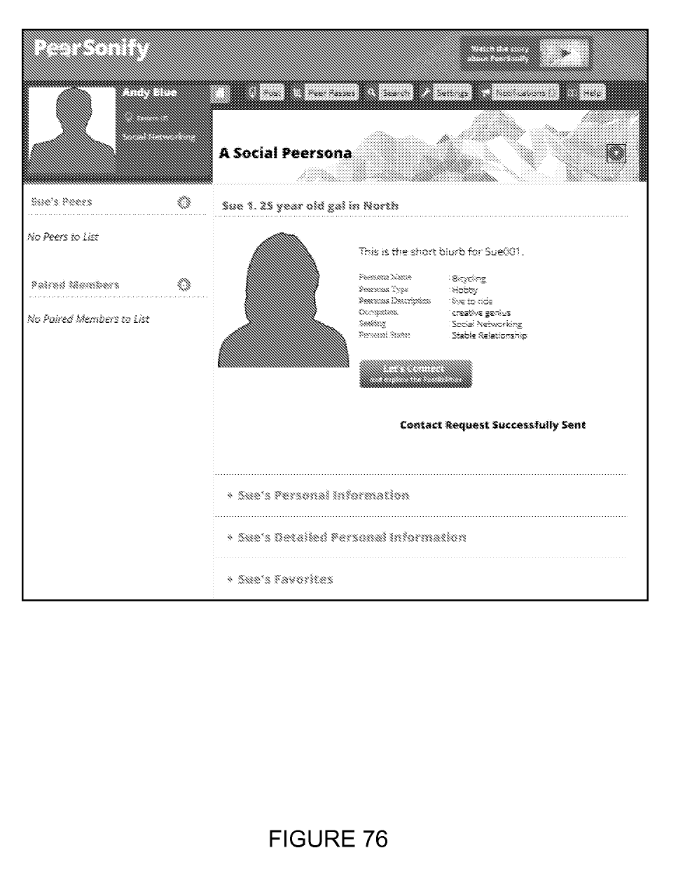

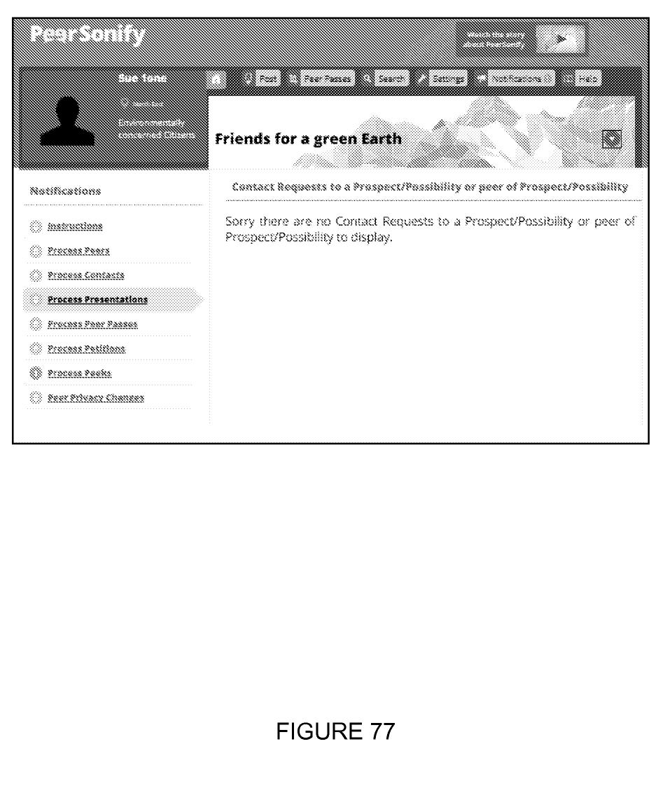

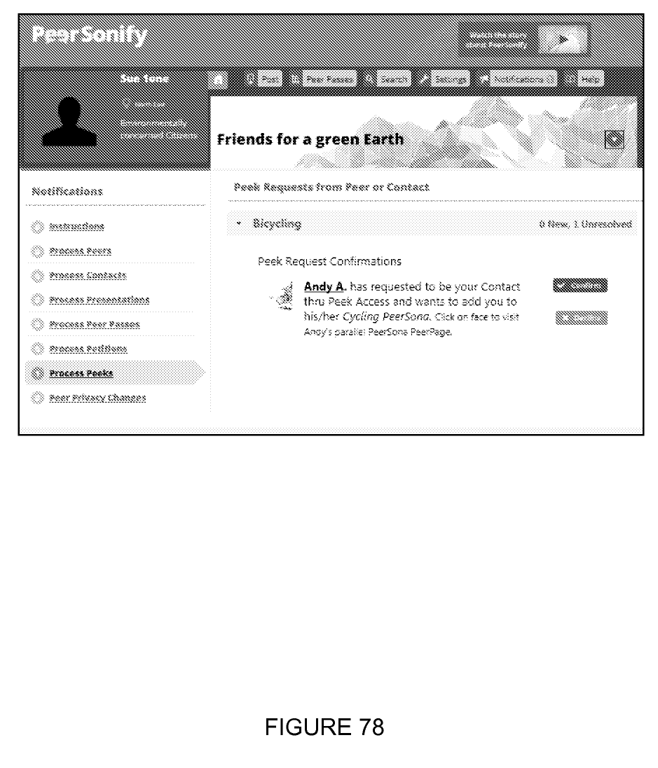

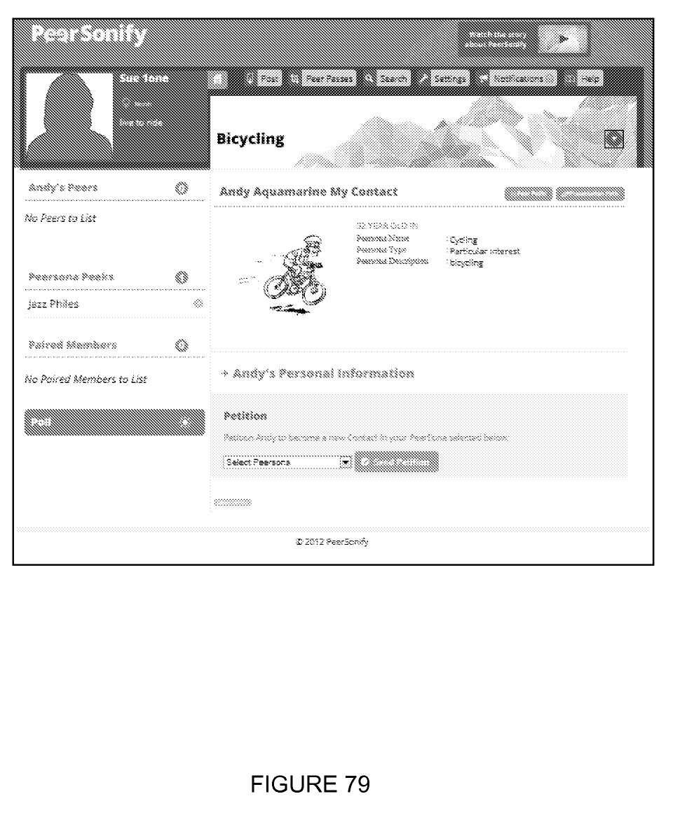

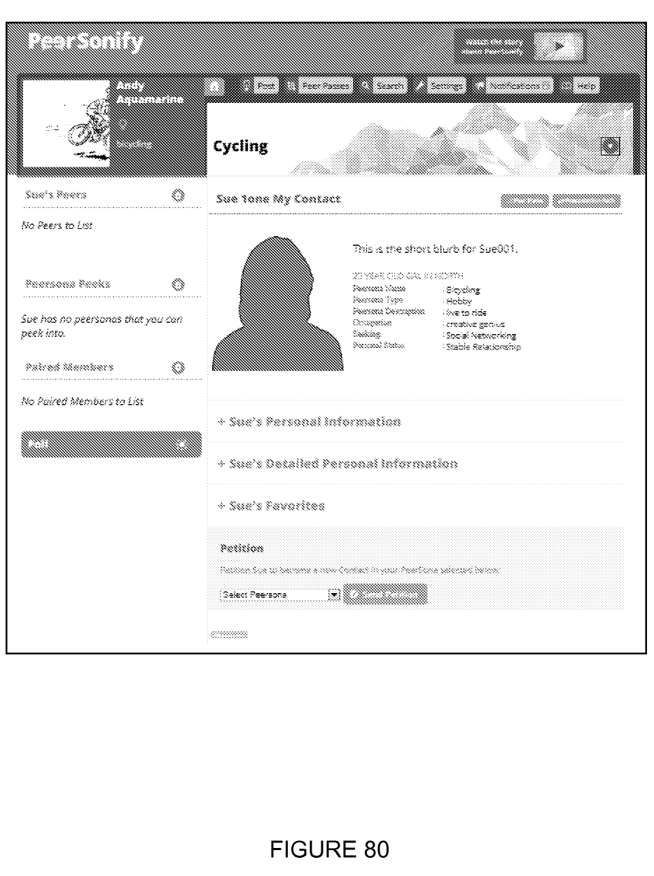

A peerpage is the page a member sees when the member clicks on another member's profile photo and what other member sees when they click on the member's peerpage. See FIGS. 14, 17, 39, 40, 42, 54, 58, 59, 62, 73, 79, and 80. It includes photos and a profile, the photos and profiles of the person's alphas, the photos and profiles of the person's mutual members, other aspect networks (if the member's has allowed viewing). A paths icon, a network poll icon. The tools it contains to determine if a member wants to request someone to become their beta are: (1) the person's profile and photos; (2) the person's alpha's profiles and photos, (3) the identity of the mutual members, (4) the member's paths, connections (and the path connections of the member's alphas), (5) other aspect networks the member chooses to include in their linked networks box and (6) a poll your network icon. If the other member is one of your alphas, the peerpage will also include your alphas' betas. In one preferred embodiment, if the other member is an alpha, the peerpage will include the other member's alphas, betas, gammas, and deltas and may closely emulate the other member's console. See FIG. 17.

### Console Page

FIG. 5 is an illustrative partial screen shot provided by the system, in accordance with an embodiment of the invention, showing the Console for member Andy in connection with his professional aspect network (Professional PeerSona). Each console is a “Home Page” for each aspect related network (peersona), every peersona has a console. See FIGS. 5 13, 16, 49, 57, 71, and 72.

### Settings Page

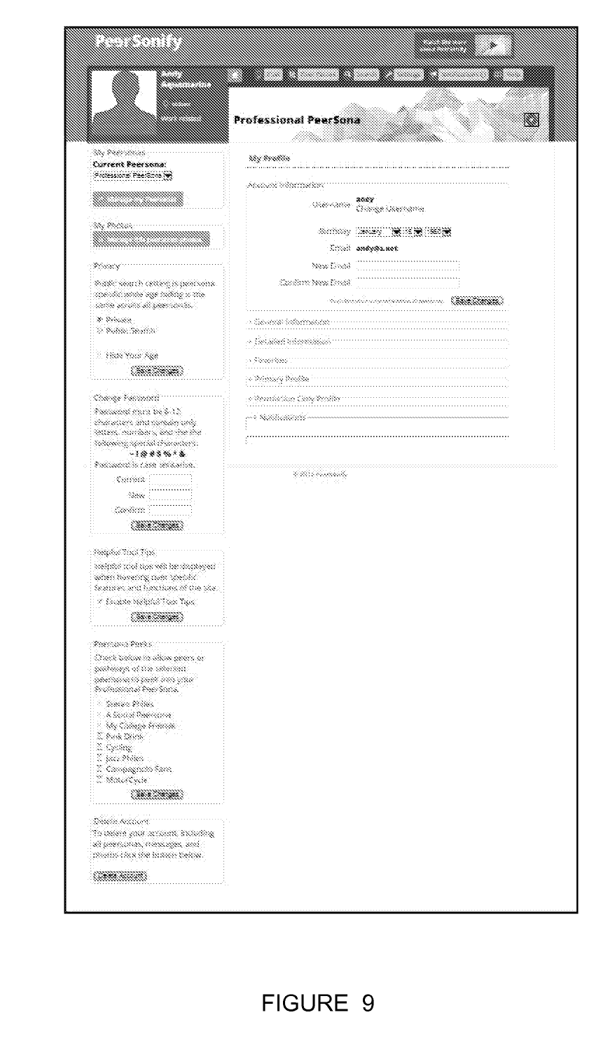

The GUI page where a member manages their profile, privacy, linked networks, aspect networks, etc. See FIGS. 9, 33, 34 and 48.

### Personal Introduction

In one embodiment, member A can send a peerpage of member's alpha member B or beta member C to another of their alphas, member D or betas, member E with a message indicating why they may want to connect. In another embodiment, member A can send member B's peerpage to member D and member D's peerpage to member B. The recipient member can request to connect and has all other peerpage tools and information available to them from a personally introduced peerpage.

### Membership by Entities

Companies, businesses and other non-individual entities can become members and network like any other member. In one embodiment, an entity member may only have other entities as peers and contacts and may only request to connect with or invite into its network other entities.

### Peer (Alpha) Pressure

Peers (alphas) can register a vote to their peer (alpha) who can request to connect to someone they can see but cannot request to connect with. If the request to connect is accepted, then those peers (alphas) can request to connect directly with such member. If a fixed percentage of a members peers (alphas) register their vote that the peer (alpha) member in control request to connect with a particular member, then the member they want connected will begin to flash (or some other display to show that the peers (alpha) want a request to connect to that member Peers (alphas) can register a vote to their peer (alpha) who can request to connect to someone they can see but cannot request to connect with. If the request to connect is accepted, then those peers (alphas) can request to connect directly with such person. If a fixed percentage of a members peers (alphas) register their vote that the peer (alpha) member in control request to connect with a particular member, then the member they want connected will begin to flash (or some other display to show that the peers (alpha) want a request to connect to that person.

### RedBox/GreenBox

When member A does not have access to open a Face X (who must have elected PVT, because the Face would open if it was Public) then member X's face will be boxed in RED (or by another identifier) and member A will only see the short blurb of X and X's portrait (and in one embodiment the number of private peers and public peers of X). When member A has access gets to a Face Y at the same level removed where the Portrait would be boxed in Red, (or by another identifier) (as in prior sentence because to many levels removed from its alpha), then if member Y elected the PUBLIC setting, then face Y will be boxed in GREEN (or by another identifier) and member A will be able to open Y's PeerPage. Similarly, A will be able to open every Face at all deeper levels when ever they elect Public setting, and those Faces, after 2 levels removed from original alpha connection, will always be boxed in GREEN (or by another identifier) and openable.

The following description of the invention utilizes, on occasion, slightly different terms for the same concepts described earlier. Importantly, notwithstanding any difference in terminology it still describes various embodiments of the present invention.

For example, an alpha is referred to as a peer; a beta is referred to as a direct portrait; a gamma is referred to as an indirect peer; a delta is referred to as an indirect portrait; the console is the portrait page; profile, profile information, profile data are information members provide on themselves, it can include any combination of information, including images, text, video/audio recording, and/or the like; a profile is a members profile data and their peer profile; a member's profile data is added to an invitee's profile as a “portrait profile”; invitee credentials are invitations from one member to another to connect.

Aspects of the invention provide an electronic social networking solution that enables users to use traditional social networking techniques in an electronic environment. In particular, aspects of the invention provide a networking environment, in which data for a plurality of members is managed. Each member includes profile data and may include one or more peers. A peer can comprise another member that is a friend, colleague, and/or the like, of the member. The member can provide invitee credentials, such as an identifier (e.g., user name) and password, which another member can use to view some or all of the profile data of the member. Additionally, peers of the other member can also view some or all of the profile data of the member and both the other member and his/her peers can view some or all of the profile data of the peer(s) of the member. In this manner, a networking environment is provided that enables an individual and his/her peers to learn about another individual in the context of the other individual's peers.

A first aspect of the invention provides a method of providing a networking environment, the method comprising: managing data for a plurality of members, each member including profile data that cannot be viewed by other members without a relationship between the members; receiving invitee credentials for viewing profile data of a first member from a second member; enabling the second member to view the profile data of the first member in response to the invitee credentials; and enabling a third member to view the profile data of the first member in response to the invitee credentials, wherein relationship data defines the third member as a peer of the second member.

A second aspect of the invention provides a system for providing a networking environment, the system comprising: a component configured to manage data for a plurality of members, each member including profile data that cannot be viewed by other members without a relationship between the members; a component configured to receive invitee credentials for viewing profile data of a first member from a second member; a component configured to enable the second member to view the profile data of the first member in response to the invitee credentials; and a component configured to enable a third member to view the profile data of the first member in response to the invitee credentials, wherein relationship data defines the third member as a peer of the second member.

A third aspect of the invention provides a computer program comprising program code stored on a computer-readable medium, which when executed, enables a computer system to implement a method of providing a networking environment, the method comprising: managing data for a plurality of members, each member including profile data that cannot be viewed by other members without a relationship between the members; receiving invitee credentials for viewing profile data of a first member from a second member; and storing relationship data indicating that the first member is a direct portrait of the second member, wherein the relationship data enables the second member to view the profile data of the first member, and enables a third member to view the profile data of the first member, wherein relationship data defines the third member as a peer of the second member.

A fourth aspect of the invention provides a method of generating a system for providing a networking environment, the method comprising: providing a computer system operable to: manage data for a plurality of members, each member including profile data that cannot be viewed by other members without a relationship between the members; receive invitee credentials for viewing profile data of a first member from a second member; enable the second member to view the profile data of the first member in response to the invitee credentials; and enable a third member to view the profile data of the first member in response to the invitee credentials, wherein relationship data defines the third member as a peer of the second member.

A fifth aspect of the invention provides a method comprising: at least one of providing or receiving a copy of a computer program that is embodied in a set of data signals, wherein the computer program enables a computer system to implement a method of providing a networking environment, the method comprising: managing data for a plurality of members, each member including profile data that cannot be viewed by other members without a relationship between the members; receiving invitee credentials for viewing profile data of a first member from a second member; enabling the second member to view the profile data of the first member in response to the invitee credentials; and enabling a third member to view the profile data of the first member in response to the invitee credentials, wherein relationship data defines the third member as a peer of the second member.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

As indicated above, aspects of the invention provide a networking environment, in which data for a plurality of members is managed. Each member includes profile data and may include one or more peers. A peer can comprise another member that is a friend, colleague, and/or the like, of the member. The member can provide invitee credentials, such as an identifier (e.g., user name) and password, which another member can use to view some or all of the profile data of the member. Additionally, peers of the other member can also view some or all of the profile data of the member and both the other member and his/her peers can view some or all of the profile data of the peer(s) of the member. In this manner, a networking environment is provided that enables an individual and his/her peers to learn about another individual in the context of the other individual's peers. As used herein, unless otherwise noted, the term “set” means one or more (i.e., at least one) and the phrase “any solution” means any now known or later developed solution.

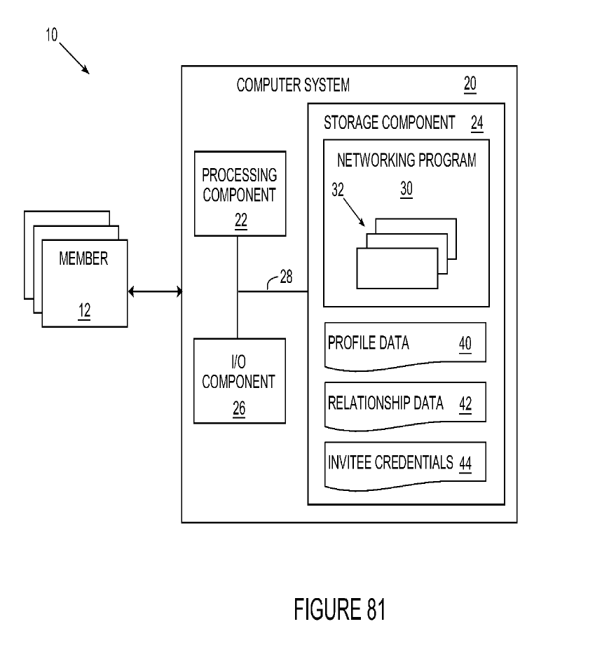

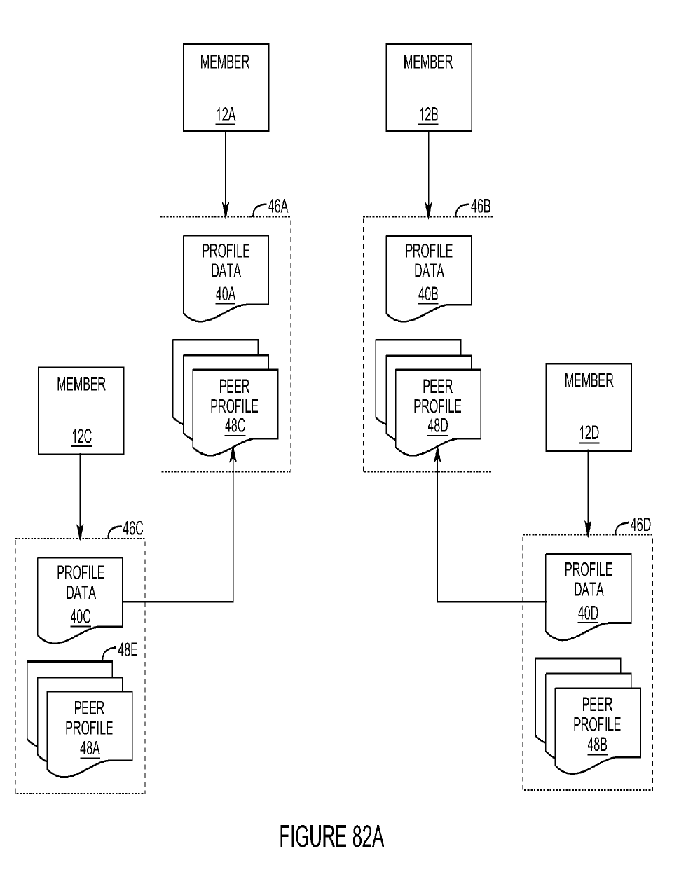

Turning to the drawings, FIG. 81 shows an illustrative environment 10 for providing a networking environment according to an embodiment. To this extent, environment 10 includes a computer system 20 that can perform the process described herein in order to provide a networking environment. In particular, computer system 20 is shown including a networking program 30, which makes computer system 20 operable to provide a networking environment by performing the process described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as networking program 30, which is at least partially stored in storage component 24. While executing program code, processing component 22 can read and/or write data to/from storage component 24 and/or I/O component 26. Pathway 28 provides a communications link between each of the components in computer system 20. I/O component 26 can comprise one or more human I/O devices, which enable a human user, such as a member 12, to interact with computer system 20 and/or one or more communications devices to enable a system user (e.g., a computer system being utilized by member 12) to communicate with computer system 20 using any type of communications link. To this extent, networking program 30 can manage interaction with member(s) 12 using a human user interface (e.g., a graphical user interface (GUI)), an application program interface (API), and/or the like.

In any event, computer system 20 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, networking program 30 can be embodied as any combination of system software and/or application software.

Further, networking program 30 can be implemented using a set of modules 32, which can be distributed and/or implemented as a unit and/or as multiple, distinct units. In this case, a module 32 can enable computer system 20 to perform a set of tasks used by networking program 30, and can be separately developed and/or implemented apart from other portions of networking program 30. As used herein, the term “component” means any configuration of hardware, with or without software, which implements and/or enables a computer system 20 to implement the functionality described in conjunction therewith using any solution, while the term “module” means program code that enables a computer system 20 to implement the functionality described in conjunction therewith using any solution. When embodied in a tangible medium of expression, networking program 30, or a module 32 thereof, is a component. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, a computing device may have only a portion of networking program 30 installed thereon (e.g., one or more modules 32). However, it is understood that computer system 20 and networking program 30 are only representative of various possible equivalent computer systems that may perform the process described herein. To this extent, in other embodiments, the functionality provided by computer system 20 and networking program 30 can be at least partially implemented by one or more computing devices that include any combination of general and/or specific purpose hardware and/or program code. In each embodiment, the program code and hardware can be created using standard programming and engineering techniques, respectively.

Regardless, when computer system 20 includes multiple computing devices, the computing devices can communicate over any type of communications link. Further, while performing the process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, networking program 30 enables computer system 20 to provide a networking environment. To this extent, computer system 20 can enable one or more individuals to become members 12 and provide profile data 40 on himself/herself for storage on computer system 20 using any solution. Profile data 40 can include any combination of information on the member 12 including one or more images, text, video/audio recordings, and/or the like. Computer system 20 can manage (e.g., store, retrieve, create, manipulate, organize, present, etc.) profile data 40 using any solution (e.g., a set of databases). In an embodiment, computer system 20 can present a series of questions, which prompt member 12 for information that is required and/or is suggested for inclusion in profile data 40. Further, computer system 20 can provide security for creating and/or modifying profile data 40 using any solution (e.g., username and password). Still further, computer system 20 can verify some or all of profile data 40 entered by member 12 and/or that member 12 is a human (and not a software agent) using any solution (e.g., valid email address, valid credit card number, valid phone number, using image(s) of distorted letters/numbers, and/or the like).

In any event, member 12 can manage relationship data 42, which defines various types of relationships between member 12 and other members. For example, computer system 20 can enable member 12 to designate one or more other members 12 as “peers” using any solution, e.g., by providing an email address, a phone number, a user name for networking environment 10, and/or any other type of identifying information. A peer can comprise a friend, colleague, trusted individual, and/or the like, of member 12. In this case, computer system 20 can generate and store relationship data 42 that indicates that the two members are peers. The peer relationship data 42 can comprise a two-way relationship, in which both members 12 are peers of one another. To this extent, computer system 20 can require that both members 12 agree to be peers of one another prior to adding a peer relationship to relationship data 42. Further, depending on the action being taken (as discussed herein), each member 12 can be considered a “peer master” for the group of peers. For example, the member that is considering, taking, and/or has authority to take an action can be considered the “peer master”.

In an embodiment, members 12 interact with other members 12 via one or more pages, which render some or all of their corresponding profiles. As used herein, a member's profile comprises the member's profile data 40 and some or all of the profile data 40 of each peer (if any) of the member as defined by relationship data 42. To this extent, computer system 20 can generate a set of pages based on profile data 40 and/or relationship data 42. For example, computer system 20 can generate a profile page that includes some or all of the profile data 40 on the corresponding member 12. Further, computer system 20 can generate a peer page that includes some or all of the profile data 40 for each peer of member 12 (if any). Computer system 20 can manage relationship data 42, which defines the various relationships described herein between members 12 and enable the correct communication and/or data permissions to be applied for each member 12 using any solution (e.g., entries in a relational database).

Access to view a member's 12 profile can be limited. For example, in an embodiment, peers can view each other's profiles. However, other individuals (members or non-members) must be invited by a particular member 12 before being allowed to view his/her profile. Communications between members 12 can be managed via the profiles and restricted in a similar manner. That is, peers can communicate with one another utilizing their corresponding peer pages, a forum, and/or the like. However, a non-peer member 12 can communicate with another member 12 only when requested by the other member 12 and/or a peer of the other member 12. Alternatively, access to view some or all of a member's 12 profile can be open. In this case, another member can view some or all of a member's 12 profile without first receiving an invitation. In an embodiment, computer system 20 can limit an ability to view profiles (e.g., by default), but enable member 12 to select to make the viewing of some or all of his/her profile open. For example, member 12 may define a subset of his/her profile data 40 that can be viewed publicly, a subset of his/her profile data 40 that can be viewed by an invitee, and/or the like. When member 12 makes some or all of his/her profile data 40 publicly viewable, publicly viewable profile data 40 for a peer of member 12 may also be displayed when the profile data 40 for member 12 is presented to a user. However, if a peer of member 12 does not designate any profile data 40 as being publicly viewable, no profile data 40 for that peer will be displayed to an uninvited user.

To this extent, in order for an individual to view the profile page of a particular member 12 and/or his/her peers, the individual can be provided invitee credentials 44 using any solution.

For example, a member 12 can request that computer system 20 generate invitee credentials 44. Invitee credentials 44 can comprise a user name and password combination, a hyperlink, and/or the like, which identifies and authenticates the individual and is associated with the particular member 12 for which the invitee credentials 44 were created. The invitee credentials 44 can have various restrictions. For example, invitee credentials 44 can be valid for a limited period of time after generation, a limited period of time after the first use, a limited number of uses, and/or the like. In any event, member 12, or a surrogate thereof, can distribute invitee credentials 44 to individual(s) using any solution. For example, member 12 can distribute invitee credentials 44 electronically, in a writing (e.g., a business card), via one or more friends/relatives, and/or the like. Subsequently, the invited individual can provide invitee credentials 44 to computer system 20, at which time the individual (and any of his/her peers if the individual is a member) will be provided access to the inviter's (the member 12 associated with invitee credentials 44) profile page and the profile page of each of the inviter's peers, if any.

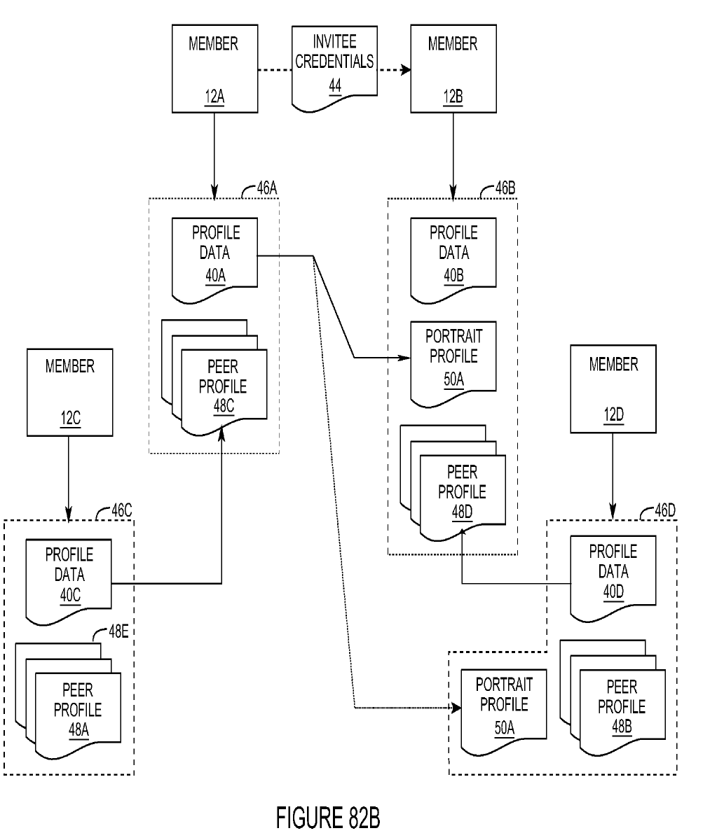

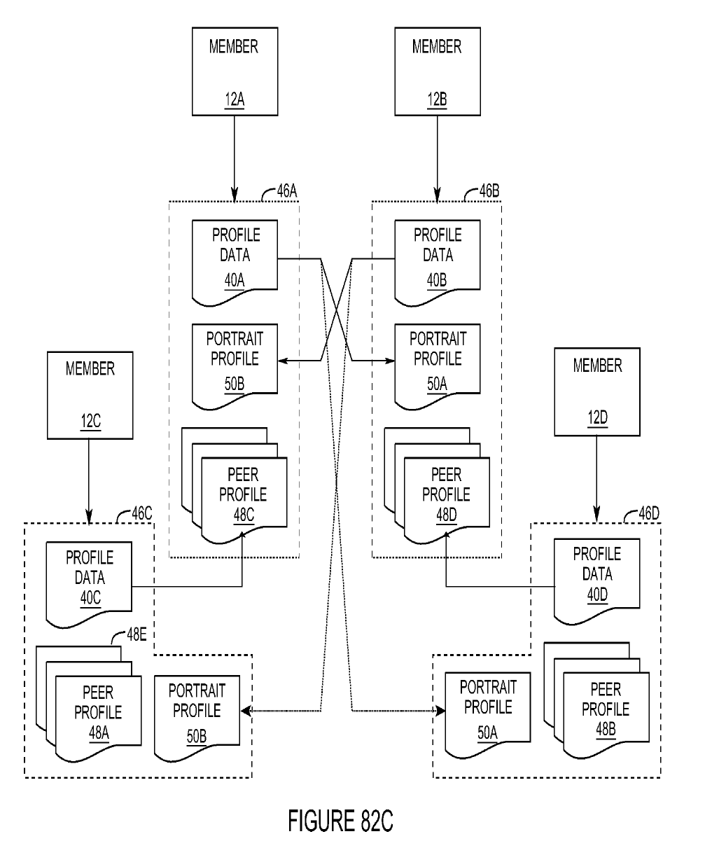

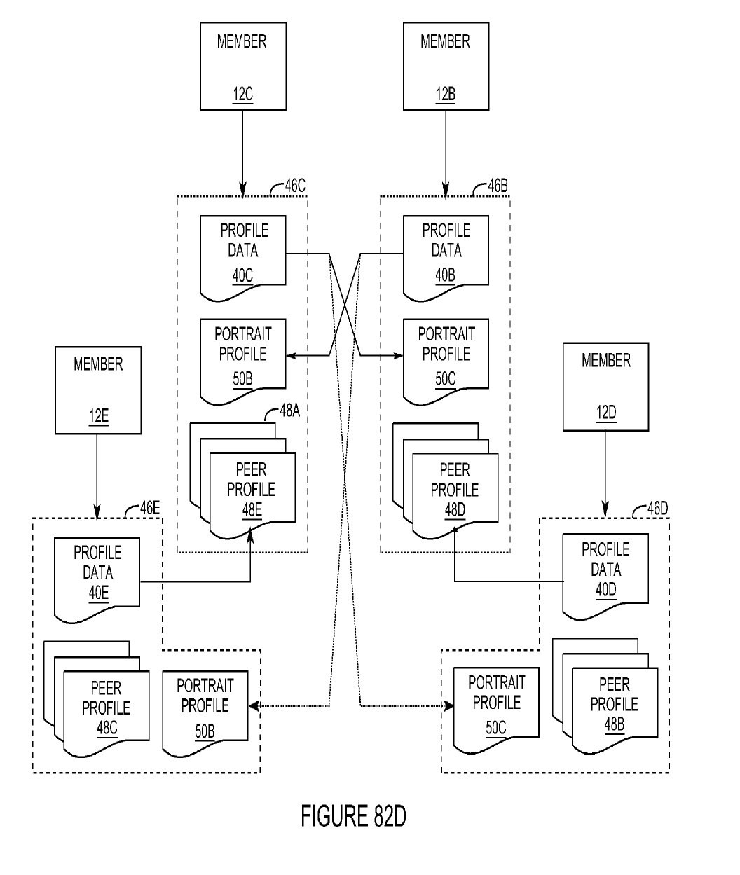

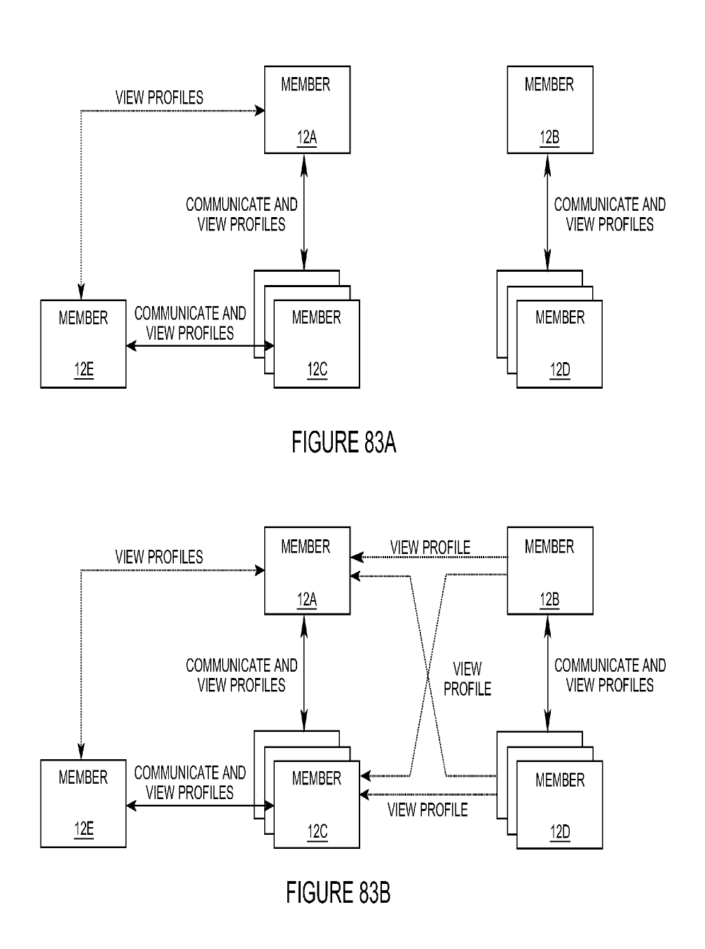

FIGS. 82A-D and 83A-D show an illustrative series of interactions and corresponding communication abilities between members 12A-E of the networking environment 10 according to an embodiment. In FIG. 82A, two distinct groups of peers are illustrated. In particular, member 12A can comprise a profile 46A that includes profile data 40A for member 12A as well as profile data, such as peer profile 48C, for one or more peers, such as member 12C, of member 12A. Similarly, member 12B comprises a profile 46B that includes profile data 40B and peer profile data 48D for member 12D, who is a peer of member 12B. Peer profiles 48C-D can comprise a subset of the data that is included in profile data 40C-D for the corresponding members 12C-D, respectively. Members 12C, 12D also are shown including similar profiles 46C, 46D, respectively. As illustrated in profile 46C, member 12C can comprise a peer (member 12E, not shown) for which peer profile 48E is included in profile 46C, but who is not a peer of member 12A.

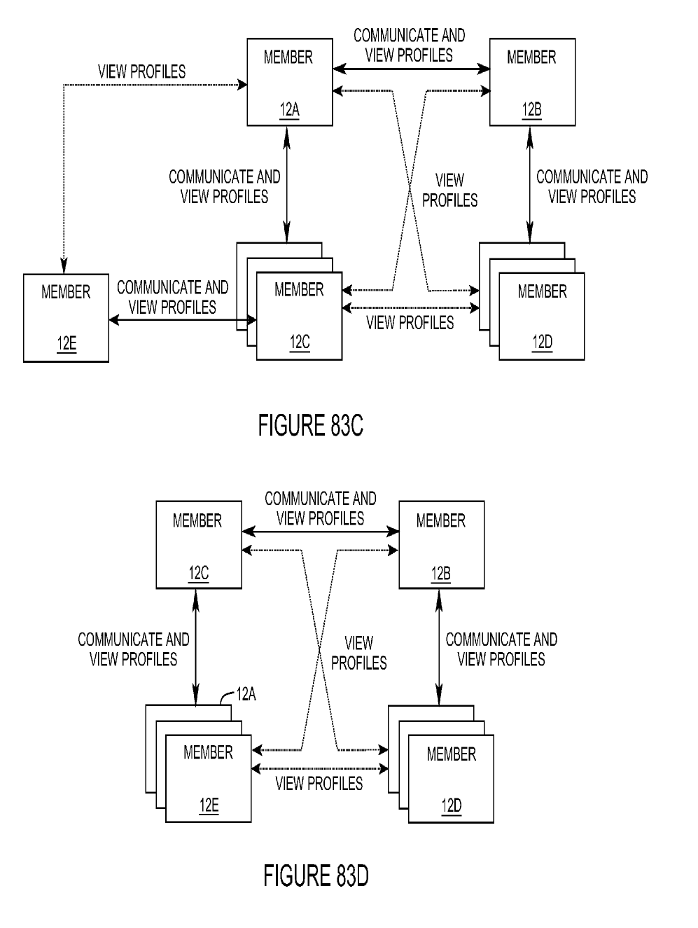

In FIG. 83A, communications between the various members 12A-E is illustrated. In particular, members 12A and 12C can communicate with one another as well as view each other's profiles since they are peers. Similarly, members 12B and 12D and members 12C and 12E can communicate with one another as well as view each other's profiles. However, members 12A, 12C, 12E cannot communicate with or view the profiles of members 12B, 12D since they are not peers and have not been requested to do so. Further, members 12A, 12E can view each other's profiles since they are both peers of member 12C (“indirect peers”), but members 12A, 12E cannot communicate with one another.

In FIG. 82B, member 12A provides invitee credentials 44 to member 12B. As discussed previously, invitee credentials 44 enable a user (member or non-member) to view some or all of the profile 46A of member 12A. Upon receiving invitee credentials 44 from the user, computer system 20 can enable the user to view profile 46A. Additionally, when the user is a member, such as member 12B, invitee credentials 44 can comprise an invitation to exchange profiles with one another, thereby expanding the number of contacts for each member 12A-B and their corresponding peers 12C-D. To this extent, after receiving invitee credentials 44, computer system 20 can add profile data 40A for the inviter (member 12A) to member's 12B profile 46B as a portrait profile 50A using any solution. For example, computer system 20 can generate and store relationship data 42 (FIG. 81) that defines a portrait relationship between members 12A and 12B. In an embodiment, the portrait relationship is a one way relationship (e.g., member 12A is a portrait of member 12B, but member 12B is not a portrait of member 12A as a result of the invitation). Further, until an exchange is accepted/declined, the relationship data 42 can indicate that the portrait relationship is temporary, pending acceptance, and/or the like. Each portrait profile 50A can comprise a subset of profile data 40A for a corresponding member 12A that has directly or indirectly invited the member 12B to view his/her profile 46A and exchange profiles. Computer system 20 (FIG. 81) can generate a separate page (“portrait page”) for displaying portrait profile(s) 50A for a member 12B. Viewing of the portrait page for a particular member 12B can be limited to the particular member 12B, and may or may not be accessible by other members including the peers of the member 12B.

As illustrated, computer system 20 also can add a portrait profile 50A to the profile, such as profile 46D, of each peer of member 12B, such as member 12D, using any solution. For example, computer system 20 can traverse relationship data 42 (FIG. 81) to identify every direct portrait of the peer(s) of member 12D, such as member 12B, and add the portrait profile(s), if any, (e.g., portrait profile 50A) to the profile of member 12D. As a result, computer system 20 can enable each peer of member 12B to view the profile 46A of member 12A. To this extent, portrait profile(s) 50A for a member can be classified by those that appear due to direct interaction with the member (e.g., “direct portrait”) and those that appear due to interaction with a peer of the member (e.g., “indirect portrait”). Further, communication privileges can be different for the two classifications. For example, a member may be able to communicate with a member that comprises a “direct portrait”, but not be able to communicate with a member that comprises an “indirect portrait”.

As illustrated in FIG. 83B, upon entry of the invitee credentials 44 (e.g., acceptance of the invitation), computer system 20 enables member 12B and member's peers, such as member 12D, to view some or all of the profile (profile data and peer profile(s)) of member 12A. Additionally, members 12B, 12D can view some or all of the profile(s) of the peers of member 12 A, such as member 12C. In an embodiment, the members 12B, 12D can not view the peers of the inviter's peers (e.g., member 12E). Alternatively, members 12B, 12D can be allowed to view the peers of the inviter's peers. However, members 12A, 12C cannot yet view the profiles of members 12B, 12D. In an embodiment, member 12B and member 12A cannot communicate with one another. Alternatively, member 12B could communicate with member 12A, while member 12A could not communicate with member 12B unless as part of a communication initiated by member 12B.

At this point, member 12B can consider whether or not to accept the invitation to exchange profiles with member 12A. To this extent, member 12B can consider the invitation without having exchanged any personal information with member 12A. Further, member 12A and his/her peers cannot view any of member 12B and/or his/her peers' profiles as a result of accepting the invitation. The invitee credentials 44 can require that member 12B accept/reject the invitation within a designated period of time. If member 12B does not take any action prior to the end of the period, member 12B can be presumed to have rejected the invitation. Regardless, in an embodiment, while member 12B is considering the exchange (or after the exchange is accepted), member 12B and/or one or more of his/her peers can request an exchange with member 12A and/or one or more of his/her peers, such as member 12C. Alternatively, member 12B and/or one or more of his/her peers cannot request an exchange with member 12A and/or one or more of his/her peers until member 12B has accepted the exchange with member 12A.

Computer system 20 (FIG. 81) can enable peers to communicate amongst each other using any solution(s). For example, computer system 20 can manage communications between members 12B, 12D via text messages, a chat room, email, telephone, and/or the like. The peers can discuss the inviter (e.g., member 12A) with the invitee (e.g., member 12B) and recommend whether the invitee should exchange his/her profile with the inviter.

In FIG. 82C, member 12B exchanges profiles with member 12A. As a result, computer system 20 can generate and store relationship data 42 (FIG. 81) that indicates that members 12A, 12B have exchanged profiles. For example, computer system 20 can generate and store relationship data 42 that indicates that both members 12A, 12B are direct portraits of each other. Further, using relationship data 42, computer system 20 adds the portrait profile 50A-B for each member 12A-B to the other member's profile 46B-A, respectively, and computer system 20 also adds portrait profiles 50A-B to the profiles 46D-C of the other member's peer(s), respectively. As illustrated in FIG. 83C, members 12A-B can now communicate with each other and view each other's profiles. Further, each member 12A-B and the peers of each member, members 12C-D, can view the profiles of the other member and his/her peers. In an embodiment, the members 12B, 12D can not view the peers of the exchanged member's 12A peers (e.g., member 12E). Alternatively, members 12B, 12D can be allowed to view the peers of the exchanged member's 12A peers.

FIG. 82D illustrates a scenario in which member 12B, after receiving an invitation from member 12A (FIG. 82B), decides to exchange with member 12C, a peer of member 12A, and member 12C accepts the exchange. In this case, computer system 20 adds relationship data 42 (FIG. 81) that indicates that members 12B, 12C have exchanged profiles (e.g., both are direct portraits). Further, computer system 20 adds the portrait profiles 50B-C to the corresponding portraits 46C-B, respectively, and computer system 20 adds portrait profile 50B to the peers of member 12C, e.g., members 12A, 12E. As illustrated in FIG. 83D, members 12B-C can communicate with one another and view their respective profiles, while the peers of member 12C, which includes both members 12A, 12E, can view the profiles of member 12B and his/her peers 12D and vice versa.

Over time, relationships between members 12A-E may change. To this extent, computer system 20 can enable a member 12A-E to change a classification of a member (e.g., from a “portrait” to a “peer”). Further, computer system 20 can enable a relationship to terminate (e.g., member 12C can drop member 12B as a portrait). In either case, computer system 20 can update relationship data 42 (FIG. 81) to reflect the change(s). Additionally, computer system 20 can update the profiles of the members and their peers to reflect the changed relationship. When a member, e.g., member 12C, seeks to move another member, e.g., member 12B, to a higher classification (e.g., from portrait to peer), computer system 20 can require that both members 12B-C agree to the change, since such an increase will mean further distribution of the other member's 12B-C data at the discretion of the member 12C-B (e.g., member 12B's data will be made available to invitee's of member 12C and vice versa).

When relationships between members are terminated, it can result in a portrait being removed from a member's profile. For example, if the relationship between members 12B-C is terminated, then the inclusion of portrait profile 50B in profile 46E will be removed. However, a member may have multiple paths to the same portrait profile. For example, even after terminating the relationship, portrait profile 50B could still appear on profile 46C as an “indirect portrait” if members 12A-B exchanged profiles since member 12C is a peer of member 12A. In this case, computer system 20 can remove the portrait profile 50B (e.g., allow the terminated relationship to overrule the indirect relationship) or keep portrait profile 50B as an indirect portrait.

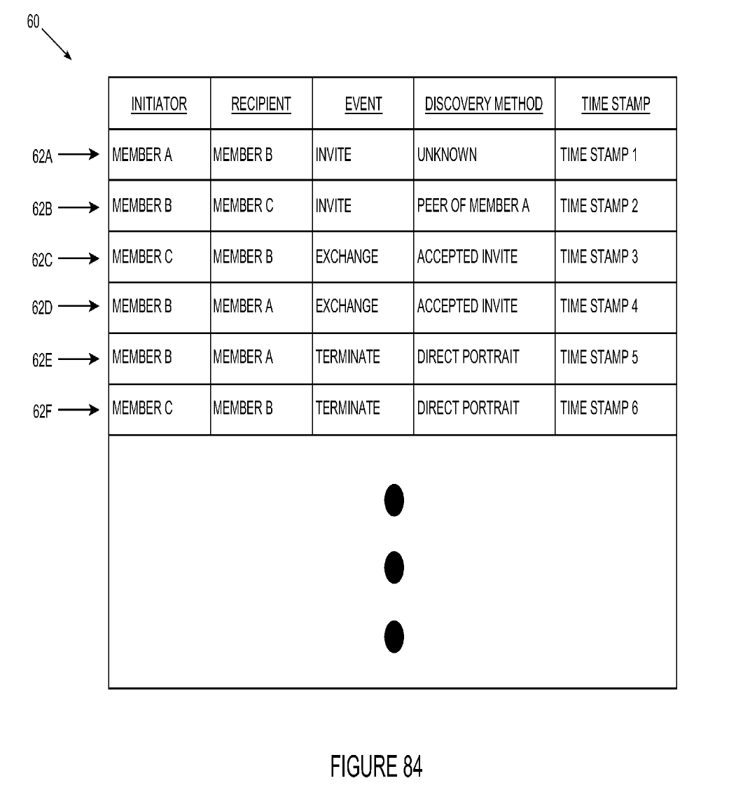

In an embodiment, computer system 20 can enable a member to determine a chain of events that led to another member being included as a direct or indirect portrait. To this extent, FIG. 84 shows an illustrative table 60 for storing events 62A-F according to an embodiment. In particular, computer system 20 can store, for each event 62A-F, an initiating member (“Initiator”) a receiving member (“Recipient”), an event type, a discovery method (e.g., the way that the initiator learned about the recipient), and a time stamp. It is understood that this data is only illustrative and different configurations of data using more and/or less fields are possible under the disclosure. In any event, computer system 20 can construct and display a path/chain of events using a linked list, and/or the like, which enables a member to determine how another member appeared as a direct/indirect portrait of the member.

In the illustrative scenario: MEMBERS A, C, and F are peers of one another; MEMBERS B and D are peers of one another; and MEMBERS E and C are peers one another, but MEMBER E is not a peer of MEMBER A or F. In this case, MEMBER A is a peer master of a peer group that also includes MEMBERS C, F; MEMBER B is a peer master of a group that also includes MEMBER D; MEMBER C is a peer master of a group that also includes MEMBERS A, E, F; MEMBER D is a peer master of a group that also includes MEMBER B; MEMBER E is a peer master of a group that also includes MEMBER C; and MEMBER F is a peer master of a group that also includes MEMBERS A, C.

Assuming events 62A-F occurred chronologically, after event 62A, MEMBER D acquires MEMBER A as an indirect portrait and MEMBER B acquires MEMBER A as a direct portrait; and after event 62B, MEMBERS A, F, and E acquire MEMBER B as an indirect portrait and MEMBER C acquires MEMBER B as a direct portrait. After event 62C, MEMBER D acquires MEMBER C as an indirect portrait and MEMBER B acquires MEMBER C as a direct portrait; and after event 62D, MEMBER A acquires MEMBER B as a direct portrait (and MEMBER B is removed as an indirect portrait of MEMBER A), MEMBER C would acquire MEMBER B as an indirect portrait, but MEMBER B is already included as a direct portrait, and MEMBER F would acquire MEMBER B as an indirect portrait, but MEMBER B is already an indirect portrait of MEMBER F due to event 62B.

Event 62A enables MEMBER B and his/her peers to access the profile data of MEMBER A and his/her peers. Event 62D enables MEMBER A and his/her peers to access the profile data of MEMBER B and his/her peers. Similarly, event 62B enables MEMBER C and his/her peers to access the profile data of MEMBER B and his/her peers. Event 62C enables MEMBER B and his/her peers to access the profile data of MEMBER C and his/her peers. However, access to the profile data can be altered when one or more relationships/exchanges are terminated.

To this extent, after event 62E, MEMBERS A, B are no longer direct portraits. Using MEMBER A as an illustrative example, computer system 20 (FIG. 81) removes MEMBER B from his/her portrait page. However, computer system 20 also can determine if a peer of MEMBER A includes MEMBER B as a direct portrait. If so, computer system 20 can re-admit MEMBER B as an indirect portrait using the alternative path. In this example, MEMBER C, a peer of MEMBER A, has MEMBER B as a direct portrait. As a result, computer system 20 can re-admit MEMBER B as an indirect portrait of MEMBER A. Alternatively, computer system 20 can allow the termination to overrule the indirect path and keep MEMBER B off of MEMBER A's portrait page.

Computer system 20 can perform a similar process for each peer of MEMBERS A, B. For example, using MEMBERS C, F as illustrative peers, computer system 20 determines whether MEMBER B is a direct/indirect portrait of the peer. If MEMBER B is a direct portrait, as for MEMBER C, computer system 20 will leave MEMBER B on the portrait page. However, if MEMBER B is an indirect portrait, as for MEMBER F, computer system 20 will determine if MEMBER F acquired MEMBER B as an indirect portrait through MEMBER A. In an embodiment, event 62B could comprise the event that adds MEMBER B as an indirect portrait. Alternatively, event 62A could be considered the earliest event, although MEMBER B was not added due to this event until after event 62D. In any event, if MEMBER B was added as an indirect portrait through MEMBER A, MEMBER B is removed as an indirect portrait. Otherwise, MEMBER B will remain as an indirect portrait. Additionally, when MEMBER B is removed, computer system 20 also can determine if another peer of MEMBER F includes MEMBER B as a direct portrait (e.g., MEMBER C). If so, MEMBER B can be re-admitted as an indirect portrait of MEMBER F using the alternative path.

Assuming no events other than events 62A-F, after event 62F, MEMBERS B and C are removed as direct portraits of one another, MEMBER B is removed as an indirect portrait of MEMBERS E, F (and MEMBER A, if re-admitted after event 62E), and MEMBER C is removed as an indirect portrait of MEMBER D. When a member remains as an indirect portrait despite one or more terminated exchanges (e.g., due to other exchanges), computer system 20 can display an indication that one or more terminated exchanges have occurred in the direct/indirect and/or an alternative chain of events, which may be interpreted by the member as a warning sign of trustworthiness, compatibility, and/or the like. Further, computer system 20 can retain a chain of events, such as events 62A, D, E after the termination for potential future reference. For example, when a member re-discovers or previously discovered (and exchanged with) another member through a different chain of events, computer system 20 can display an indication of the previous chain of events and the termination. Further, it is understood that a member terminating a peer relationship can be processed in a similar manner as the terminated exchanges discussed herein.

Returning to FIG. 81, additional details are now discussed with reference to some illustrative actions performed by a user, such as a member 12 using computer system 20, which provides a web site for users to utilize the networking environment.

To create a user account, a potential member can visit a home page provided by computer system 20 and elect to join. Computer system 20 will provide a web page requesting that the potential member provide his/her first and last names and a valid email address. Computer system 20 can send a validation email to the email address with an initial password for continuing with the registration to confirm the email address. Alternatively, the validation email can include a validation link, which will enable the potential member to continue with the registration. Assuming the email is valid, the potential member enters the password and computer system 20 can subject the potential member to a Completely Automated Public Turing test to tell Computers and Humans Apart (CAPTCHA), such as a rendering of distorted letters/numbers or the like, to ensure that t is a human user and not a software agent. Further, computer system 20 can perform additional identity check(s), e.g., confirm credit card information (if required to maintain an account/authenticate age), look up a given phone number for owner information, and/or the like.

Assuming the CAPTCHA is successfully passed, the user account is created. The user can be asked to provide a unique user name and/or password for the account (with retries if necessary). Once complete, computer system 20 can prompt member 12 for his/her profile data 40, e.g., by presenting a series of questions (e.g., home address, age, interests, etc.), obtaining alternative contact information (e.g., other email addresses, phone numbers, and/or the like), enabling images/video to be uploaded designating a primary image, and/or the like. Additionally, computer system 20 can enable member 12 to add one or more peers. Member 12 can identify his/her peers by an account name for networking environment 10, an email address, a phone number, and/or the like. Computer system 20 will attempt to match another member with the information provided. If a match is found, computer system 20 will ask the member if he/she wants to be a peer of member 12. If so, the peer relationship is established and stored as relationship data 42. It no member is found, computer system 20 can contact the individual and can provide the individual with invitee credentials 44, which will enable the individual to view the new member's profile as well as peruse the web site, and decide whether he/she wishes to join. Subsequently, member 12 can later return and manage his/her information (e.g., profile data 40 and peers).

As mentioned previously, computer system 20 can limit access to profile data 40. To this extent, member 12 (or an acquaintance of member 12) can provide invitee credentials 44 to a potential peer of member 12 and/or a potential acquaintance using any solution. In either case, the invitee credentials 44 can be uniquely created for each member 12 and include a user name and password. Invitee credentials 44 may be equipped with attribute(s) that specify a maximum number of usages/views, an expiration date, a counter to allow the inviter to determine if the invitee credentials 44 are being used or abused, and/or the like. Alternatively, invitee credentials 44 could comprise a link, which will enable a user to view the profile data 40 of member 12. Further, when invitee credentials 44 are provided to another member, the member's main web page can include an indicator of the invitation, which can enable the member to take action on the invitation.

In any event, when invitee credentials 44 are provided to computer system 20, computer system 20 can enable the user to view some or all of profile data 40 of the associated member 12 as well as his/her peer(s), if any. When the user is identified as a member of the networking environment 10, member 12 can be added as a direct portrait of the user (and an indirect portrait of his/her peers), the user (and his/her peers) also can view some or all of the profile data 40 of each peer, the user (and his/her peers) can request exchange(s) with member 12 and/or his/her peers, and/or the like. Otherwise, the user can be prompted to create an account.

When invitee credentials 44 are provided to another member and the other member enters invitee credentials 44, the inviter (e.g., member 12) is added as a direct portrait to the invitee's portraits and as an indirect portrait the portraits of the invitee's peer(s). Computer system 20 can enable the invitee and his/her peers to view the profile data 40 of the inviter, his/her peers, and the profile data 40 of the inviter's peers. Further, computer system 20 can provide a discussion area (e.g., instant messaging, forum, and/or the like) for the invitee and his/her peers to discuss the invitation.

Subsequently, the invitee and/or his/her peer may request an exchange with the inviter and/or one of his/her peers. Upon the request, the inviter and his/her peers can view and discuss the profile data 40 of the member requesting the exchange (e.g., the invitee and his/her peers or the peer and his/her peers). Upon acceptance of an exchange, the two members that exchanged can communicate with one another using computer system 20. However, absent a direct exchange, the respective peers cannot communicate with one another or the other member of the exchange (although they can view each other's profile data 40).

In this manner, there are five ways for a member 12 to discover new acquaintances. First, member 12 can initiate an exchange, e.g., by providing another with invitee credentials 44, at which point the other individual will be added as a direct portrait. Second, a peer of member 12 can initiate an exchange, at which point the other individual will be added as an indirect portrait. Third, another member can initiate an exchange with member 12, at which point the other member is added as a direct portrait. Fourth, another member can initiate an exchange with a peer of member 12, at which point the other member is added as an indirect portrait. Fifth, a peer of member 12 could add a new peer, at which point the new peer is added as an indirect peer. As a result, of the five methods, four are passive and only the first requires initial action on the part of member 12.

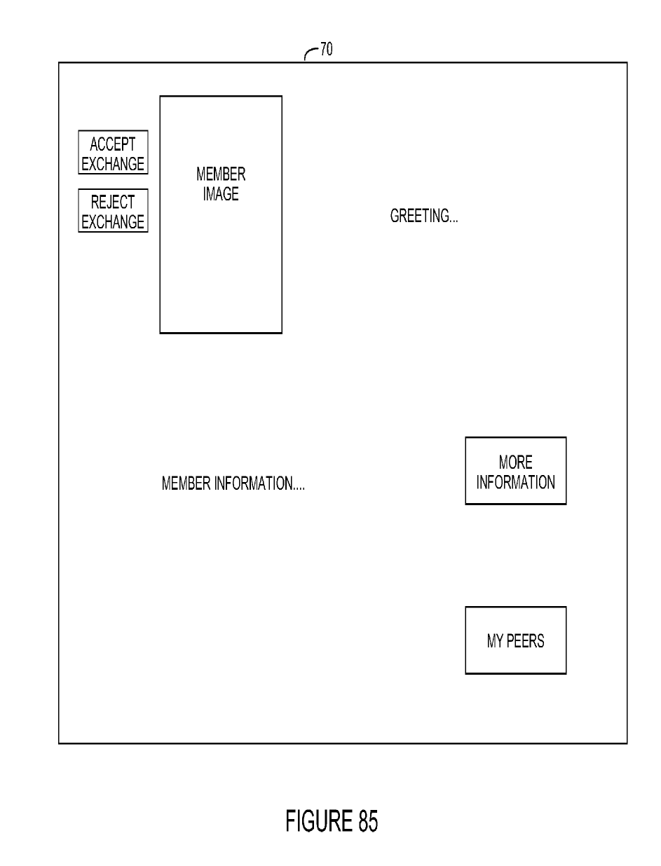

FIG. 85 shows an illustrative profile page 70 according to an embodiment, which can be generated by computer system 20 (FIG. 81). As illustrated, profile page 70 can include a primary image, a greeting, some member information, and/or the like. If available, profile page 70 can enable a user to access additional information (e.g., more pictures, additional biography, etc.). Further, profile page 70 can enable the user to access the peers of the member. Still further, when profile page 70 is presented to a member that has been invited to exchange with the member owning profile page 70, profile page 70 can enable the viewing member to accept/reject the exchange. Alternatively, when no exchange has been invited and the member owning profile page 70 is not a peer or direct profile, profile page 70 can enable the viewing member to initiate an invitation. It is understood that profile page 70 is only illustrative and additional/different functionality can be included, e.g., accept/request exchange, edit information, which can be included for the member when he/she accesses profile page 70, and/or the like.

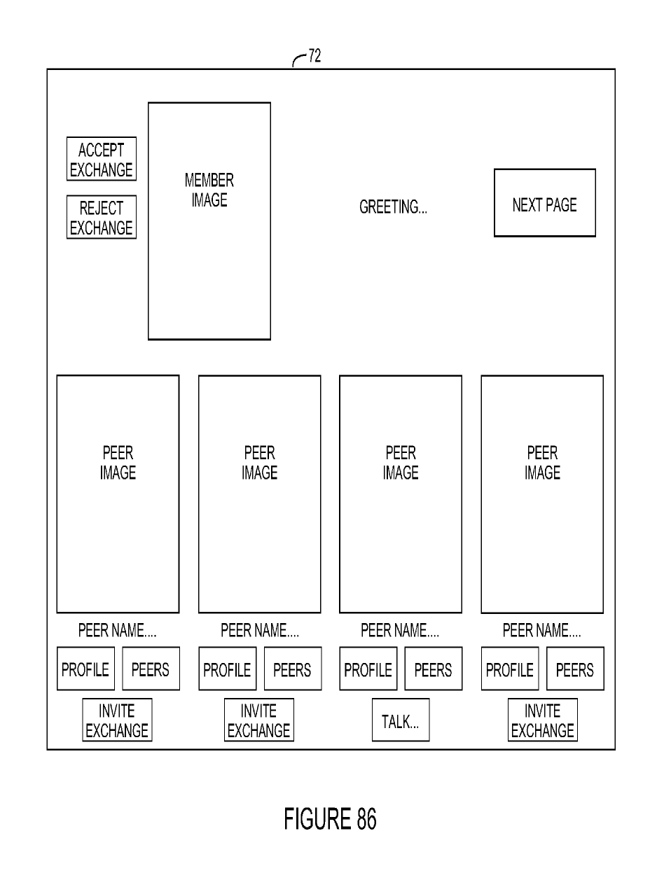

FIG. 86 shows an illustrative peer page 72 according to an embodiment, which can be generated by computer system 20 (FIG. 81). Peer page 72 can include an image of the member whose peers are being displayed as well as a peer page greeting. Further, peer page 72 can include an image of a peer, his/her name (e.g., first name), and/or other data, and enable a user to view the corresponding profile and/or peers of each peer. Further, if the user has already directly exchanged with one of the peers, peer page 72 can enable the user to communicate with the peer (e.g., “talk . . . ”). Alternatively, peer page 72 can enable the user to initiate an invitation with one or more of the members being displayed, accept/reject an invitation to exchange, and/or the like. It is understood that peer page 72 is only illustrative and additional/different functionality can be included.

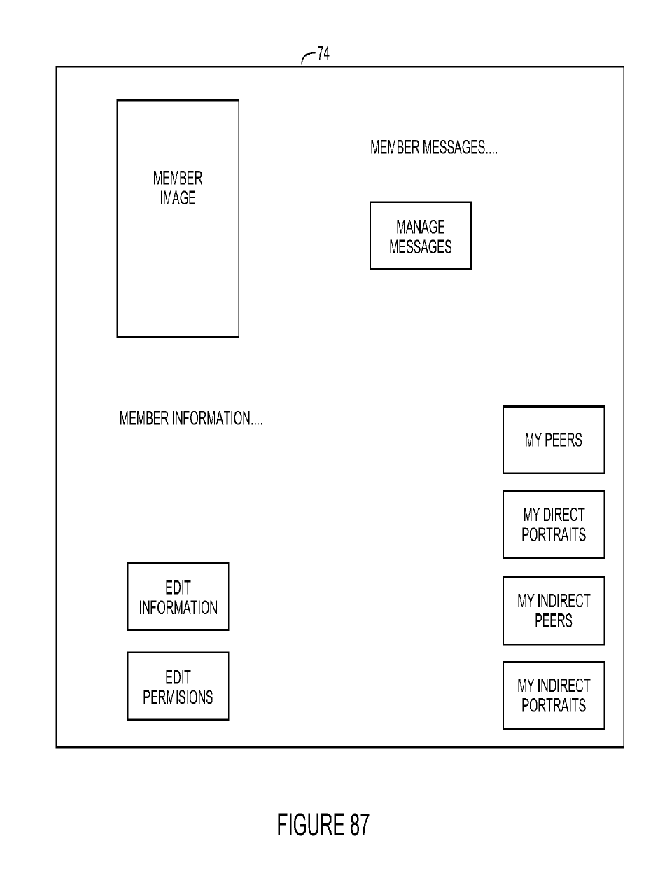

FIG. 87 shows an illustrative member page 74 according to an embodiment, which can be generated by computer system 20 (FIG. 81). Computer system 20 can provide member page 74 to a member 12 (FIG. 81) to enable member 12 to manage his/her profile (e.g., profile data 40 and relationships). As illustrated, member page 74 can enable member 12 to edit his/her profile data 40 (e.g., edit information), view/respond to messages received from other members 12 (e.g., manage messages), view/interact with profile data 40 of related members 12 and manage relationship data 42 that defines the related members. In an embodiment, member page 74 separately classifies the related members into four classes of individuals, each of which is related to member 12 via a different set of relationships.

In particular, computer system 20 can identify all members indicated as peers of member 12 in relationship data 42, and classify these members, if any, as “peers” for member 12. Additionally, computer system 20 can identify all members indicated as direct portraits of member 12 in relationship data 42, and classify these members, if any, as “direct portraits” for member 12. Further, computer system 20 can identify all members indicated as peers of a peer of member 12 and classify these members, if any, as “indirect peers” for member 12. Finally, computer system 20 can identify all members indicated as direct portraits of a peer of member 12 and classify these members, if any, as “indirect portraits” for member 12.

For each classification, member 12 may have different privileges for interacting with members of the classification as discussed herein, which the different classifications can make clear to member 12. Alternatively, member 12 may have the same privileges for two or more classifications (e.g., “indirect portraits” and “indirect peers”). Further, the relationship to members of each classification are generally less direct/more tenuous as the classes go from “peers” (most direct) to “indirect portraits” (least direct). It is understood that pages 70, 72, and 74 are only illustrative. To this extent, computer system 20 can generate pages that include similar functionality but a different look and feel. Further, computer system 20 can enable a member 12 to customize the layout of a particular page. Still further, computer system 20 can include additional information on a page, such as indicia for new information/information that has changed, access rights, and/or the like. Additionally, when sufficient screen space is available, computer system 20 can include profile data 40 (e.g., an image, name, location) on related members 12 on page 70 and/or 74. Further, computer system 20 can enable a user to view additional information (e.g., interests, career, etc.) using any solution, such as through the use of a popup window (e.g., in response to a scroll/hover over event) or the like.

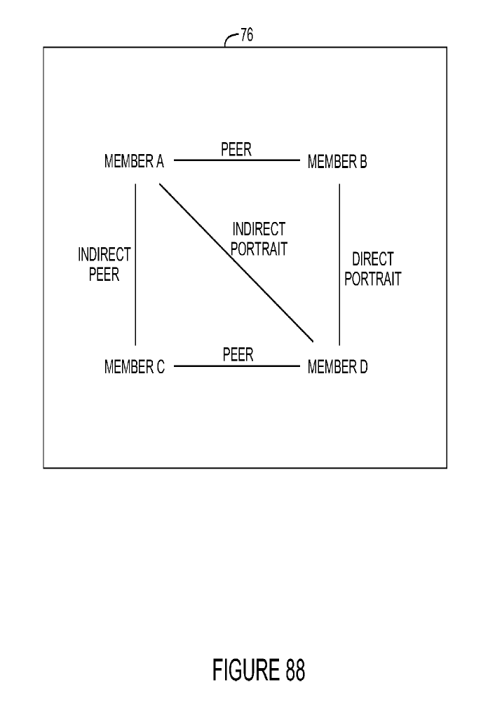

Additionally, computer system 20 can enable a member 12 to graphically view common relationships between himself/herself and another related member 12. To this extent, FIG. 88 shows an illustrative relationships page 76 according to an embodiment, which can be generated by computer system 20. In this illustrative example, MEMBER A may want to see what common relationships resulted in MEMBER D appearing as an indirect portrait. In response, computer system 20 can analyze relationship data 42 and generate relationships page 76. In reviewing relationships page 76, MEMBER A would determine that MEMBER D is an indirect portrait as a result of their respective relationships with MEMBER B. In addition, MEMBER A would determine that both members have a relationship with MEMBER C.

It is understood that various other functionality can be implemented by computer system 20 (FIG. 81). For example, computer system 20 can enable a member 12 (FIG. 81) to alter the default communication/viewing permissions that are directly and/or indirectly granted when invitee credentials 44 (FIG. 81) are provided, an exchange occurs, and/or the like. Further, when minors are allowed to be members, computer system 20 can relate one or more members with a guardian/parent member. The guardian/parent member can further restrict an ability of the member's profile to be viewed by one or more other members, monitor the exchanges that occur that impact the extent to which the member's profile is viewable, monitor/modify the member's profile, and/or the like. For example, when the member receives, generates, and/or is indirectly impacted by (e.g., as a peer) an invitation for an exchange, the guardian/parent member can be informed of the invitation and block the invitation and/or partially restrict the effect of the invitation (e.g., the member does not appear as a peer to the invitee).

While shown and described herein as a method and system for providing a network environment, it is understood that aspects of the invention further provide various alternative embodiments. For example, in one embodiment, the invention provides a computer program stored on at least one tangible computer-readable medium, which when executed, enables a computer system to provide a networking environment. To this extent, the computer-readable medium includes program code, such as networking program 30 (FIG. 81), which implements some or all of the process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; paper; and/or the like. Further, a copy of the program code can be transitory, e.g., embodied in a modulated data signal having one or more of its characteristics set and/or changed in such a manner as to encode information in the signal.

In another embodiment, the invention provides a method of providing a copy of program code, such as networking program 30 (FIG. 81), which implements some or all of a process described herein. In this case, a computer system can generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program embodied in at least one computer-readable medium. In either case, the set of data signals can be transmitted/received using any type of communications link.

In another embodiment, the invention provides a method of generating a system for providing a networking environment. In this case, a computer system, such as computer system 20 (FIG. 81), can be obtained (e.g., created, maintained, made available, etc.) and one or more programs/systems for performing the process described herein can be obtained (e.g., created, purchased, used, modified, etc.) and deployed to the computer system. To this extent, the deployment can comprise one or more of: (1) installing program code on a computing device from a computer-readable medium; (2) adding one or more computing devices to the computer system; and (3) incorporating and/or modifying the computer system to enable it to perform the process described herein.

It is understood that aspects of the invention can be implemented as part of a business method that performs the process described herein on a subscription, advertising, and/or fee basis. That is, a service provider could offer to provide a networking environment as described herein. In this case, the service provider can manage (e.g., create, maintain, support, etc.) a computer system, such as computer system 20 (FIG. 81), that performs the process described herein for one or more customers (e.g., member 12 in FIG. 81). In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

1. A method of controlling member access to information and communication means in a networking environment where members may be logically connected to other members through at least two pre-defined primary relationship connections and at least two-pre-defined secondary relationship connections in at least two aspect networks, the method comprising with respect to the networking environment:
receiving, from a first member, a request to invite a second member to connect in a primary relationship connection with respect to an aspect network;
receiving from the second member acceptance of the invitation to connect;
associating a primary relationship connection between the first and second members;
logically connecting the first and second members to other members of the aspect network through pre-fined combinations primary and secondary relationship connections;
enabling the first and second members to automatically:
(a) view information about each other;
(b) communicate with other; and
(c) view information about all other members of the aspect network logically connected them.

2. The method of claim 1, wherein the at least two different primary relationship connections are alpha and beta relationship connections relationship connections.

3. The method of claim 1, wherein the at least two different secondary relationship connections are logical connections of combinations of alpha and beta relationship connections.

4. The method of claim 3, wherein the logical combinations of alpha and beta relationship connections are the gamma, delta and epsilons(1,2,3).

5. The method of claim 3, wherein the logical connections of combinations of alpha and beta relationship connections are the gamma, delta and epsilons(1,2,3) and thetas(1,2).

6. The method of claim 1, wherein the at least two aspect networks are social and professional aspect networks.

8. The method of claim 3, wherein permitted combinations of primary relationships connections for logically connecting members are the alpha connection, the beta connection, any combination of an alpha connection and a beta connection, any combination of two alpha connections and one beta connection.

9. The method of claim 5 where in developing their aspect networks, members use paths, polling, pass codes, phase-outs, public/private viewability, peeks and petitioning.

10. A computerized networking system for automatically establishing and maintaining at least two aspect networks of members, the system automatically providing select information and select communication capabilities between members who are logically connected, in an aspect network, through pre-defined relationship connections stored as , relationship data associated with each member, and wherein the relationship connections are based on at least two primary relationship connections, and at least two secondary relationship connections.

11. The system of claim 10, wherein the at least two different primary relationship connections are alpha and beta relationship connections relationship connections.

12. The system of claim 10, wherein the at least two different secondary relationship connections are logical connections of combinations of alpha and beta relationship connections.

13. The system of claim 12, wherein the logical combinations of alpha and beta relationship connections are the gamma, delta and epsilons(1,2,3).

14. The system of claim 12, wherein the logical connections of combinations of alpha and beta relationship connections are the gamma, delta and epsilons(1,2,3) and thetas(1,2).

15. The system of claim 10, wherein the at least two aspect networks are social and professional aspect networks.

16. The system of claim 12, wherein permitted combinations of primary relationships connections for logically connecting members are the alpha connection, the beta connection, any combination of an alpha connection and a beta connection, any combination of two alpha connections and one beta connection.

17. The system claim 12 further providing the members with tools to develop their aspect networks, comprising paths, polling, pass codes, phase-outs, public/private viewability, peeks and petitioning.

18. A method of controlling member access to information and communication means in a networking environment to enhance and enable a first member's ability to gather information about a second member before deciding whether to seek to connect with the second member and then to connect the first and second members if they agree to connect, the method comprising the networking environment:
providing the identity of relevant other members who are or where in communication with the first member as well as the second member and who may have information about the second member;
accepting the first member's selection of relevant other member to be polled;
polling the selected relevant others about the second member;
receiving the polled information from the polled members and providing it to the first member;
accepting a request to connect from the first member to the second member and sending same to the second member;
connecting the first and second members upon agreement of the second party to connect and any further confirmation, if required.

19. A method of controlling member access to information and communication means in a networking environment, the method comprising:
the networking environment provides a pass code to a member of the networking environment, or the member provides a pass code to the networking environment, and the networking environment accepts the pass code;
a pass code time period of use is determined by the network and/or the member;
the member provides the pass code to another member of the networking environment or to a non-member of the networking environment which member receives the pass code;
the pass code recipient accesses the networking environment and provides the pass code to the networking environment within the time period of use;
the networking environment utilizing the provided timely pass code establishes access to information and communication between the pass code recipient and the pass code provider.

20. A method of controlling member access to information and communication means, where access is determined based on information maintained by a networking environment concerning which members are connected through other members to still other members and in which environment if the connection between members is disconnected access to that member and the still other members is normally disabled, the method comprising a first member through its connection with a second member has access to other members and the networking environment:
receives instructions from the first member to disconnect from the second member;
places the disconnected first and/or second member and all other members who are accessible through the disconnected members in a phase-out condition;
provides access to all members who had access prior to the disconnection to maintain access while the members remain in the phase-out condition;
removes members from the phase-out condition upon some preset condition; and
disables all access through the disconnected members.

21. A method of controlling electronic messages in a networking environment, the method comprising the networking environment:
allowing an electronic message sender to select who the recipient can send replies to;
and enforcing the sender's selection.

22. A method of controlling member access to information and communication means in a networking environment by controlling the ability of members to add additional member connections, the method comprising the networking environment:
receives notification in connection with the addition of member as a new connection to an existing member;
provides information about the additional member to select members of the existing member's current connections;
receives directions from the select members as to whether the additional member should be added to the existing member's connections; and
connects or does not connect the additional member to the existing member in accordance with the received directions.

23. A method of controlling member access to information and communication means in a networking environment comprising multiple aspect networks, the method comprising the networking environment:
providing for connections between a first member and a second member of a first aspect network;
allowing the second member to view information about members in a second aspect network in which the first member is a member;
receiving a request from the second member to connect with the first member in the second aspect network;
informing the first member of the request;
receiving direction from the first member regarding the request; and
connecting or not connecting the first and second members in the second aspect in accordance with the received direction.

24. A method of providing a networking environment, the method comprising: managing data for a plurality of members, each member including profile data that cannot be viewed by other members without a relationship between the members; receiving invitee credentials for viewing profile data of a first member from a second member; enabling the second member to view the profile data of the first member in response to the invitee credentials; and enabling a third member to view the profile data of the first member in response to the invitee credentials, wherein relationship data defines the third member as a peer of the second member.

25. The method of claim 24, further comprising generating a profile page for the first member in response to a request from one of: the second member or the third member, the profile page including profile data on the first member.

26. The method of claim 24, further comprising generating a peer page for the first member in response to a request from one of: the second member or the third member, wherein the peer page includes profile data for each of a set of members defined as peers of the first member in the relationship data.

27. The method of claim 24, further comprising generating the invitee credentials in response to a request from the first member, and providing the invitee credentials to the first member.

28. The method of claim 27, wherein the invitee credentials remain valid for a limited period of time after at least one of: the generating or a first use of the invitee credentials.

29. The method of claim 24, further comprising managing communications between the plurality of members, wherein members that are peers can communicate with one another using the networking environment.

30. The method of claim 24, further comprising generating a portrait page for the second member, wherein the portrait page includes profile data for the first member based on the invitee credentials.

31. The method of claim 24, further comprising generating a portrait page for the third member, wherein the portrait page includes profile data for the first member based on the invitee credentials.

32. The method of claim 24, wherein the invitee credentials comprise an invitation to exchange profiles, the method further comprising: receiving an acceptance of the invitation from the second member; adding a portrait profile for the second member to the profile data of the first member and each of a set of peers of the first member in response to the acceptance; adding a portrait profile for the first member to the profile data of the second member and each of a set of peers of the second member in response to the acceptance; enabling the set of peers of the first member to view profile data for the second member and the set of peers of the second member in response to the acceptance;
and enabling communications between the first member and the second member in response to the acceptance.

33. The method of claim 32, further comprising: receiving a request from one of the first member or the second member to change a classification of the other of the first member or the second member to a peer; requesting permission from the other of the first member or the second member to change the classification in response to the request; and
performing one of: storing relationship data indicating that the first member and the second member are peers of one another in response to the other of the first member or the second member agreeing to the change; or denying the request in response to the other of the first member or the second member not agreeing to the change.

34. The method of claim 32, further comprising: receiving a request to terminate the exchange from one of the first member or the second member; and removing the first member and the second member from the profile data for the other of the first member and the second member.

35. The method of claim 34 further comprising removing the first member and the second member from the profile data for each peer of the first member and each peer of the second member for which there does not exist an alternative set of relationships that result in the first member or the second member appearing in the profile data for the peer.

36. A system for providing a networking environment, the system comprising: a component configured to manage data for a plurality of members, each member including profile data that cannot be viewed by other members without a relationship between the members; a component configured to receive invitee credentials for viewing profile data of a first member from a second member; a component configured to enable the second member to view the profile data of the first member in response to the invitee credentials; and a component configured to enable a third member to view the profile data of the first member in response to the invitee credentials, wherein relationship data defines the third member as a peer of the second member.

37. The system of claim 36, further comprising a component configured to generate a page based on the data for the first member in response to a request from one of: the second member or the third member, the page including at least one of: profile data on the first member or profile data for each of a set of members defined as peers of the first member in the relationship data.

38. The system of claim 36, further comprising a component configured to manage communications between the plurality of members, wherein members that are peers can communicate with one another using the networking environment.

39. The system of claim 36, wherein the invitee credentials comprise an invitation to exchange profiles, the system further comprising: a component configured to receive an acceptance of the invitation from the second member; a component configured to store relationship data indicating that the first member and the second member are direct portraits of one another in response to the acceptance; a component configured to enable the set of peers of the first member to view profile data for the second member and the set of peers of the second member in response to the acceptance; and a component configured to enable communications between the first member and the second member in response to the acceptance.

40. A computer program comprising program code stored on a computer-readable medium, which when executed, enables a computer system to implement a method of providing a networking environment, the method comprising: managing data for a plurality of members, each member including profile data that cannot be viewed by other members without a relationship between the members; receiving invitee credentials for viewing profile data of a first member from a second member; and storing relationship data indicating that the first member is a direct portrait of the second member, wherein the relationship data enables the second member to view the profile data of the first member, and enables a third member to view the profile data of the first member, wherein relationship data defines the third member as a peer of the second member.

41. The computer program of claim 40, the method further comprising generating a page based on the data for the first member in response to a request from one of: the second member or the third member, the page including at least one of: profile data on the first member or profile data for each of a set of members defined as peers of the first member in the relationship data.

42. The computer program of claim 40, wherein the invitee credentials comprise an invitation to exchange profiles, the method further comprising: receiving an acceptance of the invitation from the second member; storing relationship data indicating that the first member and the second member are direct portraits of one another in response to the acceptance, wherein the relationship data enables the set of peers of the first member to view profile data for the second member and the set of peers of the second member, enables the set of peers of the second member to view profile data for the first member and the set of peers of the first member, and enables communications between the first member and the second member.

43. The computer program of claim 40, the method further comprising: receiving a request from one of the first member or the second member to change a classification of the other of the first member or the second member to a peer; requesting permission from the other of the first member or the second member to change the classification in response to the request; and performing one of: storing relationship data indicating that the first member and the second member are peers of one another in response to the other of the first member or the second member agreeing to the change; or denying the request in response to the other of the first member or the second member not agreeing to the change.

44. A method for graphically showing relationships between members in a networking environment, the method comprising the networking environment:
maintaining information regarding the paths taken by members in finding each other in order to connect; and
displaying the information so as to describe to a viewer: the current connections between the members; how and/or through which other member or members the members found each other; and, if they are no longer connected, how the members were connected.

45. A method of controlling electronic messages in a networking environment, the method comprising the networking environment:
allowing an electronic message recipient of an original electronic message to be able to automatically select as recipients for their reply only those other original electronic message recipients who are in the recipient's network;
and enforcing the recipient's selection.
